(19) United States
(12) Patent Application Publication
(10) Pub. No.: US 2007/0266054 A1
(43) Pub. Date: Nov. 15, 2007

(54) Method and system for salary planning and performance management

(76) Inventors: Frank Mitchell Stephens, Raleigh, NC (US); Donald Alan Berman, Ramsey, NJ (US); Scott Edward Farran, Haymarket, VA (US)

Correspondence Address: NIXON PEABODY, LLP, 401 9TH STREET, NW, SUITE 900, WASHINGTON, DC, 20004-2128, US

(21) Appl. No.: 11/727,204

(22) Filed: Mar. 23, 2007

Related U.S. Application Data
(60) Provisional application No. 60/785,366, filed on Mar. 24, 2006.

(51) Int. Cl. G06F 17/30

(52) U.S. Cl. 707/200

(57) ABSTRACT

A method, system, computer program product, and devices for salary planning and performance management, including at least one of means for allowing documents used by organizations for salary planning, performance management, or other human resource (HR) processes to be used as a user interface to an automated system; and means for allowing documents used by organizations for salary planning, performance management, or other human resource (HR) processes to be used to generate online forms that closely mirror the documents and subsequent changes to the documents via an automated system.

### CROSS REFERENCE TO RELATED DOCUMENTS

The present invention claims benefit of priority to U.S. Provisional Patent Application Ser. No. 60/785,366 to STEPHENS et al., entitled “METHOD AND SYSTEM FOR SALARY PLANNING AND MANAGEMENT,” filed Mar. 24, 2006, the entire disclosure of which is hereby incorporated by reference herein.

### BACKGROUND OF THE INVENTION

1. Field of the Invention

The present invention generally relates to management systems, and more particularly to a method and system for salary (also referred to as SalaryXL or CompensationXL) and performance (also referred to as PerformanceXL) planning and management.

2. Discussion of the Background

In recent years, companies of all sizes have employed salary planning to budget and distribute salary increases, bonuses, stock options, promotions, and adjustments for market conditions and increased responsibilities. Accordingly, salary planning is essentially a financial budgeting/modeling process. In most corporations, this is done by circulating spreadsheets or word processor documents that are manually created. However, this process is difficult to monitor and control and the subsequent merge of the returning documents is error prone and time consuming. Analysis of the outcome in this scenario is impossible until the cycle is complete.

Also in recent years, performance management has been employed to rate employees according to their performance in the interest of rewarding and maintaining the best employees and identifying low performers. Most companies accomplish this task by circulating word processor documents or spreadsheets which are then manually completed and circulated either by interoffice mail or email and signed and stored on paper.

There are a number of salary planning and performance management solutions on the market. However, such solutions mostly are web based and all eschew the use of spreadsheets or word processing documents in favor of proprietary online or windows based entry screens.

### SUMMARY OF THE INVENTION

Therefore, there is a need for a method and system that addresses the above and other problems. The above and other problems are addressed by the exemplary embodiments of the present invention, which provide an improved method and system for salary planning and performance management. Advantageously, the exemplary embodiments described herein allow companies to maintain the use of existing spreadsheets and word processor documents eliminating managers and employees from the burden of learning new systems. Further, these documents can be rendered either in an online (e.g., html or PDF) mode or remain in their original document format.

Accordingly, in exemplary aspects of the present invention there is provided a method, system, computer program product, and devices for salary planning and performance management, including at least one of means for allowing documents used by organizations for salary planning, performance management, or other human resource (HR) processes to be used as a user interface to an automated system; and means for allowing documents used by organizations for salary planning, performance management, or other human resource (HR) processes to be used to generate online forms that closely mirror the documents and subsequent changes to the documents via an automated system.

Still other aspects, features, and advantages of the present invention are readily apparent from the following detailed description, by illustrating a number of exemplary embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 illustrates an exemplary system for salary planning or performance management, according to exemplary embodiments of the present invention;

FIGS. 2-106 illustrate further details of the exemplary system for salary planning or performance management of FIG. 1, according to exemplary embodiments of the present invention;

FIG. 107 illustrates an exemplary system for salary planning or performance management, according to further exemplary embodiments of the present invention; and

FIGS. 108-147 illustrate further details of the exemplary system for salary planning or performance management of FIG. 107, according to exemplary embodiments of the present invention.

### DETAILED DESCRIPTION OF THE PREFERRED EMBODIMENTS

The present invention includes the recognition that financial modeling tools, including spreadsheets, such as Microsoft Excel, and the like, are invaluable in performing a salary planning process. In addition, most users who participate in salary planning are used to doing salary planning via such spreadsheets.

The exemplary system allows users to use spreadsheets, such as Microsoft Excel, and the like, as a front end to the salary planning process, while storing all salary planning information in a relational database that allows the process to be monitored and analyzed in flight. For example, the exemplary system uses a unique process of creating ExcelDefinitions that create Excel spreadsheets on the fly from real time salary planning data and that users can then download and make appropriate changes and then upload to the exemplary system and route to upper management for approval.

Advantageously, the exemplary system builds on the familiar Excel workbooks organizations, and fully integrates with Human Resource (HR) systems. In addition, the exemplary system allows a Compensation Manager or Administrator, and the like, for example, to Manage multiple compensation review processes or cycles within an organization, Dynamically refresh data as required, Manage organizational changes within review cycles and make adjustments when necessary for ‘one-off’ situations, See the status of a manager's compensation reviews at any suitable point in time, Monitor overall processes and budget, Make review changes and adjustments, Drill down with custom reports, Receive notifications and handle real-time events such as terminations, leaves-of-absence, and transfers, and Communicate efficiently with any suitable participant in the compensation review process.

Using the exemplary system, managers can perform their salary reviews with unprecedented efficiency, while working within established frameworks and guidelines. For example, managers can Easily keep track of where they stand in the process, and what they need to do next, Centrally manage the entire review process for each subordinate, Get easy access to all the information they need, from previous reviews to salary histories, Work online, or download workbooks and work offline at their convenience—without ever causing tracking or coordination problems, Submit reviews for approval by senior management, and approve or reject the reviews of their subordinate managers, and Send “what if” scenarios to management and subordinates.

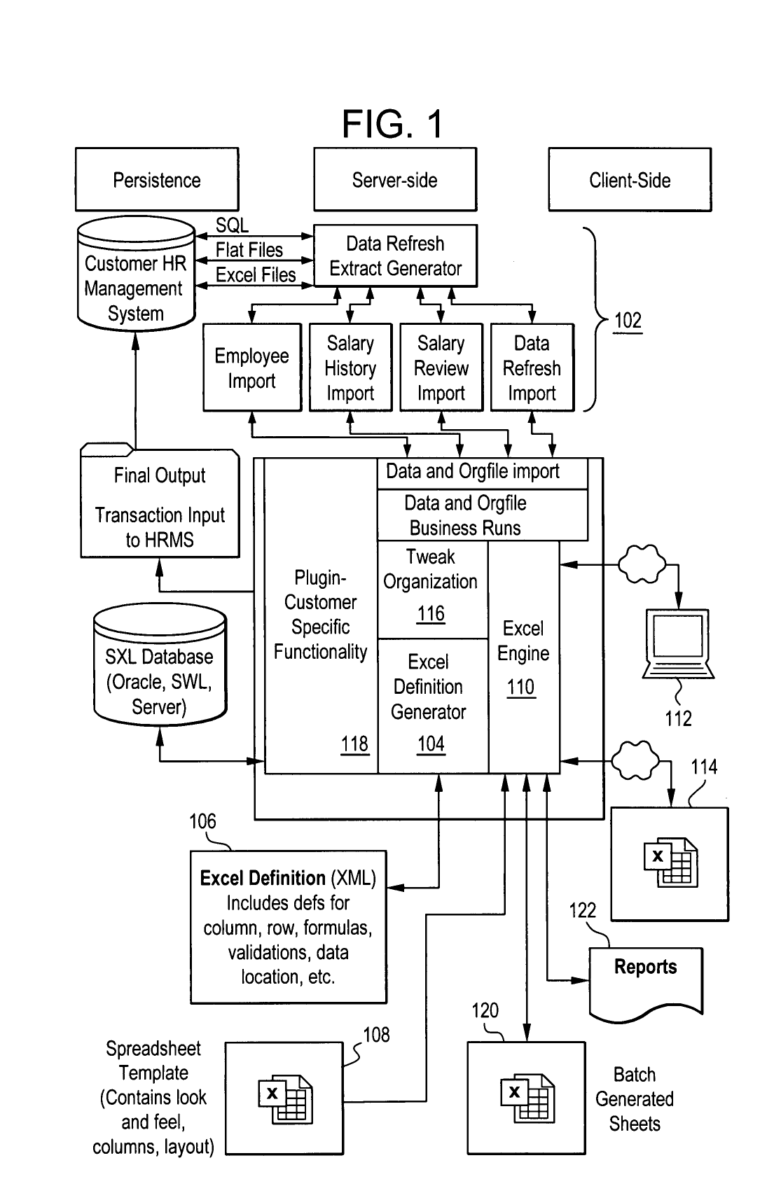

Referring now to the drawings, wherein like reference numerals designate identical or corresponding parts throughout the several views, and more particularly to FIG. 1 thereof, there is illustrated an exemplary system for salary planning and management, according to exemplary embodiments of the present invention. As shown in FIG. 1, various components can be resident on a server, and database layer. No client components need be employed, except for the exemplary system's admin tool, as further described. In FIG. 1, the client elements that are shown are accessed from the client, but need not be resident thereon.

Data Load and Load of Organization (Elements 102, and 116)

The exemplary system has a robust HR oriented data model and in addition allows for an unlimited number of user defined fields. This means that the exemplary system can store any suitable data needed by each customer without the need to add element to the exemplary system's database.

The exemplary system allows direct access to a Human Resource Management System (HRMS) via direct access using the exemplary system's SQL window (Update from HRMS) or by using Flat files or spreadsheets. The organizational structure of the client company can also be gleaned directly form the HRMS system or customer supplied flat files or spreadsheets.

The exemplary system's unique data load architecture allows the iterative reloading of Employee data, Salary History and organizational data, so that the Performance Review or Salary Planning cycle can reflect day to day occurrences in an organization, such as transfers, terminations, leaves, etc., by comparing incoming data to that already present in the exemplary system. The compensation or HR department can run such processes as often as they like and are prompted to accept or ignore changes. Compensation personnel can also use the exemplary system's Department Tab and Routing path tab to tweak their organization (element 116) by moving individuals between departments. The Organization load discussed above understands that these changes are intentional and flags them as such in the organization import. The organization data is used by the exemplary system to assure that each manager that accesses the system has access only to employees for which they are allowed. The organization data also establishes the routing paths used by groups of employees for approval by upper management.

Excel Generation Process (Elements 104, 106, 108, 110, 112, 114, 120, and 122)

The exemplary system's unique Excel Engine (element 110) pulls real-time salary planning data from it's relational database and creates user interfaces automatically, including, for example, Excel spreadsheets that users can download and work offline (element 114), and Web pages that the user can work on online (element 112).

For spreadsheets and web pages, the format, look and feel, functionality formulas and constituent data are unique at each customer site and in fact can be different for different individuals with in an organization. The Excel engine (element 110) uses the same two components to generate the downloadable Excel spreadsheet and the online sheet (e.g., web page), advantageously, with both exhibiting the same look and feel.

Excel Template (element 108)—This, for example, is an Excel workbook that includes a shell that will be used create the Excel workbook for download. It can include only the static portions, like the title, client logo, column headings, etc.

Excel Definitions (element 106)—This is an xml file, and the like, that includes all suitable information employed to dynamically define data for column and header cells for the spreadsheet and online sheet, for example, including Field name—links to database field, Column Label, Column (A, B, C, etc.), Column Format, Column Type (from database, formula, constant, etc.), Input/Output, Excel formula, Configurable extra properties (e.g., pop-up comments, etc.), Subtotal options, Validations, Sort field, Sort order, Sub total formula, and Column Style.

These Excel definitions can be created programmatically via shell definitions programs provided or using the point and click ExcelDefinition Generator (element 104).

Managers that login to the exemplary system, for example, can request either an online sheet or a downloadable spreadsheet. The compensation department can also generate spreadsheets for an organization in batch (element 120).

Reports (element 122) are also available, and can be delivered using, for example, Crystal Reports, third party reporting software, and the like. Advantageously, users see only the relevant data based on their place in the organization.

The Exemplary System's Web Application

The Web application provides a web platform for managers and other users to login and access the functionality described above.

The Exemplary System's Admin Tool

A client based version of the above functionality is packaged in the form of the exemplary system's admin tool. This tool encompasses the above functionality plus allows the compensation administer to select any suitable manager and see the application as that user sees it. The admin tool provides a greater detail and can be used to update any suitable data element used by the system. The admin tool also provides the control point for uploading and refreshing Employee data, organization data, and the like.

Accordingly, SalaryXL is a tool that streamlines, accelerates, and improves every step of your salary planning cycle. SalaryXL builds on the familiar Excel workbooks you may already be using, and fully integrates with your HRMS system. It allows you, the Compensation Manager or Administrator, to Manage multiple compensation review processes or cycles within your organization, Dynamically refresh data as required, Manage organizational changes within review cycles and make adjustments when necessary for ‘one-off’ situations, See the status of any manager's compensation reviews at any point in time, Monitor your overall processes and budgets, Make review changes and adjustments, Drill down with custom reports, Receive notifications and handle real-time events such as terminations, leaves-of-absence, and transfers, and Communicate efficiently with any participant in the compensation review process.

Using SalaryXL, your managers can perform their salary reviews with unprecedented efficiency, while working within the frameworks and guidelines you've established. They can Easily keep track of where they stand in the process, and what they need to do next, Centrally manage the entire review process for each subordinate, Get easy access to all the information they need, from previous reviews to salary histories, Work online, or download workbooks and work offline at their convenience—without ever causing tracking or coordination problems, Submit reviews for approval by senior management, and approve or reject the reviews of their subordinate managers, and Send “what if” scenarios to management and subordinates.

The following description explains how to a user can use SalaryXL to manage the overall salary or compensation planning process within organizations. In many organizations, these individuals will have titles such as Compensation Manager or Compensation Analyst. For a manager responsible for performing individual salary reviews, a SalaryXL online help system is provided. For a system administrator or technical professional seeking information about installing SalaryXL or configuring it for the first time, a SalaryXL Installation Guide is provided. Once SalaryXL has been configured for the first time, certain reconfiguration tasks can be performed through the Salary Planning Administration Tool. These tasks are described in detail herein.

Further described are SalaryXL's Salary Planning Administration tool, and the techniques you need to master in order to manage your compensation planning process with SalaryXL. It assumes that SalaryXL has already been installed and is operating successfully. As part of the installation process, created is a custom Excel templates and Excel Definitions you and your managers can utilize to perform salary reviews. These elements are used to generate Excel workbooks from real-time data stored in your HRMS systems, and other systems if applicable. The workbooks SalaryXL generates for your managers enforce your unique business rules and calculations. The following descriptions assume that these templates have already been created and installed.

To maximize your flexibility, SalaryXL templates may also employ data input into Excel workbooks you create to reflect updates to your organization structure that may not have been entered in your enterprise systems yet.

Understanding the SalaryXL Administration Process

As SalaryXL Administrator, you're responsible for using SalaryXL to set up your organization's compensation review process. This involves five steps:

1. Setting up Review Cycle(s) representing any unique salary review processes

2. Pulling information from your HRMS (and other) systems, and segmenting your employee population into any number of groups

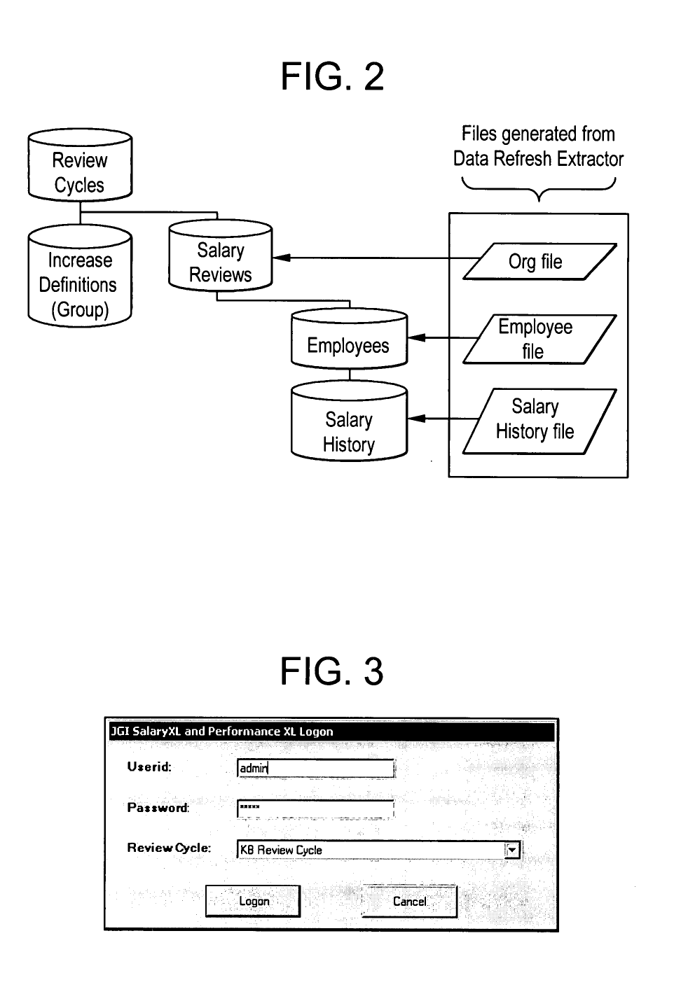

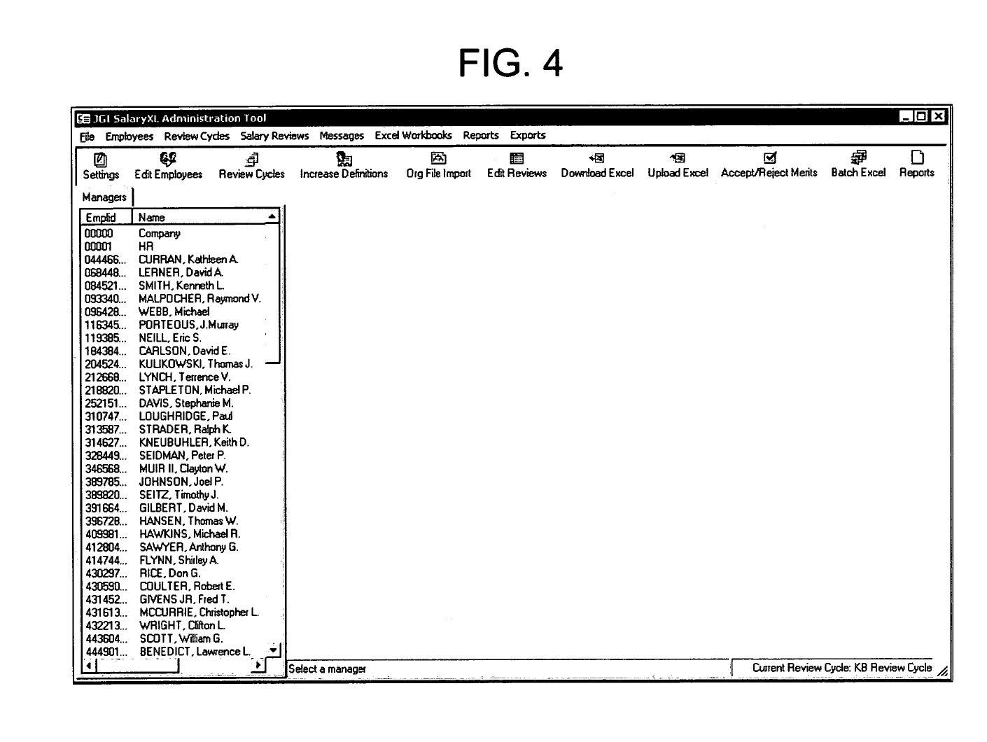

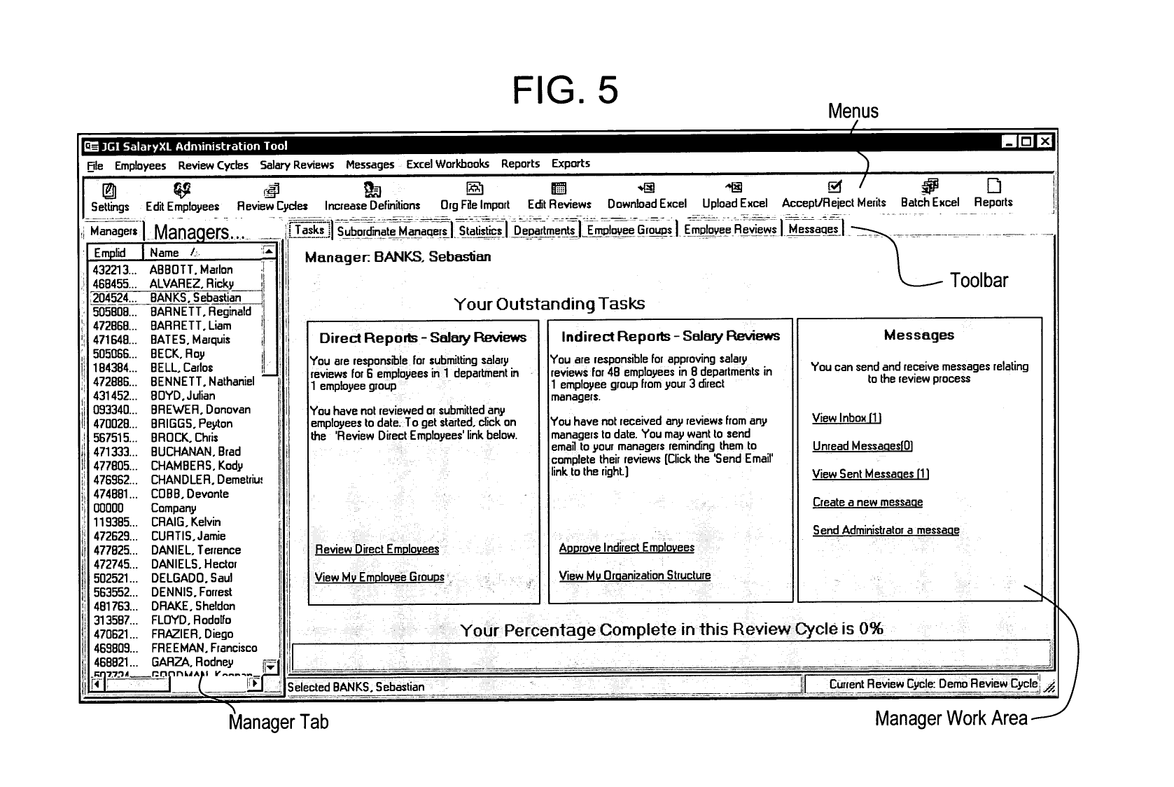

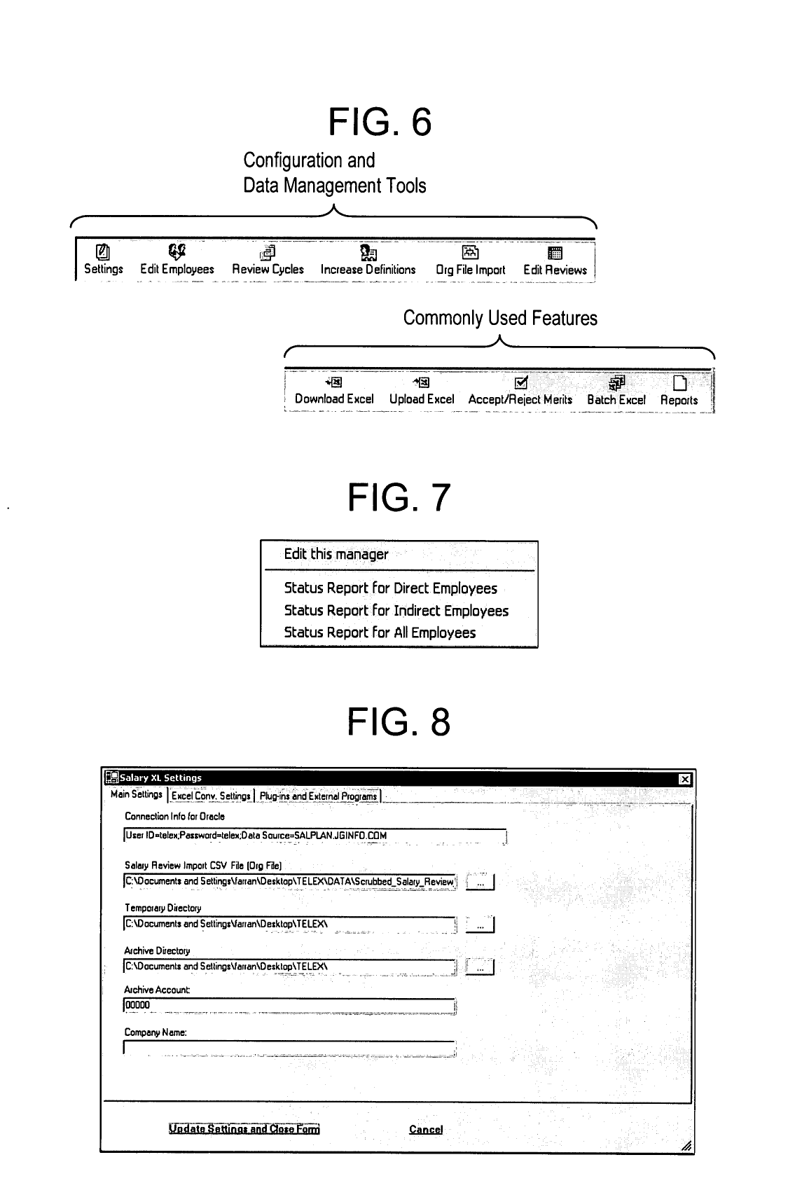

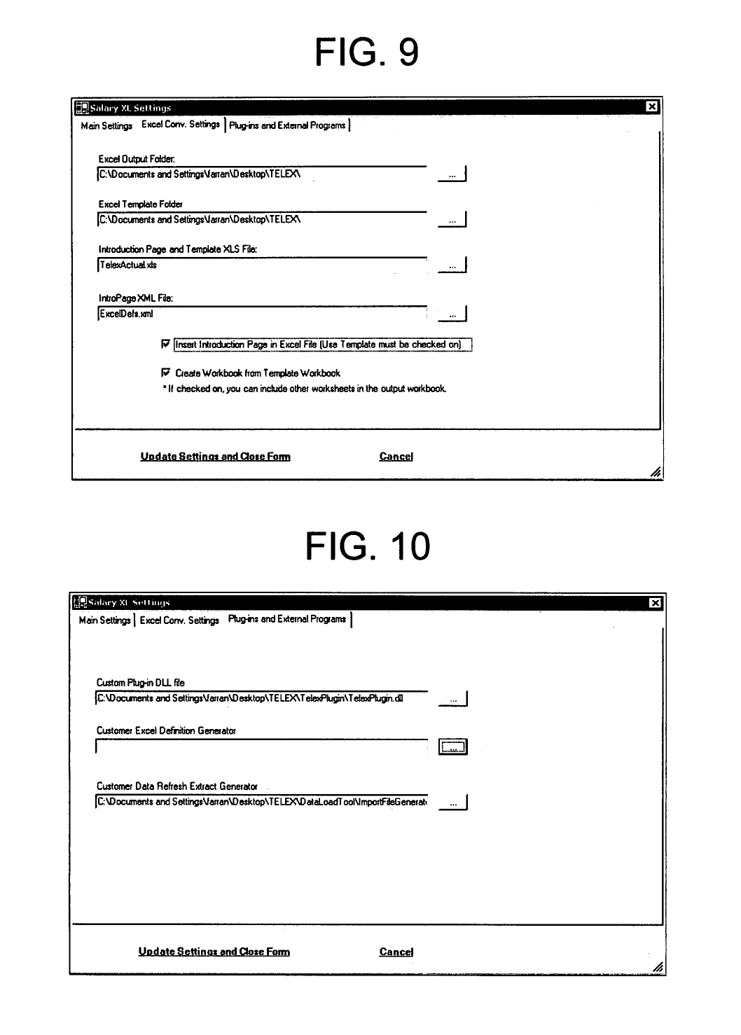

As part of the SalaryXL installation and configuration process, requirements are gathered and the processes to enable you to refresh the data are defined (see FIG. 2).

3. Reviewing the hierarchical structure of your organization, displayed in an easy-to-use graphical tree-like presentation

4. Making minor adjustments to organizational structure, using the SalaryXL Department Tab

5. Setting up “impersonations” that allow assistants or interim managers to perform salary reviews on behalf of executives who authorize them to do so

As you work within SalaryXL, you will work with one Review Cycle at a time. You'll use the SalaryXL Administration Tool to monitor it from start to finish, drilling down to any level of detail, and communicating with managers responsible for actually performing salary reviews. You can also perform salary reviews on their behalf, whenever it's necessary to do so.

Launching the SalaryXL Administration Tool

To begin working with the SalaryXL Administration Tool, double-click the SalaryXL Admin Tool icon on your desktop. Alternatively, choose Start, Programs, SalaryXL. The SalaryXL Logon Prompt appears (see FIG. 3). This login is for accessing the administrator tool. Depending on the settings you define, managers who access SalaryXL on the web, can log on via either your Microsoft Active Directory single-sign-on authentication system, or password authentication built into SalaryXL itself.

The logon prompt enables authorized users to access the SalaryXL Administration tool to manage the compensation review process. The userid and password are validated against users who are given admin authorization for SalaryXL. You also choose the Review Cycle you are going to manage.

To logon to the SalaryXL Administration tool, follow, these steps:

1. Enter your Userid

2. Enter your Password

3. Choose the Review Cycle you wish to manage. Once you are logged on to the SalaryXL Administration tool, you will be able to switch Review Cycles

4. Click Logon.

Click Cancel to terminate the logon process and close the Logon Prompt. Once you are successfully logged on, the main screen of the SalaryXL Administration Tool appears (see FIG. 4). During the implementation process and initial userid and password are created. The SalaryXL Administration Tool enables administrators to designate any employee to have access to the admin tool. This main screen is your central point of control. From here, you have immediate access to SalaryXL's configurations and settings, Up-to-the-minute information about the status of any manager's salary reviews, and Touring the SalaryXL Administration Tool Interface.

Before you begin working with the SalaryXL Administration Tool, briefly familiarize yourself with its user interface. SalaryXL follows standard Windows conventions, so you can leverage what you already know about running Windows applications such as Microsoft Office. The SalaryXL Administration Tool Interface has four main areas, including Menus, Toolbar, Managers Tab, and Manager Work Area (see FIG. 5). Each of these is described below in more detail.

Menus

Like most Windows applications, the SalaryXL Administration tool organizes its commands into a series of menus:

File. Controls the Settings SalaryXL uses to manage the selected Review Cycle and to perform Data Refreshes from your HRMS system to generate files used in SalaryXL.

Employees. Enables you to manage employee information.

Review Cycles. Enables you to create and manage Review Cycles and to manage Managers and Impersonations in the Review Cycle.

Salary Reviews. Enable you to manage employee reviews.

Messages. Enables you to communicate with SalaryXL users throughout your company.

Excel Workbooks. Provides commands for downloading, uploading, and batch-generating Excel workbooks.

Reports. Enables you to choose and run reports.

Exports. Controls the archiving of SalaryXL information and exporting SalaryXL information to load back into HRMS.

Most of these commands can also be accessed via the Toolbar, as described next.

Toolbar

Like most contemporary Windows applications, the SalaryXL Administration Tool provides one-click access to its most commonly used features via a toolbar (see FIG. 6).

Configuration Tools:

Settings. Controls SalaryXL's main settings, and settings associated with how SalaryXL generates and utilizes Excel workbooks.

Edit Employees. Enables you to search/edit employee information, add employees, and delete employees.

Review Cycles. Enables you to manage Review Cycles within your organization.

Increase Definitions. Enables you to establish and enforce salary targets for groups of employees.

Edit Reviews. Enables you to search/edit employee reviews, add new reviews, and delete reviews from the Review Cycle, as further described herein.

Commonly Used Features:

Download Excel. Exports all or selected salary review information to an Excel workbook for the currently selected manager.

Upload Excel. Uploads an Excel workbook, posting its salary review information to the database.

Accept/Reject Merits. Permits you to ‘stand in’ for the selected manager and accept or reject proposed merit increases for all employees, or a group of employees, reporting to the selected manager.

Batch Excel. Generates multiple Excel workbooks for use by multiple managers, or for other purposes.

Reports. Enables you to choose and run reports.

Managers Tab

When you start the SalaryXL Administration tool, the Managers tab appears at the left-hand side of the screen. If this is the first time you are accessing a Review Cycle and you have not gone through the Data Load process, this tab will be blank; otherwise you will see the current list of managers in the review process.

When you right-mouse click on any manager in the Managers Tab, the menu in FIG. 7 will appear.

Edit this manager. Displays the Edit Manager screen for the selected manager.

Status Report for Direct Employees. Runs a report displaying the review status for all direct employees.

Status Report for Indirect Employees. Runs a report displaying the review status for all indirect employees.

Status Report for All Employees. Runs a report displaying the review status for all direct and indirect employees.

You can sort the Managers Tab by clicking on the column headings Emplid and Name. There will be an up or down arrow indicator for ascending or descending sort.

Managers Work Area

When you select a manager from the Managers Tab, the Managers Work Area provides you access to detailed information about that manager's ongoing salary reviews. This is the same information that manager would see when he or she logs on to SalaryXL's web interface for users. By selecting Company, you can display top-level summary information about the status of your entire organization's salary reviews, as further described herein.

Once you are familiar with the SalaryXL Administrator Tool Interface, you are ready to begin using the tool to administer many aspects of SalaryXL. Initially, you will need to adhere to the following steps to get you started. These steps can be repeated for however many Review Cycles you need to create. Additionally, steps 3-6 can be repeated whenever you need to refresh from your HRMS system.

Step 1—Create/Edit Review Cycle

This step enables you to setup basic information about your Review Cycle, such as; Start/Stop dates and is it Focal or Anniversary based.

Step 2—Define Increase Definition(s)

This step enables you to define targets that each manager must adhere to. You can have multiple Increase Definitions within a Review Cycle.

Step 3—Run the Data Refresh Extractor

The Data Refresh Extractor will process output from your HRMS and produce the files necessary for Steps 4-6.

Step 4—Import Employees

Import Employees processes one of the output files from step 3 and imports the employee information into SalaryXL. This step must be completed before continuing on. All of the remaining steps and processes with the SalaryXL Administration Tool require that employees are loaded.

Step 5—Load Salary History

This is an optional step and is only required if you are loading employee's salary history for managers to review while completing the salary review process. Load Salary History processes one of the output files from Step 3 and imports the salary history information into SalaryXL.

Step 6—Load Organizational File

Load Organizational File loads the file prepared for identifying your organization's structure and reporting relationships. This file can be output from your HRMS or a file you have separately prepared. Steps 3-6 can be omitted if updating directly from the HRMS system.

Settings

Controlling SalaryXL's Main Settings

As an administrator, you can control three categories of settings, including SalaryXL's main settings, settings associated with how SalaryXL generates and utilizes Excel workbooks, and settings for plug-ins. These settings are established when SalaryXL is first installed and configured. Typically, you will rarely need to change them.

If you need to review or adjust these settings, click Settings on the toolbar. The Salary Admin Settings dialog box appears, with the Main Settings tab displayed (see FIG. 8).

Using Standard Commands within the Salary Admin Settings Screen

This dialog box makes available a row of commands that are available from any tab. These commands appear as (e.g., shown in blue) hyperlinks below the row of tabs. Update Settings and Close Form saves all the changes you've made on any tabs within this dialog box and closes the screen. Cancel enables you to cancel and changes on any tab and close the screen.

The Main Settings tab brings together connection and location information for files, databases, and programs that SalaryXL needs in order to perform its functions. Don't change these settings without a clear understanding of how the changes will impact SalaryXL's behavior.

Connection Info: Specifies the user ID, password, and data source information SalaryXL needs to connect with the database where salary review information is stored.

Salary Review Import CSV File: Specifies the location of the .CSV (comma-separated-values) or .TXT (text) file that contains information about your organization's structure and reporting relationships.

Temporary Directory: Specifies the drive and location where SalaryXL stores its temporary files.

Archive Directory: Specifies the drive and location where SalaryXL stores archives of older information.

Archive Account: Specifies the SalaryXL account to be used for accessing archived information.

Company Name: Specifies the top-level name of the company or organization using SalaryXL.

Any of these settings may be changed by typing new information in its corresponding text box. For Salary Review Import CSV File, Temporary Directory, Archive Directory, Customer Excel Definition Program, or Customer Data Refresh Extract Generator, there's also an easier alternative. To specify a different file or location:

1. Click the . . . (three dots) button to the right of the corresponding text box.

2. Browse to the location and file or program you want to use instead.

3. Click Open.

Controlling SalaryXL's Excel Conversion Settings

SalaryXL gives you extensive control over how it generates Excel workbooks for use by managers throughout the salary review process. To change SalaryXL's Excel Conversion Settings, first click Settings on the toolbar. The Salary Admin Settings dialog box appears; click the Excel Conversion Settings tab (see FIG. 9).

Excel Output Folder: Specifies where SalaryXL will store the Excel workbooks it generates.

Excel Template Folder: Specifies where SalaryXL will look for the templates it uses to generate Excel workbooks.

Introduction Page and Template XLS File: Specifies the template Excel will use as the foundation for the Excel workbook and introductory pages it generates.

IntroPage XML File: By default, SalaryXL builds an introductory page for each workbook it creates. This introductory page typically includes instructions for using the workbook, and may be customized to the individual manager the workbook is being generated for. To build this page, SalaryXL combines data from its database with an Excel template. It uses an XML file to map the data to locations in the Excel workbook it creates. By specifying an IntroPage XML file, you specify the XML file SalaryXL will use to do this.

This tab also enables you to control two other settings related to how SalaryXL generates Excel workbooks for users, including:

Insert Introduction Page in Excel File. This checkbox is checked by default. If you prefer not to include an introductory page with your workbooks, clear the checkbox. Introductory pages can provide general information and overall instructions to the user of the workbook.

Create Workbook from Template Workbook. This checkbox is checked by default. When checked, your workbooks are built from an existing workbook, rather than a blank workbook. This allows you to include any additional content you would like users to have. As an example, some companies include additional tabs that present analysis of increases information, salary range or other data.

Controlling Plug-Ins and External Programs

SalaryXL provides a lot of built-in functionality. You can extend SalaryXL by creating your own custom specific validations. External programs are also written to generate custom Excel Templates and to create the data files from your HRMS to be used with SalaryXL. To change plug-ins and external programs, first click Settings on the toolbar. The Salary Admin Settings dialog box appears; click the Plug-ins and External Programs tab (see FIG. 10).

Customer Plug-in DLL file: Specifies the name and location of the optional SalaryXL plug-in created to provide specific functionality for your organization.

Customer Excel Definition Generator: Specifies the name and location of the optional SalaryXL add-on program used to create custom Excel templates.

Customer Data Refresh Extract Generator: Specifies the name and location of the optional SalaryXL add-on program used to build new organization files containing information about your organization's structure and reporting relationships.

Managing Review Cycles

SalaryXL allows for an organization to handle multiple Review Cycles to meet their review process requirements. The Review Cycles can be focal-based or anniversary-based Review Cycles. Support for Review Cycles enables you to Store multiple instances of reviews for employees, Support different reporting structures for each employee per cycle, Have historical reporting across review cycles, and Change base review information via the administrator's tool.

Selecting Review Cycles

When you initially logged on to the SalaryXL Administration tool, you selected a Review Cycle that you wanted to manage. After you have logged on, you can select a different Review Cycle. To select a different Review Cycle, choose Select Review Cycle from the Review Cycles menu. The Select Review Cycle dialog box appears (see FIG. 11).

To select a different Review Cycle, select the desired Review Cycle from the list and click the (e.g., shown in blue) Continue hyperlink. To keep the current Review Cycle, click the (e.g., shown in blue) Cancel hyperlink. The current Review Cycle is always displayed in the lower right-hand corner of the SalaryXL Administration Tool Interface.

Creating/Editing Review Cycles

You can also edit, create, or delete Review Cycles. To select a Review Cycle to edit, choose Edit Review Cycles from the Review Cycles menu. The Edit Review Cycles dialog box appears (see. FIG. 12).

From here you can Edit a Review Cycle, Add a new Review Cycle, or Delete a Review Cycle. When you are done working with Review Cycles, click the (e.g., shown in blue) Close Form hyperlink.

Making Changes to an Existing Review Cycle

To edit an existing Review Cycle, select the Review Cycle from the Edit Review Cycles list and click the (e.g., shown in blue) Edit Review Cycle hyperlink. The Edit Review Cycle dialog box appears (see FIG. 13).

On the Review Cycle Information tab, you can change the following information:

Cycle Description: This is a descriptive name that will display in all of the selection lists.

From Date: Specifies the start date of the Review Cycle. This should be earlier than the date specified in To Date.

To Date: Specifies the end date of the Review Cycle. This should be later than the date specified in From Date.

Is Anniversary Based Review: If this is checked then the review process in the selected Review Cycle are based on the anniversary date of the employee. If this is unchecked, then the all of the reviews in the selected Review Cycles are based on the same date.

Is Closed?: If this is checked then the review process is closed and no more reviews will be allowed. If this is unchecked, then the review process is open.

Cycle ID: This is an internal SalaryXL identifier for the Review Cycle.

To view the statistics for an existing Review Cycle, click the Review Statistics tab. The Review Statistics tab (see FIG. 14).

Click the Save button to save your changes and close the Edit Review Cycle dialog box and return to the Edit Review Cycles list.

Click the Cancel button to close the window, without saving any changes, and return to the Edit Review Cycles list.

New Review Cycle

To add a new Review Cycle, select click the (e.g., shown in blue) Add New Review Cycle hyperlink. The Add Review Cycle dialog box appears (see FIG. 15).

Enter the information for the new Review Cycle. The fields are the same as described for editing an existing Review Cycle. The internal SalaryXL Cycle ID will initially be set to 0. Once the Review Cycle is added, a SalaryXL will assign a Cycle ID to the Review Cycle.

Click the Add button to add the Review Cycle and close the Add Review Cycle dialog box and return to the Edit Review Cycles list.

Click the Cancel button to close the window, without adding the Review Cycle, and return to the Edit Review Cycles list.

Deleting an Existing Review Cycle

To delete an existing Review Cycle, select click the (e.g., shown in blue) Delete Review Cycle hyperlink. The Delete Review Cycle dialog box appears (see FIG. 16). Only delete a Review Cycle if you are sure you do not need it any longer. THIS IS A VERY SERIOUS STEP AND SHOULD ONLY BE TAKEN IF YOU ARE COMPLETELY SURE. Deleting a Review Cycle, deletes everything in the Review Cycle.

Click the Delete button to delete the Review Cycle. You will get a confirmation dialog box asking if you are sure you want to delete the Review Cycle. Click OK to delete the Review Cycle and close the Delete Review Cycle dialog box and return to the Edit Review Cycles list. If you do not want to delete the Review Cycle, click Cancel to close the Delete Review Cycle dialog box and return to the Edit Review Cycles list.

Click the Cancel button to close the window, without deleting the Review Cycle, and return to the Edit Review Cycles list.

Establishing Increase Targets and Groups

SalaryXL allows you to define overall targets, including salary adjustment percentages that your managers must stay within as they review increases for individuals within their areas of responsibility.

You can apply a separate target to each group of employees you create. Using SalaryXL groups makes it easier to track budgets. It also brings greater flexibility to your compensation planning process. For example, you can calculate increases for individuals in different groups using Excel templates containing business rules customized to each group.

You may create as many groups as you wish. For example, you may establish different groups for Individuals in different divisions, Individuals serving different business functions, Full-time vs. part-time employees, Individuals working pursuant to different FLSA codes, and Individuals eligible (or not eligible) for an Executive Incentive Plan.

A manager may review salaries for individuals in multiple groups, but each employee can only be a member to one group. Typically, groups are established as part of the original process of configuring SalaryXL; often, their definitions are captured directly from your existing Human Resource Management System (HRMS). However, you can create new groups on your own. Groups must have increase definitions associated with them. They must also be present in the Organization file that contains your organization's structure and reporting relationships; if both are not present, they will not be processed.

To establish increase targets or create new groups, click the Increases Definitions button on the toolbar, or choose Increase Definitions from the File menu. The Increase Definitions Maintenance Screen appears, with the Increase Properties tab displayed (see FIG. 17).

Using Standard Commands within the Increase Definitions Maintenance Screen

This dialog box makes available a row of commands that are available from any tab. These commands appear as (e.g., shown in blue) hyperlinks above the row of tabs.

Add New Increase allows you to create a new group that will have its own Increase Definitions.

Delete Increase allows you to delete an existing group and all the Increase Definitions within it.

Save Changes saves all the changes you've made on any tab within this dialog box.

Cancel enables you to cancel from adding a new increase definition without saving any of the information.

Refresh eliminates any edits to the current tab that you've made and not yet saved, restoring data previously stored in the database.

Close Form closes the entire dialog box. If changes have not yet been saved, they will be lost.

Making Changes to an Existing Group

To set increase targets or make other changes to an existing group, follow these steps:

1. Select the group's name from the Increase Definition drop-down list at the top of the dialog box. When you do, all current information about that group is displayed in text boxes you can edit.

2. To set an effective date for the target increases and adjustments you are entering, type the date in MM/DD/YYYY format in the Effective Date text box. Alternatively, click its down-arrow and choose a date from the calendar that appears. This date must be in the future.

3. Next, in the five increase component fields beneath Effective Date, specify values for each increase component you want your managers to consider as they review salaries for their individual reports. These field's names are not customized for your individual company. For example, you might have a “Merit” increase component, a “Bonus” increase component, and/or a “Promotion” increase component. In the administrator's tool, SalaryXL will refer to these on this screen as Increase, Adjustment, Adjustment (2), adjustment (3) and Bonus. These names are for reference only and may be different from what you are using these targets for.

4. By default, SalaryXL assumes you wish to work with annual rates, rather than hourly salary amounts. If you prefer to work with hourly rather than salary amounts, check the Hourly Group checkbox at the bottom of the dialog box. If you do check Hourly Group, when employee salary information is imported, SalaryXL will validate that. if an employee is in an hourly group, the employee's salary data must be hourly.

5. Each group is assigned a Group Code and Group Name. Based on the Name, SalaryXL also creates a Worksheet Name that will be utilized within the workbooks it generates for salary reviews within this group. To change the name, enter new text in the Name text box. (The name must begin with the three characters in the Group Code, but you can make other changes.) To change the Worksheet Name, enter new text in the Worksheet Name text box. You can use any worksheet name Excel will accept. Changes to these settings will not affect reviews that have already been approved. If you change the Group Code without making corresponding changes in your Organization File, SalaryXL will not be able to find that import the salary reviews for this group.

6. When you've finished making changes, click the (e.g., shown in blue) Save Changes hyperlink to store and apply those changes. You might at some point decide to restore the entries in a SalaryXL dialog box to where they were before you started editing them. If you have not yet clicked Save Changes, click Refresh, and the original entries will reappear.

Whenever you're finished working within the Increase Definitions Maintenance Screen dialog box, click the (e.g., shown in blue) Close Form hyperlink to close the dialog box

Creating a New Group

To add a new group, display the Increase Properties tab of the Increase Definitions Maintenance Screen, and follow these steps:

1. Click Add New Increase. All text boxes and checkboxes on the Increase Properties tab are blanked, awaiting your entries.

2. Enter a new Name for your group.

3. Enter a new Group Code for your group. This information must correspond to a code utilized in your Organization File; typically, mapped to values in your HRMS system. Group codes are three characters, usually combinations of uppercase letters.

4. Set an effective date for the target increases and adjustments that apply to your new group, by typing the date in the Effective Date text box (MM/DD/YYYY format); or by clicking its down-arrow and choosing a date from the calendar. This date must be in the future.

5. In the five Increase Component fields beneath Effective Date, specify values for each increase component you want to include. These field's names are not customized for your individual company. For example, you might have a “Merit” increase component, a “Bonus” increase component, and/or a “Promotion” increase component. In the administrator's tool, SalaryXL will refer to these on this screen as Increase, Adjustment, Adjustment (2), adjustment (3) and Bonus. These names are for reference only and may be different from what you are using these targets for.

6. If you want to work with hourly rates, check the Hourly Group check box. If you prefer to work with annual salary amounts, leave it unchecked.

7. In the Worksheet Name text box, enter the name you want to be applied to the first worksheet in all Excel workbooks generated for this group. If you change the Group Code without making corresponding changes in your Organization File, no salary changes associated with the group will be processed during the import of Salary Reviews.

8. When you've finished entering information for your new group, click the (e.g., shown in blue) Save Changes hyperlink to store and apply those changes

Deleting a Group

To delete an existing group, follow these steps:

1. Select the group's name from the Increase Definition drop-down list at the top of the dialog box.

2. Click the (e.g., shown in blue) Delete Increase hyperlink.

3. A warning dialog box appears. Click Yes to confirm that you want to delete the group. Only delete a group if you are sure you no longer want to use it. Once you delete the group, it cannot be restored and it must be recreated using Add New Increase.

Defining Default Excel Settings for an Individual Group

One key advantage of using groups is that you can specify different business rules and guidelines for salary reviews in each group. With SalaryXL, you accomplish this by specifying which Excel templates are used for each group. Since salary review processes change every year, you may also wish to change the Excel templates you use each year.

The XLS Template files and the Excel definition XML files are created during the SalaryXL implementation process. Salary planning administrators usually do not need to understand how to create these file, only their respective roles in the process

To specify the Excel template you wish to use with any group, display the Increase Definitions Maintenance Screen, and follow these steps:

1. Click Default Excel Settings. The Default Excel Settings tab appears (see FIG. 18).

2. Select the group's name from the Increase Definition drop-down list at the top of the dialog box.

3. To locate the Excel file you want to use, click the . . . (three dots) button to the right of the Default Template XLS File text box; then browse to the location where your SalaryXL template files are stored, select the file you want to use, and click Open. By default, templates are stored in the \jgim\templates folder of the drive where SalaryXL has been installed.

4. After you select a Template XLS file you will be prompted to select a sheet from that workbook. Select the sheet from the prompt. You can also enter the worksheet name you wish SalaryXL to use as the template. (Additional sheets will retain the names you've given them in the template workbook itself.)

5. SalaryXL uses a customized Excel Definitions XML file to map information between your database and the workbooks it creates, and to provide for proper formatting and validation. To specify the default Excel Definitions XML file SalaryXL will use for this purpose, click the . . . (three dots) button to the right of the Direct Mgr. Excel Def. XML File text box; then browse to the location where your SalaryXL template files are stored, select the file you want to use, and click Open.

6. When you're finished making changes, click the (e.g., shown in blue) Save Changes hyperlink to store them.

Defining Settings to Be Used by Direct or Indirect Managers

In many organizations, salary reviews are sometimes performed by direct managers and sometimes performed by indirect managers, including higher-level managers reviewing individuals who are more than one level beneath them in the organization. Direct and indirect managers may wish to see different information during their review processes. For example, indirect supervisors may wish to see summary information while direct supervisors may want to drill down into greater detail.

By default, direct and indirect managers see the same workbook, including the one you've just defined in the Default Excel Settings tab of the Increase Definitions Maintenance Screen. However, SalaryXL allows you to provide each with a different workbook. These differing workbooks can contain different data, and even different business rules, if necessary.

Changing Excel Settings for Direct Managers' Workbooks

To change the settings SalaryXL uses to generate Excel workbooks for direct supervisors:

1. Display the Increase Definitions Maintenance Screen dialog box.

2. Make sure you've selected the group you want to edit; if not, choose it from the Increase Definition drop-down box.

3. Click Direct Mgr. Excel Settings. The Direct Mgr. Excel Settings tab appears (see FIG. 19).

4. Clear the Use Default Excel Settings for Direct Managers check box. The tab's other settings become available for editing.

5. To locate the Excel file you want to use, click the . . . (three dots) button to the right of the Default Template XLS File text box; then browse to the location where your SalaryXL template files are stored, select the file you want to use, and click Open.

6. After you select a Template XLS file you will be prompted to select a sheet from that workbook. Select the sheet from the prompt. You can also enter the worksheet name you wish SalaryXL to use as the template. (Additional sheets will retain the names you've given them in the template workbook itself.)

7. To specify the default XML file that SalaryXL will use in generating workbooks for direct managers, click the . . . (three dots) button to the right of the Direct Mgr. Excel Def. XML File text box; then browse to the location where your SalaryXL template files are stored, select the file you want to use, and click Open.

8. When you're finished making changes, click the (e.g., shown in blue) Save Changes hyperlink to store them.

Changing Excel Settings for Indirect Managers' Workbooks

To change the settings SalaryXL uses to generate Excel workbooks for indirect supervisors:

1. Display the Increase Definitions Maintenance Screen dialog box.

2. Make sure you've selected the group you want to edit; if not, choose it from the Increase Definition drop-down box.

3. Click Indirect Mgr. Excel Settings. The Indirect Mgr. Excel Settings tab appears (see FIG. 20).

4. Clear the Use Default Excel Settings for Indirect Managers check box. The tab's other settings become available for editing.

5. To locate the Excel file you want to use, click the . . . (three dots) button to the right of the Default Template XLS File text box; then browse to the location where your SalaryXL template files are stored, select the file you want to use, and click Open.

6. After you select a Template XLS file you will be prompted to select a sheet from that workbook. Select the sheet from the prompt. You can also enter the worksheet name you wish SalaryXL to use as the template. (Additional sheets will retain the names you've given them in the template workbook itself.)

7. To specify the default XML file that SalaryXL will use in generating workbooks for indirect managers, click the . . . (three dots) button to the right of the Indirect Mgr. Excel Def. XML File text box; then browse to the location where your SalaryXL template files are stored, select the file you want to use, and click Open.

8. When you're finished making changes, click the (e.g., shown in blue) Save Changes hyperlink to store them.

Loading Data

SalaryXL provides two methods of loading data, including via flat files pulled from you HRMS System, and via direct access to your HRMS Database. Either of these methods can be used to retrieve both employee and salary review data. The following section discusses the use of flat files pulled from you HRMS system.

Creating SalaryXL Files

SalaryXL uses the external Data Refresh Extract program to create the files it needs to manage the compensation review process. As part of the process of configuring SalaryXL for the first time, JGI worked with you to modify this program for your unique needs. On occasion, you may need to run the Data Refresh Extract program to regenerate your organization's files.

The location and name of the Data Refresh Extract program is defined under Settings. The Data Refresh Extract Generator described below is an EXAMPLE. Each extract generator delivered is custom for each installation. However, each extract generator will generate the files required by SalaryXL for the review process. You will receive documentation on your extract generator at implementation time.

To run the Data Refresh Extract program, choose Run Data Refresh Extract Generator from the File menu. The Data Refresh Extract Program dialog box appears (see FIG. 21). Follow these steps:

1. Step 1: Load SQR

a. Click on the . . . for the SQR File Directory. This is the directory where the output files from your HRMS reside.

b. Click the Load SQR Into Memory button (this button is disabled until you complete Step 1a). This will load the output files into memory for processing.

When Step 1 is complete, you will be able to proceed to Step 2.

2. You should review the statistics and click View Log to see what exceptions may have been generated during Step 1.

3. Step 2: Generate Extracts

Click the Generate Text Files For Import button (this button is disabled until you complete Step 1. Depending on your organization's needs, the output files from Step 1 will be processed generating the required SalaryXL files that can be can be loaded for employees, salary history, and salary reviews.

You should review the records exports and note the location of the exported files which will be indicated in green in the bottom status area.

Import Employee Data

SalaryXL enables you to import employee data extracted from your HRMS. One of the output files from Creating Salary XL Files process is a file to be used to import Employee Data.

To run the Import Employee data, choose Import Employee from the Employees menu. The Import Employees from Text File dialog box appears (see FIG. 22). Follow these steps:

1. Click the . . . to find the location and name of the file to import.

2. Click Use Template Employee to default any missing data for an Employee.

3. Choose an Action to handle Unidentified Fields. The choices are:

a. Throw_Exception—this will halt the processing and require you to correct the problem.

b. Ignore_the_Field—this will continue the process and ignore the field.

c. Create_User_Field—this will dynamically add a user field for employees in SalaryXL.

4. Create New Employee Record if Employee not found.

a. Checked—Any records in the file that do not match an employee already in SalaryXL for this Review Cycle will be loaded.

b. Unchecked—Any records in the file that do not match an employee already in SalaryXL for this Review Cycle will be ignored and not loaded.

5. Click the (e.g., shown in blue) hyperlink Continue to begin loading the file.

Click the (e.g., shown in blue) hyperlink Cancel to cancel the process and return to the main screen of the SalaryXL Administration Tool.

6. When the load is complete, you will receive a confirmation indicating how many records were loaded. Click OK and you will return to the main screen of the SalaryXL Administration Tool.

Import Salary History Data

SalaryXL enables you to import historical employee review data extracted from your HRMS . . . . This information is optional but can be beneficial in supporting your managers during the compensation review process. One of the output files from Creating SalaryXL Files process is a file to be used to import Salary History.

To run the Import Salary History data, choose Import Salary Histories from the Employees menu. The Import Salary Histories from Text File dialog box appears (see FIG. 23). Follow these steps:

1. Click the . . . to find the location and name of the file to import.

2. Choose an Action to handle Unidentified Fields. The choices are:

a. Throw_Exception—this will halt the processing and require you to correct the problem.

b. Ignore_the_Field—this will continue the process and ignore the field.

3. Ignore Unknown Employees:

a. Checked—Any records in the file that do not match an employee loaded from the.

Import Employee Data process will not be loaded.

b. Unchecked—All records in the file will be loaded.

4. Click the (e.g., shown in blue) hyperlink Continue to begin loading the file.

Click the (e.g., shown in blue) hyperlink Cancel to cancel the process and return to the main screen of the SalaryXL Administration Tool.

5. When the load is complete, you will receive a confirmation indicating how many records were loaded. Click OK and you will return to the main screen of the SalaryXL Administration Tool. Depending on the size of your organization and the number of years of Salary History to be loaded, this process could be time consuming.

Importing Salary Review Information

SalaryXL draws on information about your organization's structure and reporting relationships as well as data needed to perform salary reviews in order to help you manage the salary review process. When you first begin working with SalaryXL, you will import this information using a Salary Review Import file (Created by your extract generator) also known as an Organization File or Org file for short. This process can be rerun iteratively in order to reflect organizational changes such as new hires, promotions, reorganizations, and transfers with in your organization.

The information SalaryXL relies upon typically originates in your HRMS or other enterprise system. SalaryXL can be configured to draw it from the HRMS directly. However, many companies find it easier to first export this data to an Excel workbook; make any necessary edits; and then import the data into SalaryXL.

To import a new organization file or to refresh salary review information, follow these steps:

1. Click Org File Import on the toolbar, or choose Update Salary Reviews form File (Org File) from the Salary Reviews menu. The Update Database From Organization File dialog box opens (see FIG. 24). As a precursor to this step, you can validate your file by choosing Validate Salary Review Import File from the Salary Review menu. The location and name of the file that will be validated is the file specified in the update salary review from import file dialog shown below.

2. In Manager Options, choose one of the following options:

Refresh (update the list of managers): Use this option for initial load of your SalaryXL database, or iterative updates. Displays all changes made since the last time you updated salary review information, does not delete any managers, or any “impersonations.”

Delete: Deletes all managers in the current Organization File, so you can start over. Delete is most commonly used when you are starting a new salary review cycle, or when you are testing the system. When you use this option, also select Delete the Old Salary Reviews and Create New Empty Reviews, in the Salary Review Options area of this dialog box.

Do Not Update Managers: Use this option when you are only updating the Salary Review Options that are discussed next, and you don't want to make changes to your list of managers or their reporting relationships.

3. In Salary Review Options, choose one of the following options:

Refresh the Existing Reviews with Data in the Organization File: Replaces reviews you've recently performed with earlier data stored in your organization file.

Delete the Old Salary Reviews and Create New Empty Reviews: For testing, or for preparing to start an entirely new review cycle, use this option along with Delete, in the Manager Options area of this dialog box.

Do Not Update Salary Reviews: Use this option when you are only updating the Manager Options that were discussed previously, and you don't want to make changes to your salary review options. You can also use this option if you deleted a manager by mistake, and don't want to store the deletion in your database; or if you need to validate salary review data.

4. Choose as many of the following checkbox settings as you want:

Abort Process if Increase Definitions Are Not Found. When you are salary review information for a review cycle, you'll want to make sure that increase definitions have been defined for each group your managers will be reviewing. When you check this box, if SalaryXL finds a group that does not have a corresponding increase definition, it stops and tells you where the problem exists. You can then fix the problem, return to this dialog box, and import the organization file. However, there may be times when the organization file contains your entire population of employees, but you only intend to process some of them. In this scenario, it may be acceptable to ignore groups where no increase definition exists, and you can clear this checkbox.

Create/Update Employee Records from Org File. With this checkbox checked, SalaryXL will rely on the Organization File for its list of employee names. With this checkbox cleared, SalaryXL will return to the database tables in its built-in database. Check this box if you are creating alias (fake) names for training purposes, or if you need to correct names that are incorrect in your HRMS system.

Ignore Hourly/Salary Employee Check. When an organization file contains a mix of hourly and annual employees, Hourly/Salary Employee Check normally validates that each employee fits into the right category, and that calculations combining hourly and annual employees are made accurately. In rare cases, you may have unusual salary arrangements that require special processing. In these cases, check this checkbox to turn off Hourly/Salary Employee Check. Toggling this feature on and off does not affect your Hourly Groups settings on the Increase Properties tab of the Increase Definitions Maintenance Screen dialog box.

5. Once you've completed establishing settings, click Continue. To abandon the process of updating your Organization File at any time, click Cancel. The dialog box will close, and all changes you've made will be lost.

During the import process, SalaryXL compares each salary review record in the import file with the records currently stored in SalaryXL. When it finds a discrepancy in the review process routing path, the Change in Employee Routing Path or Group Code dialog box will appear (see FIG. 25). If this is your first time importing the organizational file, you should not see this dialog box.

In this dialog box, you can review the changes in your organization file that SalaryXL detects. Changes in the organization file could have resulted from manual adjustments made via the department tab in SalaryXL, a prior import, or from changes being pulled in from your HRMS system. Changes made in manually SalaryXL via the department tab will indicate that the change was made manually via a message at the bottom of the screen. For example, if you've chosen Refresh (update the list of managers), this dialog box will list all changes to your organization's reporting structure since the last time you updated salary review information. Changes to reporting structure may include new employees; promotions and demotions; and individuals who've been reassigned to different reporting relationships.

Current reporting structure will be listed in the Existing Employee Reporting Structure scroll box; new reporting structure will be displayed in the New Employee Reporting Structure scroll box. You can scroll through either box to review SalaryXL's proposed changes.

As you review proposed changes in this dialog box, you can control how (or whether) they are updated.

To accept the proposed change, click the (e.g., shown in blue) Update Merit Record hyperlink.

To tell SalaryXL not to import a specific change, select it and click the (e.g., shown in blue) Ignore this Merit Record hyperlink.

To cancel the entire import or update process, click the (e.g., shown in blue) Cancel Import hyperlink.

If you are changing a large group of people whose review process will be similar, you can specify the changes once, and instruct SalaryXL to make the same changes for each individual. To do so, check the Apply Settings to All Records checkbox in the top right of the dialog box. (As an example, if you are moving one department to another location in the organization; you might Apply Settings to All Records of individuals within that department.)

Once you make a decision to update or ignore a record, SalaryXL continues to process remaining records. As it proceeds, it will display any further changes and you can accept or reject each new or replacement record, one at a time.

If SalaryXL cannot find the information it needs about a specific employee, it will give you a choice, wherein you can either skip the employee or abort the process.

6. When the import or update process is complete, SalaryXL displays a dialog box listing what it has done (see FIG. 26).

Managing Employees

Drawing on your HRMS or other enterprise systems, SalaryXL stores a list of all employees that will be in the compensation review process. When the Import Employee process was completed, it created an initial list of employee. As administrator, you can control this list and edit, add, or delete employee information. To edit employees, click Edit Employees on the toolbar, or choose Edit Employees from the Employees menu. The Edit Employees for all Review Cycles Screen appears (see FIG. 27).

Commands in the Edit Employees for all Review Cycles Screen

Add New Employee allows you to create a new employee that will have its own Properties.

Edit Employee allows you to edit the selected employee that will have its own Properties.

Delete Employee(s) allows you to delete existing employee(s).

Close Form closes the entire dialog box.

You sort this list by any column, by clicking on the column header. To reverse the order in which SalaryXL displays its list of employees, click on the same column header again.

You can also filter this list by:

Employee name, Employee ID (Emplid), or Logon Account by entering a value in the respective fields and clicking the Go button.

Clicking the Select All Employees button will show all employees.

Clicking the Select Admin Users button will filter the list and show only those employees who are enabled as admin users.

Clicking the Mgrs—All Review Cycles button will filter the list and show only those employees who are managers. The filter will show managers from all review cycles.

Clicking the Mgrs—This Review-Cycle button-will filter the list and show only those employees who are managers for the current review cycle.

If Display Active Employees Only is checked the list will be additionally filtered to only show those employees who have the Is Active flag checked.

If Show Custom Fields Grid is checked then the list will display any custom fields defined for employees and the values for the employees.

Editing Employees

Base Information

To edit base information for an existing employee, select the employee you wish to edit, then click Edit Employee. The Base Information tab of the Edit Employee dialog box appears (see FIG. 28).

You may enter the employee's name, logon account, email address, phone number, and password. You cannot change the employee ID associated with an employee already in the system.

1. In the Name text box, enter the employee's name, last name first

(e.g., SMITH, Robert L.)

2. Enter a Logon Account and Password for your employee; follow whatever formats your company has already established for these.

3. Optionally, include email and phone contact information.

When you're finished editing an employee's information, click the Save button to store that information. As soon as you've done so, the information will be available for use by SalaryXL.

Click the Cancel button to discard any changes you have made.

Salary History

To edit salary information for an existing employee, select the employee you wish to edit, then click Edit Employee. The Base Information tab of the Edit Employee dialog box appears. Now click the Salary History tab (see FIG. 29).

You can quickly review the salary history for an employee from this screen. Additionally, you can edit, add, or delete salary history.

Editing Salary History for an Employee

To edit salary history for an employee, select a salary history record then click the (e.g., shown in blue) Edit Salary History hyperlink. The Edit Salary History dialog box will appear (see FIG. 30).

You may enter the effective date, action, action reason, annual salary, hourly salary, change amount, and change percent. You cannot change the salary history ID or the employee ID associated with the salary review record.

When you're finished editing the salary history information, click the Save button to store that information.

Click the Cancel button to discard any changes you have made.

Salary History—User Fields (Advanced)

SalaryXL enables you to define up to 10 user defined fields for salary history. These fields can be used to store additional information about your employee's salary history that is not currently standard in SalaryXL. Adding user defined fields is for advanced users and you should consult with your SalaryXL Implementation Team before using.

To access the User Fields tab, click the User Fields tab on the Edit Salary History dialog box (see FIG. 31).

1. You can now enter or change the information in User Fields 1-10. On the right of each field, in parentheses, is the type and length of each field. The types are:

| Type | Length | Description |
|---|---|---|
| Chars | As indicated | Any character |
| Decimal | Unrestricted | Numbers and decimal point |
| Date Time | See description | MM/DD/CCYY HH:MM:SS |

2. Click the Save button to save your changes or click the Cancel button to close without saving.

Editing Salary History for an Employee

To add salary history for an employee, click the (e.g., shown in blue) Add Salary History hyperlink.

Deleting Salary History for an Employee

To delete salary history for an employee, select a salary history record then click the (e.g., shown in blue) Delete Salary History hyperlink.

Flags and Options

SalaryXL provides six “flags” you can use to set attributes for employees. By default, none of these flags are turned on. To set these flags for an employee, select the employee you wish to edit, then click Edit Employee. Now click the Flags and Options tab (see FIG. 32).

Account Disabled (User Cannot Logon to Merit System): Checking this box prevents the user from logging on to the system. You might use this checkbox when you want to temporarily place the system off-limits without eliminating the employee's account completely.

Notify by Email When New Messages Arrive: Checking this box tells SalaryXL to send an email message to the user whenever he or she receives a message within SalaryXL's internal messaging system.

Admin User: Checking this box gives a user the same administrative rights and access to the administrator's tool that you have.

User Can Impersonate Another User: Checking this box allows the user to act in place of another manager, performing that manager's salary reviews. Before this can happen, you must specify who the manager is authorized to impersonate. (This option allows you to set up impersonations, leave them configured, but turn them on temporarily, only when needed.)

Authenticate Using Active Directory: Checking this box instructs SalaryXL to rely on Microsoft Active Directory for authentication of this user, supporting a single-sign-on environment. With this box checked, SalaryXL disregards any password information stored for this employee.

Is Active Employee: Checking this box instructs indicates that this employee is active for the compensation review process.

When you're finished setting the flags for the employee, click the Save button to store that information. As soon as you've done so, the information will be available for use by SalaryXL.

Click the Cancel button to discard any changes you have made

Education

SalaryXL enables you to optionally store education information for an employee. This information may be useful for managers during the review process. To edit education information for an existing employee, select the employee you wish to edit, then click Edit Employee. Now click the Education tab (see FIG. 33).

You may enter any of the educational information for the employee.

When you're finished editing an employee's education information, click the Save button to store that information. As soon as you've done so, the information will be available for use by SalaryXL.

Click the Cancel button to discard any changes you have made

All Properties (Advanced

You can readily view and change all information stored for an employee in SalaryXL by accessing the All Properties tab of the Edit Employee dialog box. Only advanced users should make changes on this tab. To access the All Properties tab for an existing employee, select the employee you wish to edit, then click Edit Employee. Now click the All Properties tab (see FIG. 34).

You can view and change any of these properties for an employee. Each section can be collapsed or expanded by clicking the plus ‘+’ or minus ‘−’ next to the section header.

When you're finished, click the Save button to store that information. As soon as you've done so, the information will be available for use by SalaryXL.

Click the Cancel button to discard any changes you have made.

User Fields (Advanced)

SalaryXL enables you to define up to 10 user defined fields for each employee. These fields can be used to store additional information about your employees that is not currently standard in SalaryXL. Adding user defined fields is for advanced users and you should consult with your SalaryXL Implementation Team before using.

To access the User Fields tab for an existing employee, select the employee you wish to edit, then click Edit Employee. Now click the User Fields tab (see FIG. 35).

1. You can now enter or change the information in User Fields 1-10. On the right of each field, in parentheses, is the type and length of each field. The types are:

| Type | Length | Description |
|---|---|---|
| Chars | As indicated | Any character |
| Decimal | Unrestricted | Numbers and decimal point |
| Date Time | See description | MM/DD/CCYY HH:MM:SS |

2. Click the Save button to save your changes or click the Cancel button to close without saving.

Custom Fields (Advanced)

In addition to ten user defined fields, SalaryXL enables you to define any number of custom defined fields for each employee. These fields can be used to store additional information about your employees that is not currently standard in SalaryXL. Adding custom defined fields is for advanced users and you should consult with your SalaryXL Implementation Team before using.

To access the Custom Fields tab for an existing employee, select the employee you wish to edit, then click Edit Employee. Now click the Custom Fields tab (see FIG. 36).

To refresh the list, click the (e.g., shown in blue) Refresh hyperlink.

To edit an existing custom field, highlight the custom field and click the (e.g., shown in blue) Edit Custom Field hyperlink. You have the ability to specify the field name, its value, the field type, and max length.

To add a new custom field, simply type the information in on the new line were the ‘*’ appears.

To delete an existing custom field, highlight the custom field and click the (e.g., shown in blue) Delete Custom Field hyperlink.

When you're finished, click the Save button to store that information. As soon as you've done so, the information will be available for use by SalaryXL.

Click the Cancel button to discard any changes you have made.

Adding a New Employee

To add a new employee click Add New Employee on the Edit Employees for all Review Cycles Screen. the Add Employee dialog box will appear (see FIG. 37).

Adding a new employee is the same as editing an existing employee, except that you need to provide the emplid field for the new employee.

1. Complete the rest of the information on Add Employee dialog box.

2. Click Add to Add the employee, close the Add Employee dialog box, and return to the Edit Employees for all Review Cycles Screen.

3. Click Cancel to cancel the add request and return to the Edit Employees for all Review Cycles Screen

Deleting Employees

In most cases, employee terminations are handled within your HRMS or other enterprise system. On occasion, however, you may wish to delete an employee within SalaryXL. To delete employee(s), select the employee(s) you wish to delete, then click Delete Employee(s) on the Edit Employees for all Review Cycles Screen.

Deleting employees deletes all information, including review history, for the selected employee(s). If the employee is designated as a manager, the manager information will also be removed.

If you have only selected one employee to delete, the Delete Employee dialog box will appear (see FIG. 38).

Click Delete to delete the employee, close the Delete Employee dialog box, and return to the Edit Employees for all Review Cycles Screen.

Click Cancel to cancel the delete request and return to the Edit Employees for all Review Cycles Screen.

If you selected more than one employee to delete, the Delete Confirmation will appear (see FIG. 39).

Click Yes to delete the selected employees, close the Delete Confirmation, and return to the Edit Employees for all Review Cycles Screen.

Click Cancel to cancel the delete request and Edit Employees for all Review Cycles Screen.

Managing Employee Reviews

As you begin to use SalaryXL for your compensation review process, any reviews completed using SalaryXL will stored in SalaryXL. As administrator, you can view, edit, add, or delete salary review information for employees. To edit salary reviews for employees, click Edit Reviews on. the toolbar, or choose Edit Employee Reviews from the Salary Reviews menu. The Edit Employee Salary Reviews Screen appears (see FIG. 40).

Commands in the Edit Employees for all Review Cycles Screen

View allows you to view-only the salary history for the selected employee.

Add New allows you to create a new salary review for the selected employee.

Edit allows you to edit the salary review for the selected employee.

Delete allows you to delete salary review history for the selected employee.

Close Form closes the entire dialog box.

You sort this list by any column, by clicking on the column header. To reverse the order in which SalaryXL displays its list of employees, click on the same column header again.

You can also filter this list by:

Employee name, Employee ID (Emplid), or Logon Account by entering a value in the respective fields and clicking the Go button.

Clicking the Select All Salary Reviews button will show all employees.

Clicking the Current Mgr Employees button will filter the list and show only those employees who report to the selected manager on the Managers tab.

Quick View shows only 5 columns of information regarding the employees review.

All Columns (except Custom) shows all columns of information regarding the employees review except for custom fields.

Show Custom Fields Grid is checked then the list will display any custom fields defined for employees and the values for the employees.

Editing Reviews

Base Information

To edit base information for a review for an employee, select the employee you wish to edit, then click Edit. The Base Information tab of the Edit Salary Review for Employee dialog box appears (see FIG. 41).

The Emplid/Name cannot be changed. Direct Manager and Department cannot be changed on this tab—they can be changed on the Routing Path/Mgr Records tab.

1. Choose a Group Code from the drop-down list. The drop-down list will only list valid group code for the current review cycle.

2. You can then enter any of the other information indicated.

When you're finished, click the Save button to store that information.

Click the Cancel button to discard any changes you have made.

Routing Path/Mgr Records

The direct manager, department, and review routing path were established for all employees during the process to load salary review information. SalaryXL provides you the ability to alter the routing path or direct manager for any employees review. To view or edit the routing path or direct manager information for an existing employee, select the employee review you wish to edit, then click Edit. The Base Information tab of the Edit Salary Review for Employee dialog box appears. Now click the Routing Path/Mgr Records tab (see FIG. 42).

Commands in the Routing Path/Mgr Records tab

Add Manager displays the Select an Employee dialog for selecting employee enabling you to select an employee as manager for this review process.

Edit Manager allows you to edit the manager review record for the employee's review.

Delete Manager deletes the selected manager from the routing path list.

Set As Current sets the selected manager as the employee's current direct manager. Any other manager who is currently set as the current manager will be set to no.

Move Up moves the selected manager up in the routing path list. The result is that the selected manager is lower on the actual routing path for the review.

Move Down moves the selected manager down in the routing path list. The result is that the selected manager is higher on the actual routing path for the review.

Refresh will refresh the routing path list. If you are comfortable with manually entering the SalaryXL routing path, you can do so in the entry field and then click Refresh to visually see the results in the routing path list.

Click the Save button to save any changes. If the changes you have made result in a change in the routing path for the employee review, you will be need to tell SalaryXL how to handle the routing path change.

Click the Cancel button to cancel any changes and return to the Edit Salary Review for Employee dialog box.

Editing Manager Employee Review Records

The review information provided by each manager in the routing path can be viewed and edited. To view or edit the manager review information, select the manager you wish to edit, then click Edit Manager. The Manager Data for Employee Review Record tab of the Edit Manager Record for Employee Review dialog box appears (see FIG. 43).

The Emplid/Name for the employee or the manager cannot be changed.

You can then enter/edit any of the other information as needed.

When you're finished, click the Save button to store that information.

Click the Cancel button to discard any changes you have made.

All Properties (Advanced)

You can readily view and change all information stored for a review for an employee in SalaryXL by accessing the All Properties tab of the Edit Salary Review for Employee dialog box. Only advanced users should make changes on this tab. To access the All Properties tab for a salary review for an existing employee, select the employee review you wish to edit, then click Edit. Now click the All

Properties tab (see FIG. 44).

You can view and change any of these properties for the manager's review. Each section can be collapsed or expanded by clicking the plus ‘+’ or minus ‘−’ next to the section header.

When you're finished, click the Save button to store that information.

Click the Cancel button to discard any changes you have made.

Managing Changes in the Review Routing Path

When you save a review, SalaryXL compares the review record with the current record currently stored in SalaryXL. When it finds a discrepancy in the review process routing path, the Change in Employee Routing Path or Group Code dialog box will appear (see FIG. 45).

In this dialog box, you can review the changes that SalaryXL detects.

Current reporting structure will be listed in the Existing Employee Reporting Structure scroll box; new reporting structure will be displayed in the New Employee Reporting Structure scroll box. You can scroll through either box to review SalaryXL's proposed changes.

The message in the Employee Group Validation area will indicate if you need to enter a New Department. There are some cases where the same routing path is ready defined for another group of employee(s). In which case, SalaryXL will detect this and just want you to accept the change. New Department is required when you have defined a new unique routing path.

When entering a new department you should click the (e.g., shown in blue) Validate New Department hyperlink to insure that the New Department is unique.

As you review proposed changes in this dialog box, you can control how (or whether) they are updated.

To accept the proposed change, click the (e.g., shown in blue) Apply Changes To Record hyperlink. This hyperlink is not active until you have entered a New Department when required.

To tell SalaryXL not to import a specific change, select it and click the (e.g., shown in blue) Keep Old Routing Path hyperlink.

To cancel the entire import or update process, click the (e.g., shown in blue) Cancel Update hyperlink.

If you choose to update the record, SalaryXL will process the request and update totals for managers affected by the change. When processing is complete, you will be returned to the Edit Employee Salary Reviews screen.

If you choose to not update or cancel, you will be returned to the Edit Employee Salary Reviews screen.

All Properties (Advanced)

You can readily view and change all information stored for a review for an employee in SalaryXL by accessing the All Properties tab of the Edit Salary Review for Employee dialog box. Only advanced users should make changes on this tab. To access the All Properties tab for a salary review for an existing employee, select the employee review you wish to edit, then click Edit. Now click the All Properties tab (see FIG. 46).

You can view and change any of these properties for a review for an employee. Each section can be collapsed or expanded by clicking the plus ‘+’ or minus ‘−’ next to the section header.

When you're finished, click the Save button to store that information. As soon as you've done so, the information will be available for use by SalaryXL.

Click the Cancel button to discard any changes you have made

Custom Fields (Advanced)

SalaryXL enables you to define any number of custom defined fields for reviews for employees. These fields can be used to store additional information about reviews for your employees that is not currently standard in SalaryXL. Adding custom defined fields is for advanced users and you should consult with your SalaryXL Implementation Team before using.

To access the Custom Fields tab for reviews for an existing employee, select the employee you wish to edit, then click Edit. Now click the Custom Fields tab (see FIG. 47).

To refresh the list, click the (e.g., shown in blue) Refresh hyperlink.

To edit an existing custom field, highlight the custom field and click the (e.g., shown in blue) Edit Custom Field hyperlink. You have the ability to specify the field name, its value, the field type, and max length.

To add a new custom field, simply type the information in on the new line were the ‘*’ appears.

To delete an existing custom field, highlight the custom field and click the (e.g., shown in blue) Delete Custom Field hyperlink.

When you're finished, click the Save button to store that information.

Click the Cancel button to discard any changes you have made.

Viewing a Salary Review for an Employee

If you just want to view the salary review for an employee and not make any changes, select the employee whose salary review you wish to view, then click View on the Edit Employee Salary Reviews Screen. The View Salary Review for Employee appears (see FIG. 48).

You can view any information on any of the tabs, when you are finished, you can click on either the Close or Cancel button to return to the Edit Employees for all Review Cycles Screen.

Adding a New Salary Review for an Employee

When you have added a new employee or when a review for an employee hasn't been completed you may want to add a salary review for those employees. To add a salary review for an employee, click Add New on the Edit Employees for all Review Cycles Screen. The Add New Salary Review Record dialog box will appear (see FIG. 49).

Adding a new review record is the same as editing an existing salary review for an employee, except that you need to provide the Emplid field for the new employee.

Complete the rest of the information on Add New Salary Review Record dialog box.

Click Add to add the employee review, close the Add New. Salary. Review Record dialog box, and return to the Edit Employee Salary Reviews Screen.

Click Cancel to cancel the add request and return to the Edit Employee Salary Reviews Screen.

Deleting a Salary Review for an Employee

In some cases you may want to delete a review for an employee. You may want to do this if the review is outdated or if a review was entered erroneously. To delete salary review(s), select the employee salary review(s) you wish to delete, then click Delete Employee(s) on the Edit Employee Salary Reviews Screen.

If you have only selected one employee to delete, the Delete Employee dialog box will appear (see FIG. 50).

Click Delete to delete the salary review for the employee, close the Delete Salary Review for Employee dialog box, and return to the Edit Employee Salary Reviews Screen.

Click Cancel to cancel the delete request and return to the Edit Employee Salary Reviews Screen.

If you selected more than one salary review to delete, the Delete Confirmation will appear (see FIG. 51).

Click Yes to delete the selected salary reviews, close the Delete Confirmation, and return to the Edit Employee Salary Reviews Screen.

Click Cancel to cancel the delete request and Edit Employee Salary Reviews Screen.

Search for Employees Using Quick Search

SalaryXL contains a built-in search feature that allows you to rapidly locate information about any employee in the system, based on employee name, ID, or department. To use it, click Search Emps on the toolbar, or choose Search For Employee from the Organization Maintenance menu. The Employee Search dialog box opens, displaying the Quick Search tab (see FIG. 52).

Enter the employee's name, ID, or department in the appropriate text box, and click Go. SalaryXL displays a list of all employees matching that search, along with summary information about each of those employees.

You can drill down to more information on an employee by selecting his or her name from the list, and clicking the (e.g., shown in blue) Select Employee hyperlink. SalaryXL opens the Employee Reviews tab, with that employee's detailed information displayed, as further described herein. In SalaryXL, you can sort lists by any column, by clicking on the column header. To reverse the order in which SalaryXL displays a list, click on the same column header again.

Search for Employees Using Advanced Search

In large organizations, Quick Search may not be powerful enough for all your employee search requirements. Therefore, SalaryXL also offers an Advanced Search feature that permits you to search based on any field in its database, use search operators, and refine your search with multiple terms. To use Advanced Search, display the Employee Search dialog box and click Advanced Search. The Advanced Search tab opens (see FIG. 53).

To search by a field name, choose it from the Field Name drop-down box. Next, choose the operator and value you want SalaryXL to use. For example, to find all employees with an Old Salary less than or equal to $15.00 per hour, choose Old Salary as the Field Name; choose <=as the Operator, and chose $15.00 as the Value.

Depending on the Field Name you select, SalaryXL may provide a drop-down list of values to choose from. For example, if you select Group as your Field Name, SalaryXL displays a drop-down list of your groups.

To narrow or broaden your search results, you can use multiple search criteria.

To narrow your search, choose And in the And/Or column. A second row appears; enter a new search criterion there. SalaryXL will return only those employees who meet both search criteria.

To broaden your search results, choose Or in the And/Or column, and enter a new search criterion in the second row that appears. SalaryXL will return those employees who meet at least one of your search criteria.

By default, SalaryXL only displays direct managers in your search results. To display all managers that match your search criteria, including indirect managers, clear the Only Show Direct Manager checkbox.

Whenever you've finished specifying search criteria, click Go. SalaryXL will find the employees corresponding to the criteria you've specified. By default, SalaryXL only displays 100 rows of search results. To display more results, choose a different value from the Max Rows drop-down box.

Managers and Impersonations in the Review Cycle

Drawing on your HRMS or other enterprise systems, SalaryXL stores a list of all managers permitted to use it for salary review purposes. When the Import Organization process was completed, it created an initial list of managers. As administrator, you can control this list and edit, add, or delete managers. To administer managers choose Edit Managers and Impersonations in Review Cycle from the Review Cycles menu. The Edit Managers for this Review Cycle Screen appears (see FIG. 54).

Commands in the Edit Manager for this Review Cycle Screen

Add New Manager allows you to create a new manager that will have its own Properties.

Edit Manager allows you to edit the selected manager that will have its own Properties.

Delete Manager(s) allows you to delete existing manager(s).

Close Form closes the entire dialog box.

Your can filter this list by entering the Emplid for the manager you are searching for and then clicking the Go button. The manager record will now show in the list.

Clicking the Select All Managers will show all managers for this Review Cycle in the list.

Editing Managers

To edit an existing manager, select the manager you wish to edit, then click Edit Manager. The Manager Information tab of the Edit Manager dialog box appears (see FIG. 55).

You may specify the Excel template that will be used to generate salary review workbooks for use by this individual manager. To do so, click the . . . (three dots) button to the right of the XLS Template text box; browse to the template you want to use; select it; and click Open. If you don't choose a template, the manager's workbooks will be based on the template associated with his or her group.

SalaryXL also provides three “flags” you can use to set attributes for individual managers. By default, none of these flags are turned on.

Account Disabled (User Cannot Logon to Salary System): Checking this box prevents the user from logging on to the system. You might use this checkbox when you want to temporarily place the system off-limits without eliminating a manager's account completely.

Notify Manager by Email When New Messages Arrive: Checking this box tells SalaryXL to send an email message to the user whenever he or she receives a message within SalaryXL's internal messaging system

This manager can impersonate another user in this Review Cycle:

Checking this box allows the user to act in place of another manager, performing that manager's salary reviews. Before this can happen, you must specify who the manager is authorized to impersonate. (This option allows you to set up impersonations, leave them configured, but turn them on temporarily, only when needed.)

When you're finished editing a manager's information, click the Save buttons to store that information. As soon as you've done so, the information will be available for use by SalaryXL.

Click the Cancel button to discard any changes you have made.

Creating Impersonations

Often, an executive or manager will delegate the responsibility for either performing salary reviews or entering them into SalaryXL. As administrator, you can allow an assistant or other authorized individual to act on behalf of an executive or manager. To do so, use Manager Impersonations.

Display the Edit Managers for this Review Cycle Screen, choose a manager, click Edit Manager, and follow these steps:

1. Click the Manager Impersonations tab. The Managers Impersonations tab appears, displaying any impersonations already established for this manager (see FIG. 56).

2. Click Add New Impersonation. The Select Manager(s) dialog box appears (see FIG. 57).

3. Check the boxes corresponding to each manager you want to authorize this individual to impersonate. If the individual is authorized to impersonate any manager, click the (e.g., shown in blue) Select All Mgrs hyperlink. To clear all the impersonations you've just checked within this dialog box, click Select None.

4. When you're finished, click OK. The Manager Impersonation tab reappears.

5. Click Save Changes.

Choosing Select None does not eliminate impersonations you've previously added. You can delete them directly from the list of impersonations in the Managers Impersonations tab.

Once you've established impersonations for an individual user, when that user logs on they will be given a list of those impersonations and asked who they wish to impersonate. (If they are authorized to act on their own behalf, they will also be given that option.) If they choose an impersonation—and log on successfully—they have the same access to SalaryXL as the individual they are impersonating would have.

Deleting Impersonations

Once an impersonation has been created, you can eliminate it at any time. With the Manager Impersonations tab of the Edit Manager Screen displayed, follow these steps:

1. Highlight an impersonation you wish to delete. (You can select multiple impersonations at once by holding the Shift key down as you highlight them.

2. Click the (e.g., shown in blue) Delete Impersonation hyperlink to delete all the impersonations you've highlighted. Or, to delete all the impersonations associated with an individual manager, click the (e.g., shown in blue) Delete All hyperlink.

3. When you've finished making changes, click Save.

User Defined Fields (Advanced)

SalaryXL enables you to define up to 10 user defined fields for each manager. These fields can be used to store additional information about your managers that is not currently standard in SalaryXL. Adding user defined fields is for advanced users and you should consult with your SalaryXL Implementation Team before using.

Display the Edit Managers for this Review Cycle Screen, choose a manager, click Edit Manager, and follow these steps:

1. Click the User Fields tab. The User Fields tab appears, displaying any user fields already established for this manager (see FIG. 58).

2. You can now enter or change the information in User Fields 1-10. On the right of each field, in parentheses, is the type and length of each field. The types are:

| Type | Length | Description |
|---|---|---|
| Chars | As indicated | Any character |
| Decimal | Unrestricted | Numbers and decimal point |
| Date Time | See description | MM/DD/CCYY HH:MM:SS |

3. Click the Save button to save your changes or click the Cancel button to close without saving.

Adding a New Manager

To add a new manager click Add New Manager on the Edit Managers for this Review Cycle Screen. The Add New Manager dialog box will appear (see FIG. 59).

Adding a new manager is the same as editing an existing manager, except that you need to indicate the employee you are adding as a manager.

To select an employee you can enter the Emplid or Name for the employee. If you type an Emplid or Name that is not loaded into SalaryXL, you will see ‘Manager not found in Employee Table’. You can also click the . . . to get a list of employees in the Review Cycle. When you do this, you will get the Select an Employee dialog box (see FIG. 60).

You can use this dialog box just as described in section

Managing Employees. Once you highlight an employee and click the (e.g., shown in blue) Select Employee hyperlink, the Select an Employee dialog box will close and the selected employee will be populated in the Emplid/Name field.

Complete the rest of the information on Add New Manager dialog box.

Click Add to Add the employee as a manager to the Review Cycle, close the Add New Manager dialog box, and return to the Edit Managers for this Review Cycle Screen.

Click Cancel to cancel the add request and return to the Edit Managers for this Review Cycle Screen.

Deleting Managers

To delete manager(s), select the manager(s) you wish to delete, then click Delete Manager(s) on the Edit Managers for this Review Cycle Screen. Deleting managers does not delete the employee record for the manager, it only removes the employee as a manager.

If you have only selected one manager to delete, the Delete EmpManager dialog box will appear (see FIG. 61).

Click Delete to delete the manager, close the Delete EmpManager dialog box, and return to the Edit Managers for this Review Cycle Screen.

Click Cancel to cancel the delete request and return to the Edit Managers for this Review Cycle Screen.

If you selected more than one manager to delete, the Delete Confirmation will appear (see FIG. 62).

Click Yes to delete the selected managers, close the Delete Confirmation, and return to the Edit Managers for this Review Cycle Screen.

Click Cancel to cancel the delete request and Edit Managers for this Review Cycle Screen.

Tracking the Status of Any Manager's Salary Reviews

It's your job to make sure that your managers perform their salary reviews on time and consistent with your policies and budgets, and that your entire organization moves smoothly through the entire salary review cycle. The SalaryXL Administration Tool gives you a birds-eye view of the process. It also enables you to drill down to the perspective of any individual manager. By doing so, you can see exactly where that manager stands with the reviews he or she is responsible for—and you can follow up quickly and efficiently.

When you open SalaryXL, the Managers tab appears at the left edge of the screen. To view the overall status of your company's salary review cycle, choose Company from the list of names in the Managers scroll box. To view the status of an individual manager's salary reviews, choose that manager's name.

When you select either Company or an individual's name, the Tasks tab appears (see FIG. 63). This is the view of SalaryXL each manager sees when he or she launches the program. It presents the “world” of salary review through their eyes, including the tasks they've performed, the tasks they still need to perform, and the issues they may be encountering. For you, the administrator, this screen acts a control panel for reviewing all the salary review information associated with the Company or the individual you've chosen.

SalaryXL organizes the manager's responsibilities into three areas of the Tasks window:

Direct Reports—Salary Reviews: Provides options for performing salary reviews of individual employees the manager is responsible for, and for viewing the groups these employees belong to.

Indirect Reports—Salary Reviews: Provides options executives can use to review and approve salary recommendations made by their subordinate managers, as well as tools for viewing the structure of the entire organization. Options will only be available here if the manager you've selected actually has indirect reports.

Messages: Provides access to SalaryXL's internal messaging system, so managers can communicate securely about salary reviews with their colleagues, and with you, the SalaryXL administrator.

At the bottom of the Task tab, SalaryXL displays the percentage of reviews the manager has successfully completed during the current salary review cycle.

Viewing a Manager's Direct Report Salary Reviews

To review where an individual manager stands with his or her salary reviews, select the manager's name from the list in the Managers tab. Then, either click the (e.g., shown in blue) Review Direct Employees hyperlink, or click the Employee Reviews tab. The Employee Review tab appears (see FIG. 64). From here, you can review information about all the employees this manager is responsible for reviewing.

Filtering and Sorting Lists of Employees

You have two ways to filter the list of employees shown on this tab:

View Options allows you to choose whether to view the manager's Direct Employees Only (direct reports); Indirect Employees Only (indirect reports); or Both Direct & Indirect Employees. By default, SalaryXL shows Direct Employees Only.

Status Filter allows you to view only employees whose reviews are at a specific point in the process. For example, you can display lists of employees whose reviews have not yet begun (No Activity); or have been submitted to, approved by, or rejected by upper management. By default, the Status Filter is set to Groups Requiring My Attention, including all employees who belong to groups the manager has responsibility for.

You can also sort the lists by any column, by clicking on the column header. To reverse the order in which SalaryXL displays its list of employees, click on the same column header again.

Reviewing the Salary Review Status of an Individual Employee

Once you've displayed the list of employees you want to see, you can review the status of any individual employee by scrolling the list and displaying that employee's row. Since SalaryXL provides far more information than will fit on one typical PC screen, you may need to use the horizontal scroll bar to see all the information you're looking for.

SalaryXL typically provides the following categories of information, including Employee ID, Employee Name, Group, Direct Department, Manager's Department, Review Status, Old Salary, Performance Rating, Guideline %, Actual Increase %, Actual Increase $, Proration, Annual Increase $, Sec. Increase $, New Salary, Comments, Increase Target %, Sec. Target %, Direct Manager, Current Review Manager, Last Approved By, and Approval Path (a set of codes for the individuals who must approve this individual's salary adjustments.

Towards the bottom of the Employee Reviews tab, SalaryXL makes available additional information through six more tabs.

The first tab, Excel Sheet, gives you access to a mini-workbook from where you can actually perform salary reviews, just as if you were the manager whose information you're viewing. Excel Sheet is covered in the following section.

The other five tabs give you background information about the employee and how his or her salary review is being managed. The information provided on these tabs cannot be edited here.

Excel Definitions displays technical information about the definitions SalaryXL is using to build salary review workbooks and mini-workbooks that include this employee (see FIG. 65). It is primarily used for debugging

Salary History displays a history of changes to this employee's salary, including codes that specify the reason for the change, such as MER for merit raise, ADJ for adjustment (see FIG. 66).

Approval Routing Path displays a list of the managers who must approve this employee's salary adjustments, with information about where each of these managers stands in the review process (see FIG. 67). This tab gives you an overview of the entire review process as it relates to the employee you've selected.

Submission Status displays the review status of this employee and indicates whether or not you can submit the review for approval (see FIG. 68).

Job Info Fields displays detailed information about this employee and his or her job title, as captured from your HRMS or other enterprise system (see FIG. 69).

Using the Mini-Workbook to Perform a Salary Review

On occasion, you may need to perform a salary review yourself, on behalf of another manager in your organization. To do so, display the Tasks tab for the manager you're standing in for, and choose the employee you want to review. Next, display the Excel Sheet tab at the bottom of the screen, if it isn't displayed already (see FIG. 70).

Click the (e.g., shown in blue) Load Record hyperlink to display the mini-workbook where you can enter data (see FIG. 71).

This mini-worksheet reflects the business rules built into your salary review process. The figure illustrated above may not reflect the exact custom worksheet used in your company.

You can now enter data in any field formatted in yellow. For example, in the sample shown here, you can select a performance rating from the options programmed into the workbook. Similarly, you can enter an increase percentage.

Since SalaryXL provides far more information than will fit on one typical PC screen, you may need to use the horizontal scroll bar to see all the data fields you need to review or enter.

When you're finished, click Update Database. Your salary review information is entered into the system, and the employee's Review Status is updated for the next stage in the process. If you change your mind and wish to clear your edits before you've saved them, click Refresh Record.

Reviewing the Status of Approvals for Indirect Employees

In many organizations, multiple levels of management must approve any salary change. It's essential that senior managers perform timely reviews of the salary recommendations their subordinates have forwarded to them. SalaryXL makes it easy to monitor these “indirect” salary reviews.

To review the status of a manager's indirect salary reviews, first select the manager's name from the Managers tab. The Tasks tab appears. If the manager has indirect responsibilities, the Approve Indirect Employees option will be available. Select it. The Employee Reviews tab will appear, listing all indirect reports now awaiting this manager's review.

The Employee Reviews tab works the same for indirect reviews as for direct reviews. It contains all the options already discussed in the context of direct reviews, including View Options and Status Filters for filtering the lists it displays; the Excel Sheet that displays a mini-worksheet and performing reviews; Salary History, Job Information, and Approval Routing Path data; and more, as further described herein.

Generating an Overall Progress Report for a Manager

To see all of a manager's reviews at a glance, you can generate an Overall Progress Report. Click the (e.g., shown in blue) Overall Project Report hyperlink near the top of the Employee Reviews tab. SalaryXL will build a report and display it in a separate window (see FIG. 72).

In this report, reviews can be color-coded as follows:

| | |
|---|---|
| Blue | In Review |
| Green | Submitted/Approved |
| Red | Rejected |
| White | Waiting for Subordinate |

Viewing a Manager's Employee Groups

You may wish to review the groups a manager is responsible for, or review the lists of individual employees associated with any of these groups. To do so, select the manager's name from the list in the Managers tab. Then, either click the (e.g., shown in blue) View My Employee Groups hyperlink, or click the Employee Groups tab. The Employee Groups tab appears (see FIG. 73).

You'll notice that two lists are shown on this tab. The list at the top display groups and departments this manager has responsibility for. It provides summary information on the status of reviews and budgets for each department.

Remember that a group may include employees from many departments, and the same department may include individuals from more than one groups. One manager may supervise several different departments, each with its own budget restrictions—and perhaps its own business rules. SalaryXL is designed to smoothly accommodate these organizational complexities.

As in the Employees Review tab discussed earlier, you can filter the lists shown on this tab:

View Options lets you choose whether to view the manager's direct report, indirect reports, or both. By default, SalaryXL shows direct reports only.

Status Filter lets you view only employees whose reviews are at a specific point in the process. By default, the Status Filter is set to Groups Requiring My Attention, including all employees who belong to groups the manager has responsibility for.

Viewing All Employees in a Group and Department

When you select a row from the list of groups and departments at the top of the Employee Groups tab, SalaryXL displays a second list at the bottom of the window.

This second list, presented in the Employees in this Employee Group tab, contains every individual in the group and department you've selected. Using it, you can view detailed information on any individual employee, ranging from performance rating and review status to old and new salary.

Viewing the Budget Status of a Group and Department

As mentioned earlier, each department a manager is responsible for supervising is likely to have its own budgets and salary increase limitations. SalaryXL permits you to review where managers stand relative to budget for each department they're responsible for.

With the Employee Groups tab displayed, select a row corresponding to the Group and Department you want to review budget status for. Then, below, click the Budgets tab (see FIG. 74). SalaryXL shows where the manager stands in terms of budget allocation. It can display both a “primary” and a “secondary” budget (if one exists). You can download (generate) or upload Excel workbooks from within the Employee Groups tab.

To download a workbook for the manager you've already selected, click the (e.g., shown in blue) Download Excel Workbook hyperlink. The Select Groups to Export to Excel dialog box opens. Now, follow the directions, as further described herein.

To upload a workbook for the current manager, click the (e.g., shown in blue) Upload Excel Workbook hyperlink. The Upload Excel Workbook dialog box opens. Now, follow the directions in Uploading Excel Workbooks Managers Have Worked with Offline.

Viewing Organization Structure from any Manager's Perspective

As you track a manager's salary reviews, you may wish to see where that manager fits into your overall organization. SalaryXL enables you to quickly identify all the groups any manager belongs to, and who that manager reports to within each group.

First, in the Managers tab, choose the manager you want to review. Next, click the Departments tab. If the manager you've selected has indirect reports, you can also click the (e.g., shown in blue) View My Organization Structure hyperlink in the Tasks tab. The Departments tab opens, displaying all the hierarchies the manager is part of (see FIG. 75).

Each Group is listed separately, with its reporting structure listed from the top down to the manager you've selected. The manager you've selected appears in red. As shown in the example in this figure, a manager may be part of multiple groups. He or she may also be subject to multiple reporting relationships even within a group.

As elsewhere in the program, SalaryXL permits you to filter the groups and managers shown here. Use the View Options drop-down box to determine whether to view departments a manager is directly responsible for, indirectly responsible for, or both. By default, SalaryXL shows Direct Departments Only. Use the Status Filter drop-down box to view only employees whose reviews are at a specific point in the process. By default, it is set to Groups Requiring My Attention, including all employees who belong to groups the manager has responsibility for.

If the data shown is large and unwieldy, you can collapse listings within any group or beneath any individual manager, by double-clicking on the group or name. A plus (+) symbol will appear to the left of that row, indicating that more information is available; double-click on the row to display it all again.

To view all the individuals who report to any manager SalaryXL displays, click on that manager's name. Two tabs appear at the bottom of the screen, including Employees in this Employee Group, containing detailed information about individual employees who are part of the selected group, and/or report to the selected manager, as further described herein.

When you right-mouse click on any employee in the Employees in this Employee Group Tab, the menu in FIG. 76 will appear.

Edit The Merit Record For This Employee. Displays the Edit Salary Review or Employee screen for the selected manager.

Re-Assign The Employee Group For This Merit Record. Selecting this option enables you to assign the selected employee to another manager in the Review Cycle (see FIG. 77). The Re-Assignment process will remove the selected employee from the current Group Department and add the employee to the selected Group Department. This process will also update any totals for the effected managers.

To re-assign the selected employee:

1. Choose the desired group and click the box next to the Group Code

2. Click the (e.g., shown in blue) Re-Assign hyperlink.

To cancel the re-assign and not perform the re-assignment process, click the (e.g., shown in blue) Cancel hyperlink.

Budgets, displaying summary information about where the group or individual manager stands in terms of allocating budgets for salary adjustments, as further described herein.

On both the Departments and Employee Groups tabs, you can work with any individual employee in the list as you would in the Employee Reviews tab. To do so, double-click on any employee and the Employee Detail popup will display (see FIG. 78).

You can now work with this employee's review information as you would other sections, as further described herein.

Listing the Subordinate Managers Reporting to Any Manager

The Subordinate Managers tab gives you an easy way to view the employee groups any manager has responsibility for, and to drill down to direct or indirect reports within those groups. To display this tab, select the manager you wish to track, and click Subordinate Managers (see FIG. 79).

Towards the top of this tab, SalaryXL lists all managers who report to the manager you've chosen. Using the View Options drop-down box, you can filter this list to show only individuals who are direct reports; only indirect reports; or both. By default, SalaryXL shows direct reports only.

When you select a row containing one of these names, SalaryXL lists all the groups and departments containing individuals who report to that manager. This information appears at the bottom of the screen, in the Employee Groups Under This Manager tab.

Information presented in this tab includes the number of employees in each department and group who report to the manager you've selected, a summary of the status of their salary reviews; their total current and new salaries, summary increase percentages, and the next department and manager who will have to review salary increases for these individuals.

Within each group, a separate row will appear for each department containing employees this manager is responsible for. This reflects the reality that a manager might supervise—for example—teams of programmers and administrative assistants in different departments, with different salary guidelines.

Viewing the Statistics for Any Manager

The Statistics tab gives you an easy way to view the counts of Employees, Employee Groups, Departments, and Manager related to the selected manager. To display this tab, select the manager you wish to track, and click Statistics (see FIG. 80).

Downloading Excel Workbooks for Managers to Use Offline

You can use SalaryXL to generate Excel workbooks for use offline by managers, at their convenience. You may generate workbooks for any manager who is responsible for salary reviews within your organization. To create and store many workbooks at once, use SalaryXL's Batch Excel feature.

You may also filter the workbooks you create, by specifying groups. When you do, SalaryXL creates workbooks that include only employees within those groups, and exclude other employees that managers may be responsible for. To generate Excel workbooks for offline use, follow these steps:

1. Select the manager who will receive this workbook. To do so, highlight the managers' name in the Managers tab (see FIG. 81). If you choose Company, you will generate a workbook encompassing all individuals and groups throughout the entire company.

2. Once you've selected managers, click the Download Excel button on the toolbar, or choose Download Excel Workbook from the Excel Workbooks menu. The Select Groups to Export to Excel dialog box appears (see FIG. 82).

Here, you can control which groups you wish to include in the Excel workbooks you generate. You may include:

Direct Groups Only: Only groups containing individuals who are direct reports.

Indirect Groups Only: Only groups containing individuals who are indirect reports.

All Groups: Both direct and indirect groups.

Select Groups: Displays a list of groups; place a checkbox next to each group you want to include.

3. Optionally, you can limit SalaryXL to including only editable groups—in other words, items you are actually authorized to change. (For example, if you are a direct manager and you submit salary reviews to your own manager, you can no longer change them; similarly, if you are a higher-level manager awaiting reviews by a subordinate, those reviews don't become editable by you until your subordinate has performed them.) To limit your workbook to editable groups, check the Only Export Editable Groups checkbox.

4. When you select groups, the list of groups you've selected appears at the bottom of the dialog box, along with detailed information about each group.

Department: Provides the department code your company uses; typically drawn from your HRMS or other enterprise system.

Review Status: Displays the review's current status; for example, “Waiting for My Review,” or “Rejected by Upper Management.”

Direct Manager Names the manager who supervises the individuals in the groups contained in this workbook.

Editable? Specifies whether the group is editable, as discussed in the preceding step.

# Employees: Specifies the number of employees included in the group.

You can review the list and make adjustments. For example, if you decide not to include a group, you can clear the checkbox on the left edge of its row.

You can also click the (e.g., shown in blue) Select All hyperlink to select all groups or click the (e.g., shown in blue) Select None hyperlink to select none of the groups. These 2 hyperlinks provide a quick way of selecting groups especially when an organization has a large number of groups.

Sometimes, a large list of groups may appear in your list. If you decide that you only want one or two groups included in your workbook, click the (e.g., shown in blue) Select None hyperlink to clear all the checkboxes. Then, check the groups you want to include.

Conversely, if after removing some groups, you decide you'd rather include them all, click Select All. Checkboxes will appear next to each group, indicating that they will all be included in the workbook SalaryXL will generate.

5. When you're ready to generate your Excel workbook, click the (e.g., shown in blue) Generate Excel Workbook hyperlink. SalaryXL generates one or more Excel workbooks following the specifications you've set.

SalaryXL generates a new workbook, and opens it within Excel. Of course, this assumes Excel is installed on your computer.

Each workbook's name includes the manager's employee ID number to identify it. Each workbook contains a worksheet for each group. Finally, unless you've specified otherwise in the Increase Definitions Maintenance Screen, each workbook includes an introductory page explaining how it should be used.

If you plan to use the workbook later, or forward it to a colleague, save it within Excel. If you decide not to create a workbook, you can abandon your changes and close the dialog box by clicking the (e.g., shown in blue) Cancel hyperlink button—or, of course, by clicking the Close (X) button at the top right of the dialog box.

Uploading Excel Workbooks Managers Have Worked with Offline

Once you or your colleagues have performed salary reviews using the Excel workbooks you've generated, you must upload the finished workbooks back into SalaryXL. Until you do so, the results of the salary reviews included in these workbooks are not reflected anywhere in the SalaryXL system.

To upload an Excel workbook back into SalaryXL, follow these steps:

1: Select the manager whose workbook is to be uploaded. To do so, highlight the manager's name in the Managers tab.

2. Click the Upload Excel button on the toolbar, or choose Upload Excel Workbook from the Excel Workbooks menu. The Upload Excel Workbook dialog box appears (see FIG. 83).

3. Select the Excel file you want to upload. To do so, click the . . . (three dots) button to the right of the Select Excel File text box; then browse to the location where you've stored the Excel workbook you want to upload; select it, and click Open.

The workbook file you upload must belong to one of the managers you selected in Step #1. To make sure they match, make sure the last five digits of the workbook file match the five-digit employee ID listed in the Managers tab.

4. Click the (e.g., shown in blue) Step 1: Upload File hyperlink. SalaryXL will display a list of all Valid Salary Reviews within the workbook (see FIG. 84). In a separate tab, SalaryXL will display a list of any Errors/Messages, typically corresponding to reviews that are either incomplete or out-of-guideline (see FIG. 85).

5. If at least one valid performance (salary) review is present, you can continue the upload process. Click Step 2: Update Database. SalaryXL confirms that the database has been updated. If the errors and messages are unacceptable to you, you might choose to return the workbook to the manager instead of uploading it.

Accepting or Rejecting Salary Reviews

After a salary review has been performed, it must be accepted or rejected. To accept or reject a salary review, first select the reviewed individual from within the Employee Groups or Employee Reviews tab. Next, click the Accept/Reject Salary Review toolbar button or the (e.g., shown in blue) Accept/Submit Merit hyperlink. The Submit Salary Reviews for Approval dialog box opens (see FIG. 86), displaying information about the salary review. In addition to details about the compensation changes you want to make, it also contains the employee's group, your name, and the next approval manager who must receive your recommendation.

Review this information; you can edit the body of the message if you choose.

If you prefer not to send a covering message, clear the Send Message with Submission checkbox. The next manager in the hierarchy will find this employee's review awaiting them when they next log onto SalaryXL, but will not receive a separate message.

When you've finished reviewing and editing the message, click the (e.g., show in blue) Submit for Approval hyperlink. SalaryXL will confirm that you've completed accepting or rejecting the employee's salary review, and that the review has been moved to the next step in the process.

Creating Multiple Excel Workbooks At Once

As previously described, you learned how to generate one or more Excel workbooks for managers to use offline. SalaryXL also contains a batch Excel workbook generation feature for use when you need to create many workbooks all at once.

As with the Download Excel feature, you can create batches of workbooks for specific groups, or select individual managers (though, by default, Batch Excel Generation creates workbooks for every manager, as well as a summary workbook for the entire company). Batch Excel Generation, unlike Download Excel, also permits you to specify an output folder where all your workbooks will be placed.

To use Batch Excel Generation to create multiple Excel workbooks at once, follow these steps:

1. Click the Batch Excel button on the toolbar, or choose Batch Generation of Workbooks from the Excel Workbooks menu. The Batch Excel Generation dialog box appears (see FIG. 87).

2. Control which groups you wish to include in the Excel workbooks you generate. You may include:

Direct Groups Only: Only groups containing individuals who are direct reports.

Indirect Groups Only: Only groups containing individuals who are not direct reports.

All Groups: Both direct and indirect groups.

Select Groups: Displays a list of groups; place a checkbox next to each group you want to include.

3. Optionally, you can limit SalaryXL to including only editable groups. To do so, check the Only Export Editable Groups checkbox.

4. Optionally, in the Select Managers scroll box, clear the checkboxes associated with managers you do not wish to create workbooks for.

5. Optionally, in the Output Folder text box, change the location of the folder where SalaryXL will place the workbooks it is about to create. To do so, click the . . . (three dots) button to the right of the Select Excel File text box; then browse to the location where you've stored the Excel workbook you want to upload; select it, and click Open. (By default, SalaryXL stores workbooks in the \jgim\output\ folder of the drive where it is installed.)

6. When you're finished making selections, click Generate Excel Workbooks. If you change your mind and decide not to create a batch of workbooks, click Cancel. To start the batch workbook creation process over again, using SalaryXL's default settings, click Refresh.

Generating Reports

SalaryXL provides a collection of pre-defined reports. You can use these reports to get detailed information about the any manager's salary reviews. To run a report, follow these steps:

1. Select the manager you want to report on. To do so, highlight the manager's name in the Managers tab.

2. Click the Reports button on the toolbar, or choose Select and Run Reports from the Reports menu. The Report Selection dialog box appears (see FIG. 88).

3. Choose the report you want to create. SalaryXL offers five built-in reports, including Employee Reporting Structure, Employee Review Status, Ratings Distribution Summary, Salary Summary By Group, and Salary Summary By Manager.

4. Specify whether you want your report to encompass Direct Groups Only, Indirect Groups Only, or All Groups.

5. To run and display the report, click the (e.g., shown in blue) Run Report hyperlink.

When you run a report, it appears in a separate Report Viewer window (see FIG. 89). As shown in FIG. 90, the Report Viewer's toolbar provides commands for navigating, searching, and printing the report.

Using SalaryXL's Internal Messaging System

SalaryXL contains an internal messaging system that all authorized managers can use to communicate and share information about ongoing salary reviews. Requiring managers to use this messaging system for the salary review process gives you a powerful tool for restricting access to salary information. You can link, groups, names of employees, or performance (salary) review data, giving recipients access to this sensitive information without distributing workbooks or other information through your conventional message systems.

As SalaryXL administrator, you can review any message that has been sent through SalaryXL's internal messaging system. You can also send your own messages—for example, to encourage timely reviews, identify errors in colleagues' reviews, or to help colleagues resolve review-related problems

Reviewing a Manager's Messages

To review a manager's communications, first choose the manager from the Managers tab. Five (e.g., shown in blue) hyperlinked options appear in the Messages area:

View Inbox Displays messages currently in the manager's inbox, and tells how many messages are currently there.

Unread Messages Displays messages that have not yet been read, and tells how many unread messages are present.

View Sent Messages: Displays all messages this manager has sent, and tells how many messages he or she has sent.

Create a New Message: Displays a dialog box you can use to create a new message in the manager's name (or your own). To send a message as the SalaryXL administrator, choose Admin or Company as the manager's name.

When you choose View Inbox, Unread Messages, or View Sent Messages, SalaryXL displays the Messages tab, and shows the list of messages you've requested (see FIG. 91). You can also display the Messages tab by choosing Read Messages from the Messages menu.

Once the Messages tab is open, you can use the View Options drop-down box to choose any category of messages you want to review, including Sent Messages, Received Messages, All Messages Sent and Received, Unread Messages, Messages Linked to This Manager, or All Messages Sent, Received, or Linked.

To view an individual message, double-click on it, or select it and click the (e.g., shown in blue) Read Message hyperlink. The View Messages dialog box appears (see FIG. 92).

The To Manager drop-down box displays the name of the manager who received this message. The contents of the message appear in the Message Text box. If any groups or individual salary reviews were linked to the message, these are listed at the bottom of the dialog box. When you're finished reviewing an individual message, click the (e.g., shown in blue) Close Form hyperlink to close it.

Deleting a Message

To delete a message, select it in the Message tab, and click the (e.g., shown in blue) Delete Message hyperlink. The message is immediately deleted.

Creating New Messages

You can create a message either in your own name as Administrator, or on behalf of another manager on the system. To create a message in your own name, first choose Admin in the Managers tab. To create a message in another authorized manager's name, choose his or her name instead. Next, choose Create New Message from the Messages menu. The Create New Message dialog box appears (see FIG. 93). If the Tasks window is displayed, you can create a new message by clicking the (e.g., shown in blue) Create a New Message hyperlink. Or, if the Messages tab is already displayed, you can click the (e.g., shown in blue) Add Message hyperlink.

Follow these steps:

1. Choose a recipient from the list of authorized system users in the To Manager drop-down list box.

2. Enter a subject for your message in the Subject text box.

3. Enter the contents of your message in the Message Text box.

4. If your message concerns one or more specific employee groups, you can link them to your message, giving your recipient one-click access to the information they'll need to respond. To do so:

A. Click Add in the Linked Group area. The Select Employee Group dialog box opens. It lists the employee groups the sender has a role in reviewing (see FIG. 94).

B. Select one or more groups.

C. Click Select Employee Group(s). The Select Employee Group dialog box closes. The group(s) you've selected now appear in the Linked Groups area of the Send New Message dialog box. To delete a link to a group, select the group in the Linked Groups area of the Send New Message dialog box, and click the (e.g., shown in blue) Delete hyperlink there.

5. If your message concerns one or more specific employees or salary reviews, you can link them to your message. To do so:

A. Click Add in the Linked Employees/Salary Reviews area. The

Select Employee Group dialog box opens. It lists the employees the sender has a role in reviewing (see FIG. 95).

B. Select one or more employees.

C. Click Select Employee(s). The Select Employee(s) dialog box closes. The employee(s) you've selected now appear in the Linked Employees/Salary Reviews area of the Send New Message dialog box. To delete links to employees, select them in the Linked Employees/Salary Reviews area of the Send New Message dialog box, and click the (e.g., shown in blue) Delete hyperlink there.

6. When you've finished preparing your message, click the (e.g., shown in blue) Send Message hyperlink at the top of the Send New Message dialog box.

Archiving a Salary Review Cycle

When you complete a salary review cycle, you'll want to archive that information before you begin the next cycle. SalaryXL's archiving feature creates a snapshot of all your reviews as they currently stand, but it does not lock your current salary review cycle from further change.

To archive your SalaryXL data, choose Archive Cycle from the Exports menu. The Archive Cycle dialog box appears (see FIG. 96).

Enter a description in the Cycle Description text box, and click the (e.g., shown in blue)Archive Cycle hyperlink. SalaryXL will create the archive, and confirm that it has done so successfully. When you're finished working in this dialog box, or if you change your mind and decide not to archive now, click the (e.g., shown in blue). Close Form hyperlink.

Updating your HRMS

When you complete a salary review cycle, you may want to export that information so that you can update your HRMS.

To export your SalaryXL data, choose Generate Export File from the Exports menu. The Export dialog box appears (see FIG. 97).

A yellow message area can be used to indicate the status of increases that can be exported.

To Export increase information, follow these steps:

1. Choose a location for the export file by clicking on the . . .

2. Click on the (e.g., shown in blue) Export Increases hyperlink.

3. You will receive confirmation on the number of records exported.

When you're finished working in this dialog box, or if you change your mind and decide not to export now, click the (e.g., shown in blue) Close Form hyperlink.

You have the ability to export the same records as many times as you wish. Alternatively, you can lock previously exported increases so that they cannot be exported again (see FIG. 98). Typically, this is done after you have verified the Export file.

To lock previously exported increase information, click on the (e.g., shown in blue) Lock Previously Exported Increases hyperlink.

If you do not have any review records ready for export or you have locked previously exported increases, you will see the messages shown in FIG. 99.

Performing Advanced Administration Tasks

You've already mastered most of the tasks you'll need to perform as a SalaryXL administrator. This section covers some additional tasks you may need to perform on rare occasions, including Switching and cloning configuration files, Running the Excel Definition program, Updating from the HRMS System, Database Housekeeping, Defining Custom Fields, and Switching Configuration Files.

Normally, SalaryXL uses one configuration file throughout a full year's salary planning cycle. Occasionally, however, you may wish to review information from a previous year's cycle. To do so, you must switch to the previous year's configuration file. To do so, follow these steps:

1. Choose Switch Configuration File from the File menu. The Switch Configuration File dialog box appears (see FIG. 100).

2. Select a configuration file from the list of configuration files.

3. Click the (e.g., shown in blue) Switch Config File hyperlink.

4. Click the (e.g., shown in blue) Close Form hyperlink.

Cloning Configuration Files

When you create a new configuration file for a new year's salary planning cycle (or for any other purpose), it's often fastest to edit an existing file rather than starting from scratch. To “clone” a configuration file so you can edit a copy instead of the original, follow these steps:

1. Choose Switch Configuration File from the File menu. The Switch Configuration File dialog box appears.

2. Select a configuration file from the list of configuration files.

3. Click the (e.g., shown in blue) Clone Selected File hyperlink. The Clone Config File dialog box appears (see FIG. 101).

4. Enter a name for your new configuration file.

5. Click OK.

6. Click the (e.g., shown in blue) Close Form hyperlink.

Running the Excel Definition Program

SalaryXL uses an XML file to integrate new salary increase definitions into the workbooks it creates for you and your managers. As part of the process of configuring SalaryXL for the first time, JGI worked with you to modify this XML file for your unique needs. On occasion, you may need to modify it yourself. JGI provides an optional graphical Excel Definition Program for this purpose.

To run the Excel Definition Program, choose Run Excel Definition from the File menu.

When you're finished, click the (e.g., shown in blue) Close Form hyperlink.

Updating from HRMS System

In the Loading Data section, you were shown how to import files generated from your HRMS system. SalaryXL enables you to update employees and salary reviews directly from your HRMS systems.

Update Employees from HRMS System

To update employees directly from your HRMS system, choose Update Employees from HRMS System from the Employees menu. The Reload Employees from HRMS System dialog box appears (see FIG. 102).

Update Salary Review Data from HRMS System

To update salary reviews directly from your HRMS system, choose Update Salary Reviews from HRMS System from the Salary Reviews menu. The Reload Salary Review Data from HRMS System dialog box appears (see FIG. 103).

Database Housekeeping

Occasionally you may need to perform global housekeeping on the database in order to clean up the database after you have manually moved employees and changed their routing paths.

If you simply want to refresh the list of managers on the Managers Tab, choose Refresh Managers from the Review Cycles menu.

To access additional Database Housekeeping tasks, choose Database Housekeeping from the Review Cycles menu. The Database Housekeeping dialog box will appear (see FIG. 104).

You can choose any of these database housekeeping tasks by checking them on.

Click the (e.g., shown in blue) Continue hyperlink to perform the selected database housekeeping tasks.

Click the (e.g., shown in blue) Cancel hyperlink to cancel out of the database housekeeping tasks.

Custom Fields (Advanced)

Custom Fields can be defined separately for Employees or Salary Reviews in each of their sections. You can access the entire list of Custom Fields to see in one place all the fields that have been defined. To enter or modify the values for the Custom Fields, you need to access the Custom Fields for the corresponding section. Adding custom defined fields is for advanced users and you should consult with your SalaryXL Implementation Team before using.

To access Custom Fields choose Edit Custom Fields from the File menu. The Custom Fields dialog box will appear (see FIG. 105).

Field ID: This is the internal SalaryXL identifier for the custom field.

Field Name: This is the descriptive name you have given the custom field.

Table Name: This refers to the SalaryXL table corresponding to where you are adding the custom field:

| Element | Table Name |
|---|---|
| Employee | JGIM_EMPLOYEE |
| Salary Review | JGIM_MERIT |

Data Type: Numeric code representing the data type:

| Data Type Code | Data Type |
|---|---|
| 0 | Character |
| 1 | Decimal |
| 2 | Date |

Data Type T: The data type for the custom field.

Max Length: Applies only to data types of Character. This is the maximum number of characters for the value of the custom field.

To add a new custom field, simply type the information in on the new line were the ‘*’ appears.

To edit an existing custom field, highlight the custom field and click the (e.g., shown in blue) Edit Custom Field hyperlink. You have the ability to specify the field name, table name, the data type t, and max length.

To delete an existing custom field, highlight the custom field and click the (e.g., shown in blue) Delete Custom Field hyperlink.

Exiting the SalaryXL Administration Tool

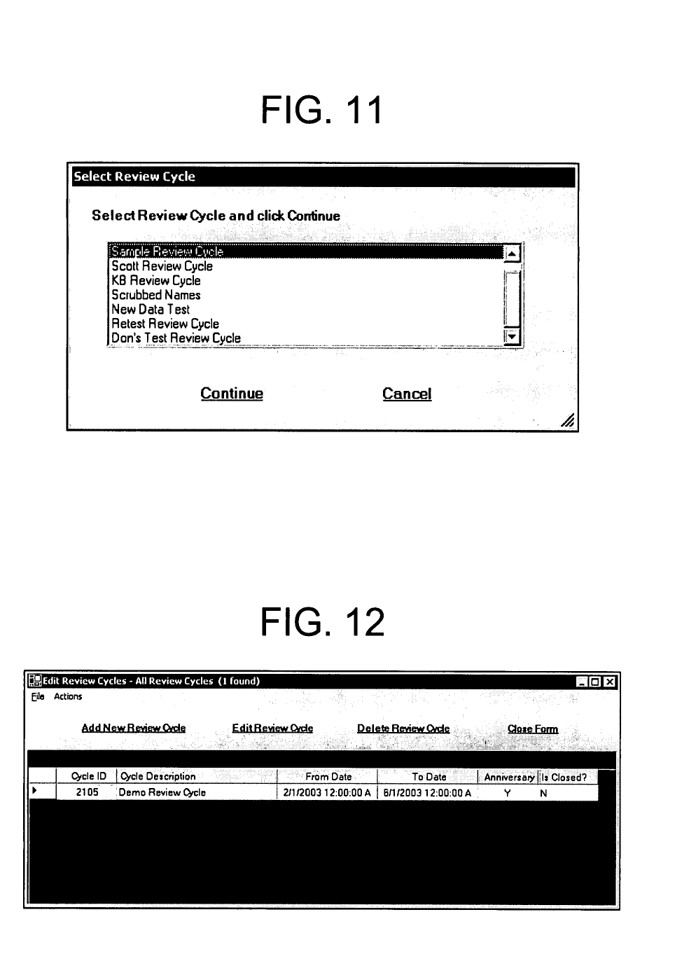

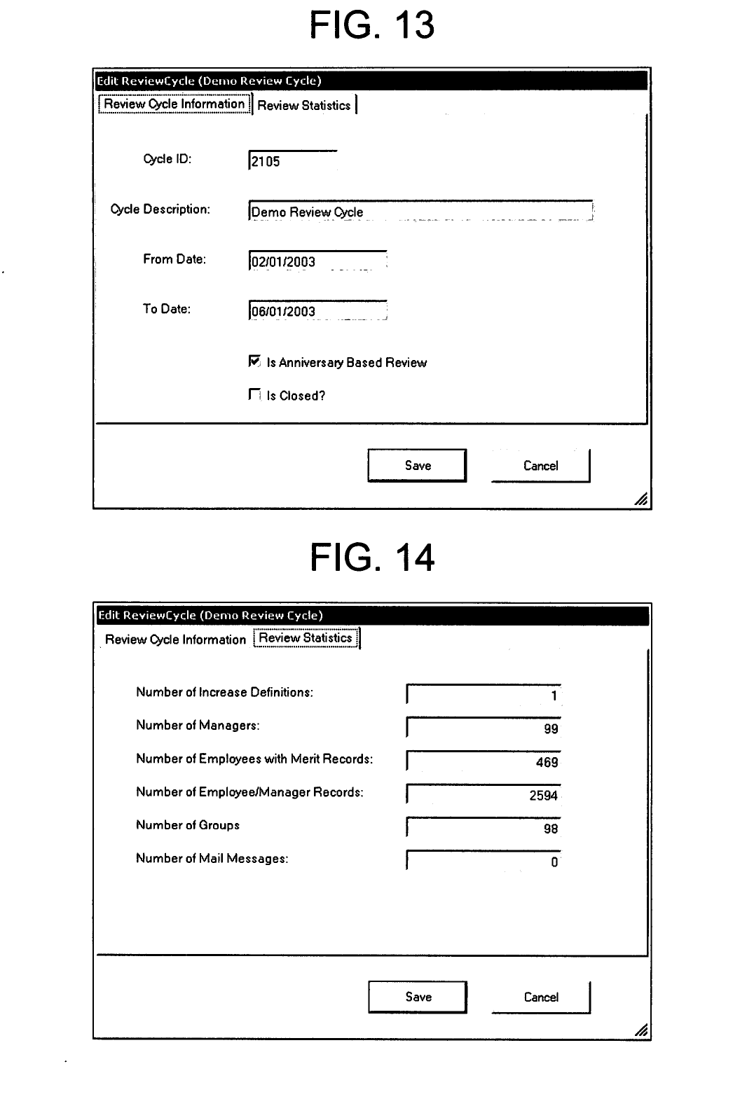

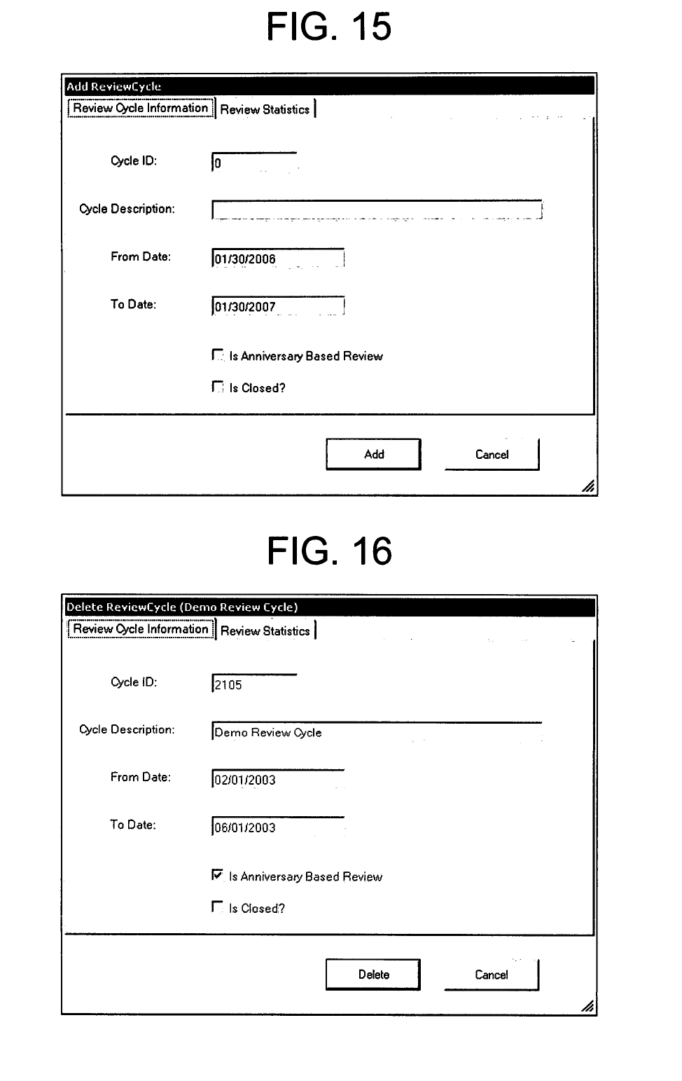

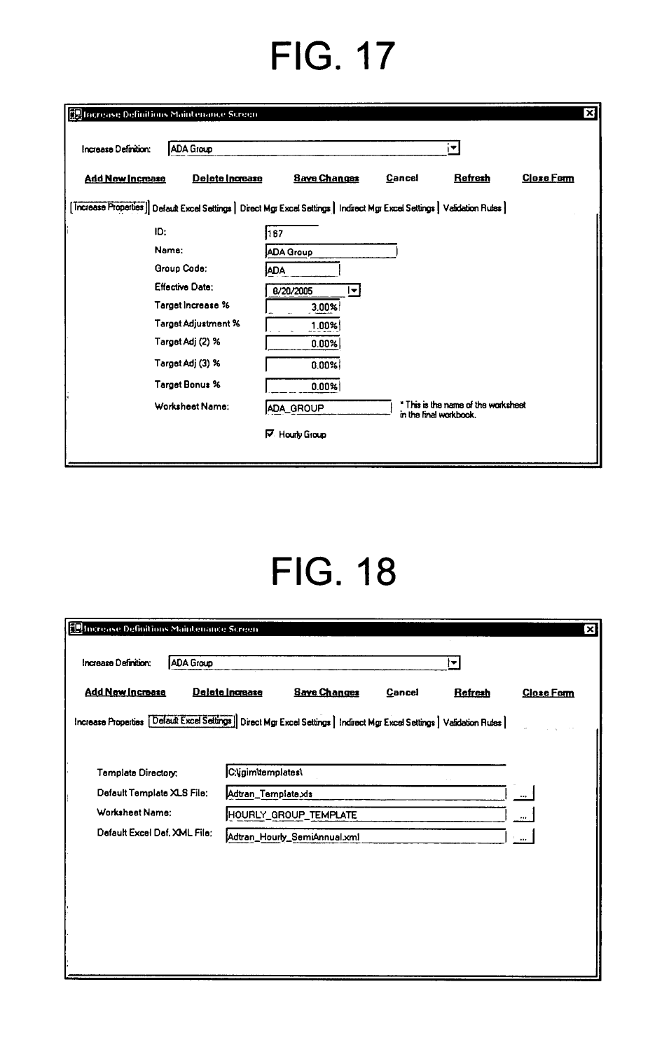

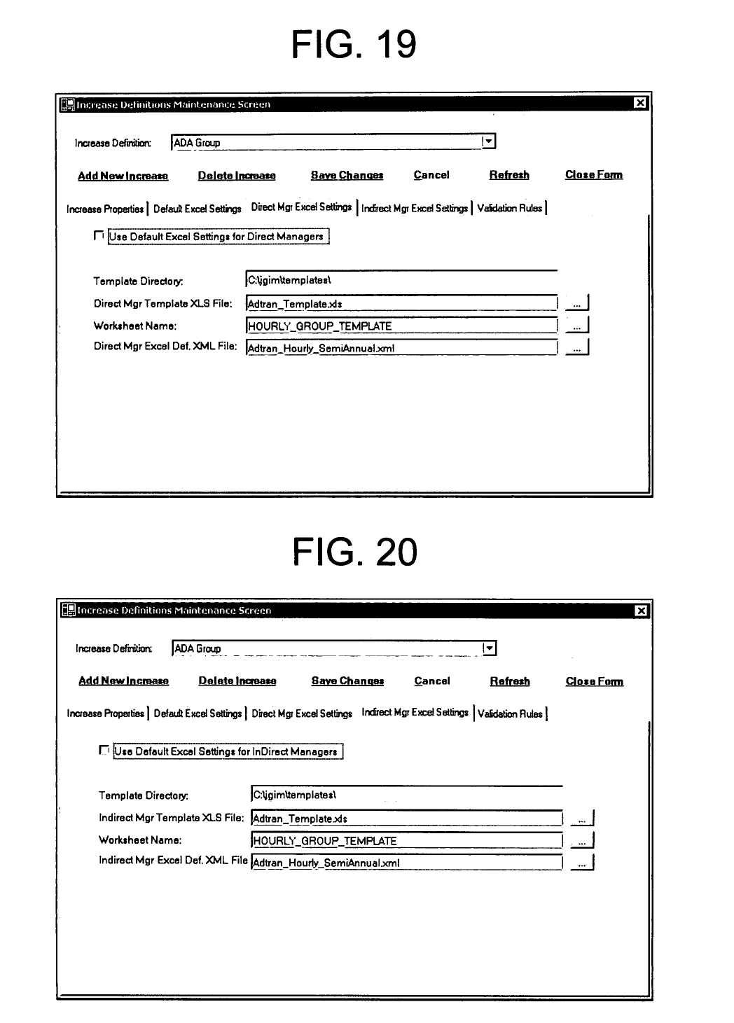

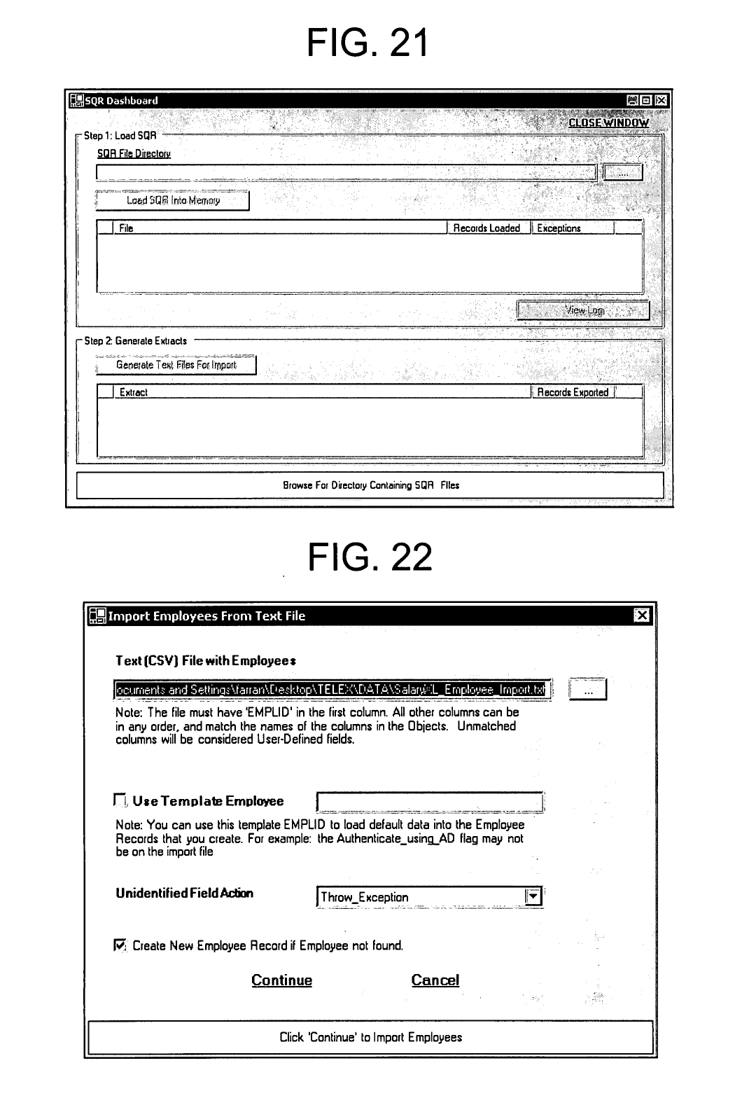

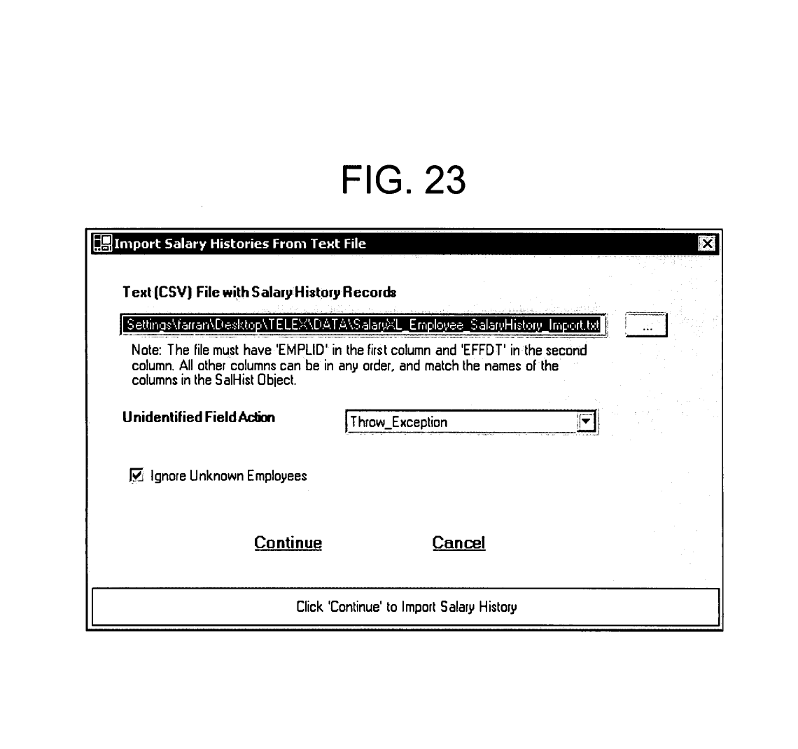

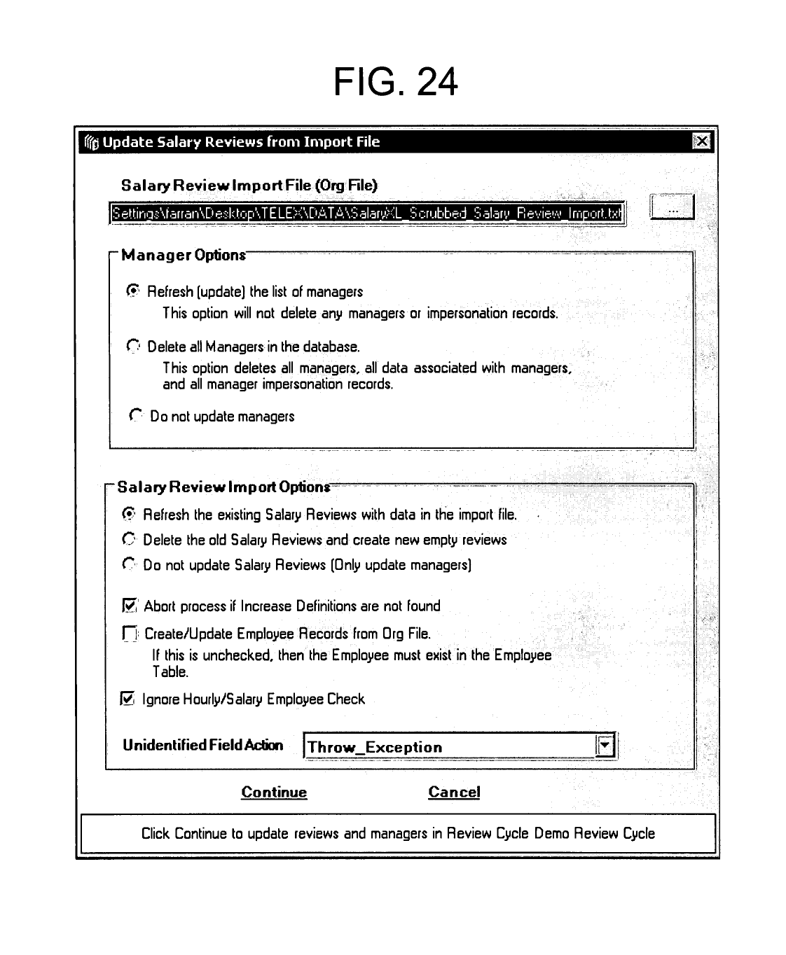

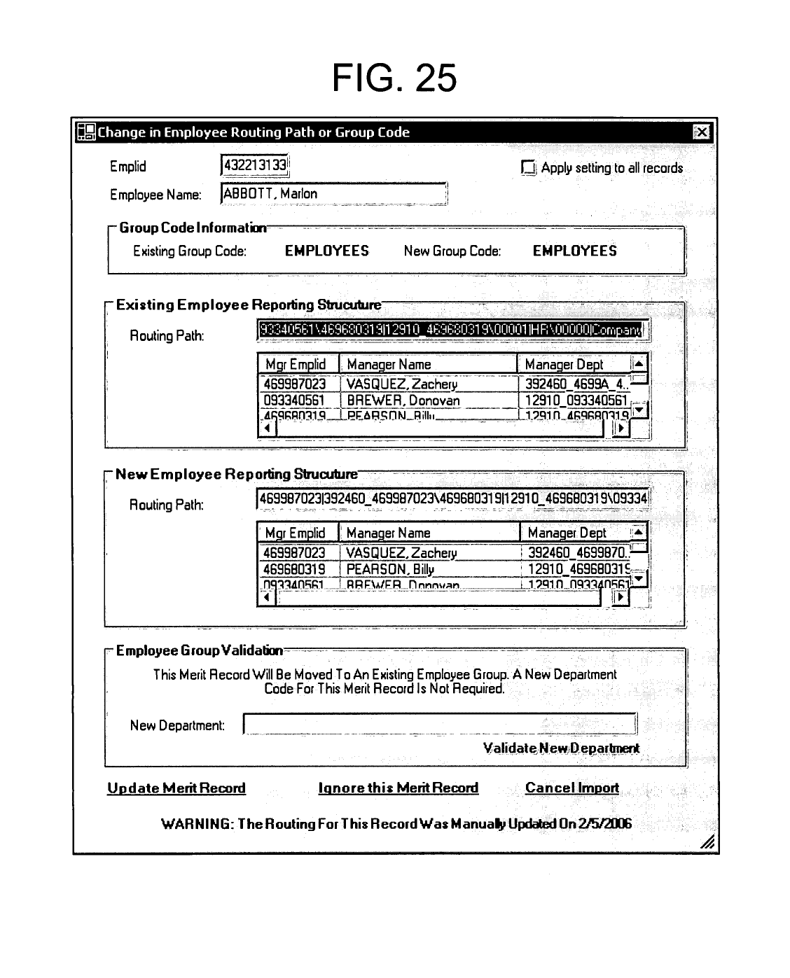

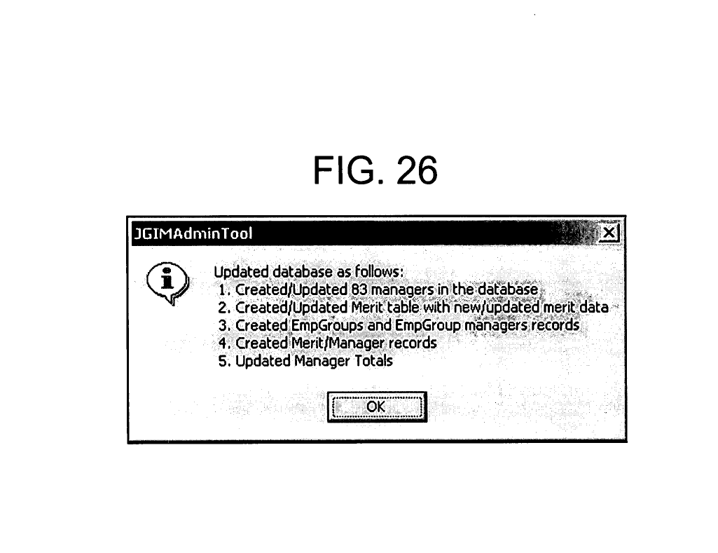

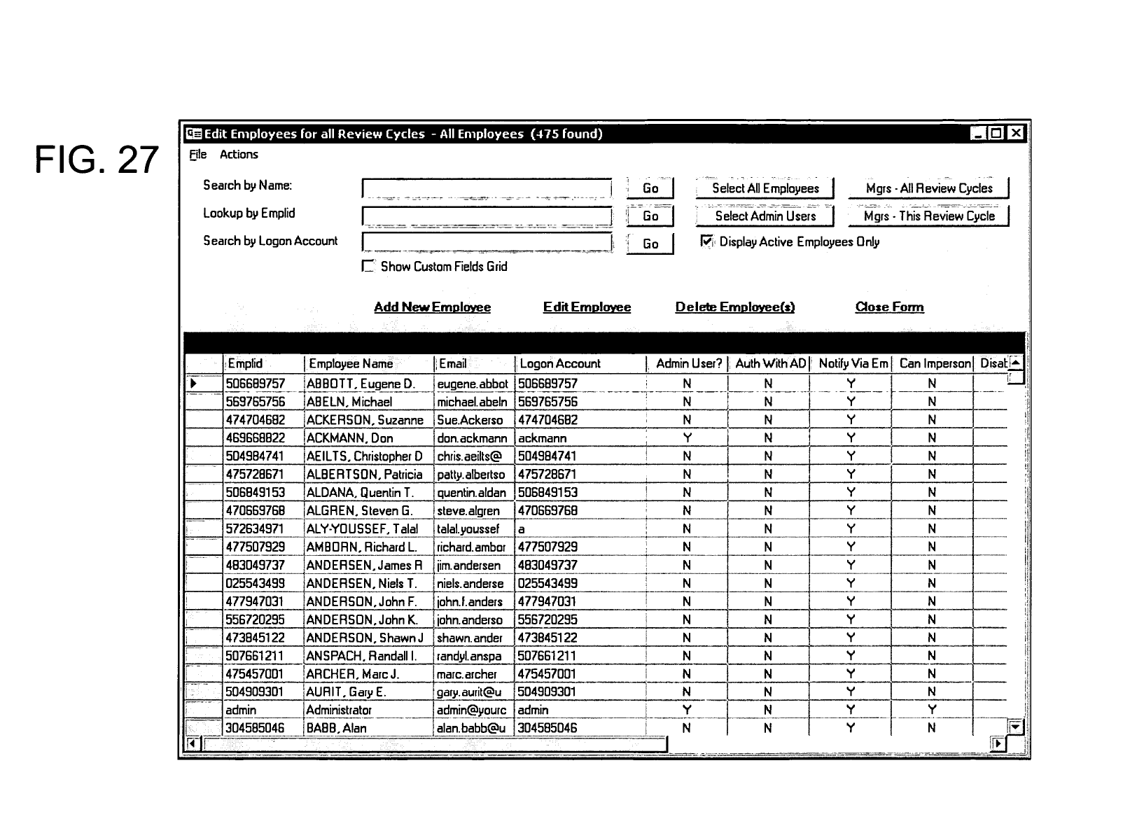

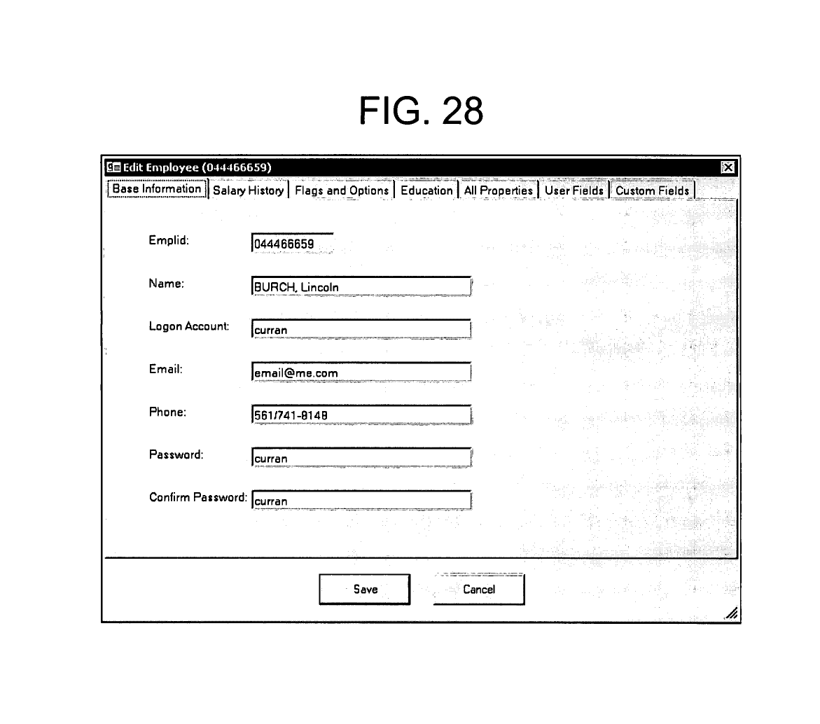

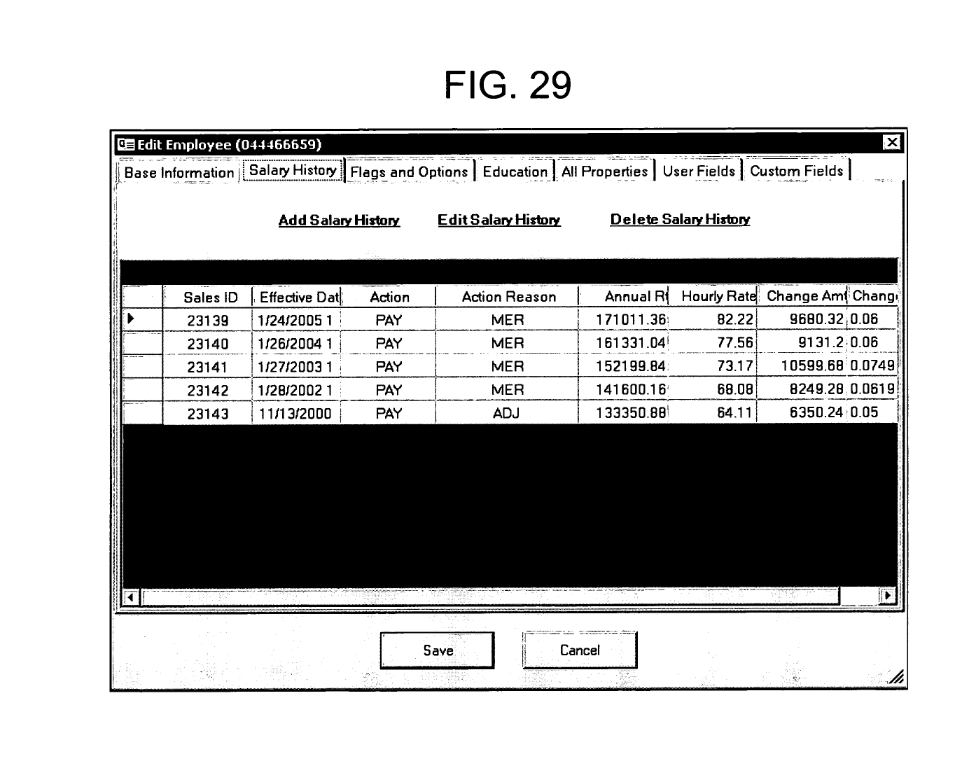

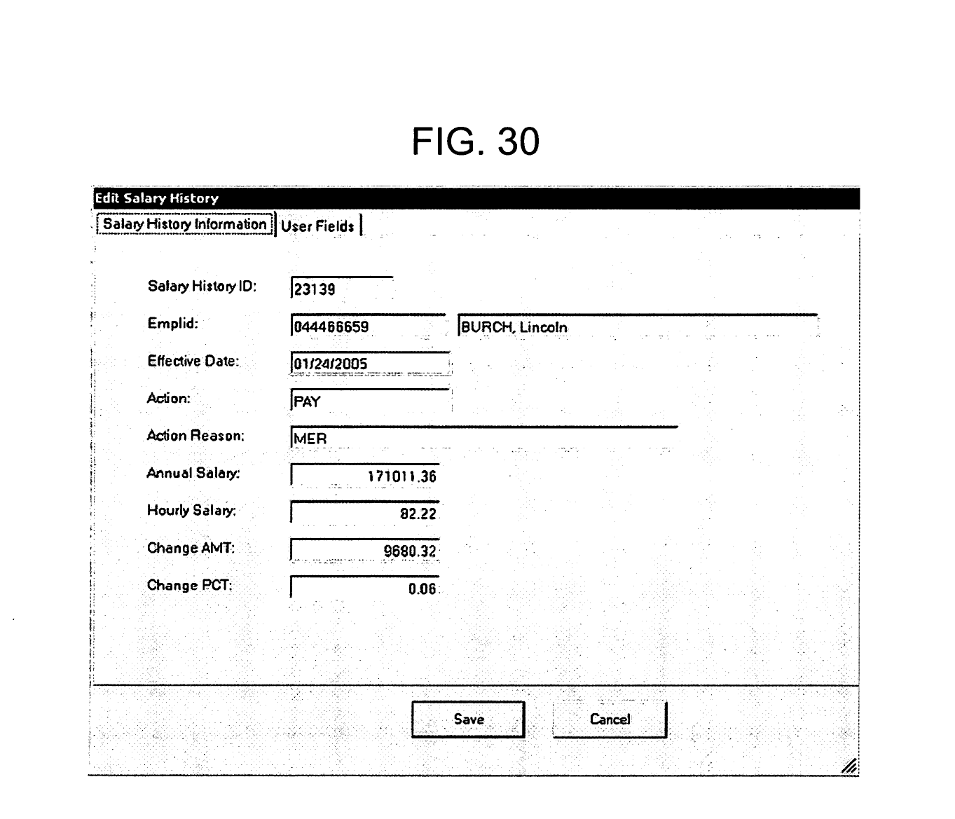

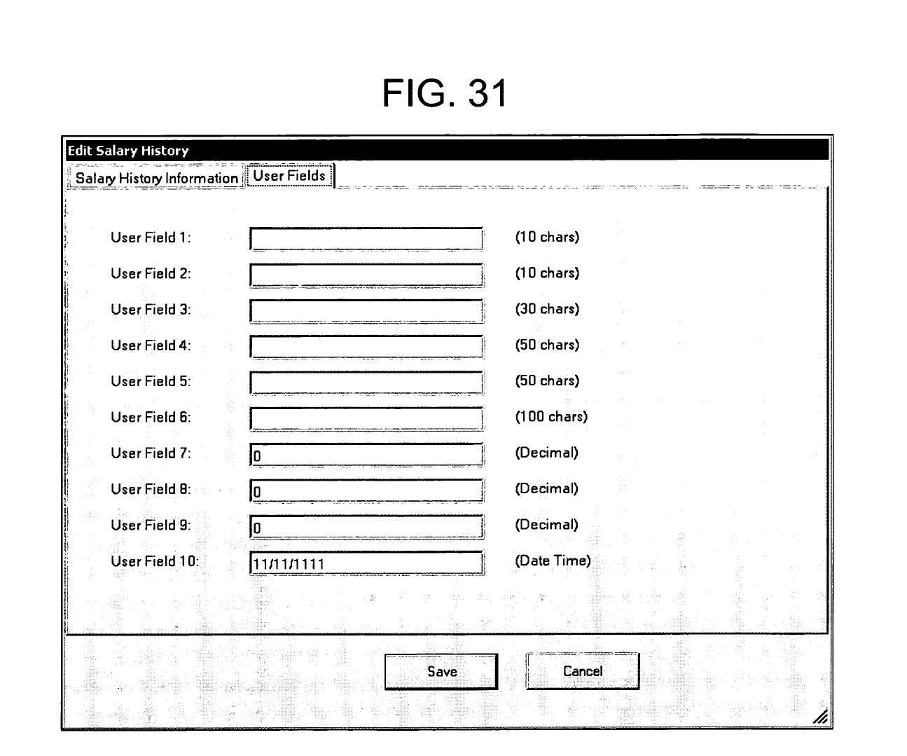

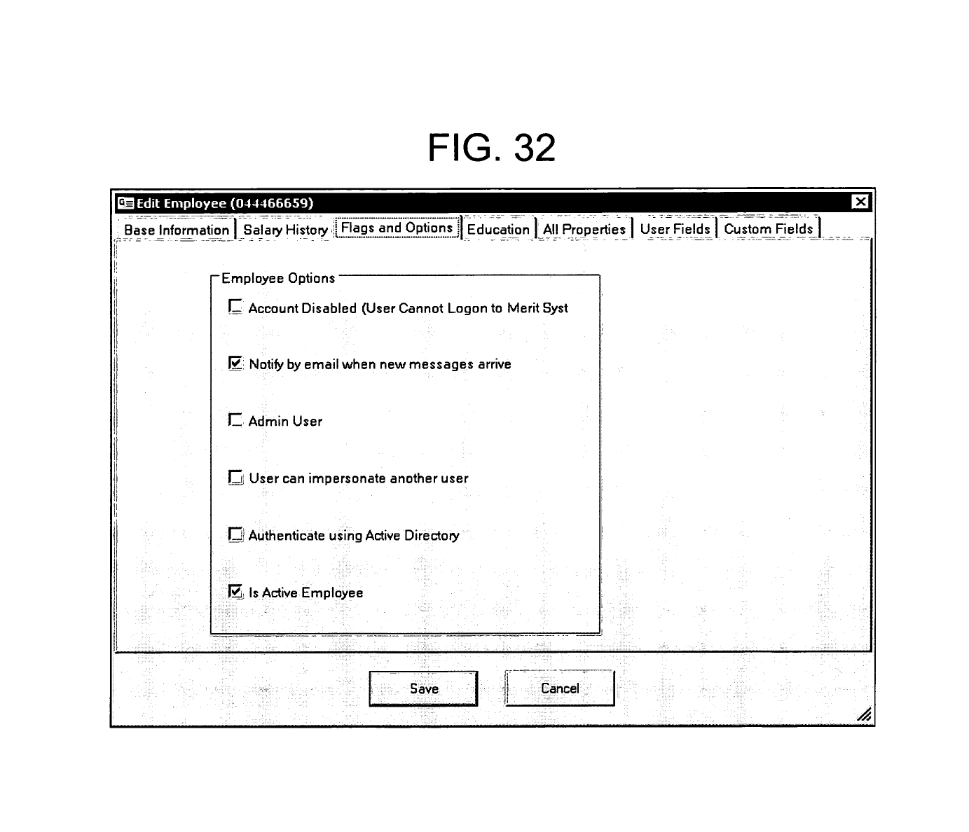

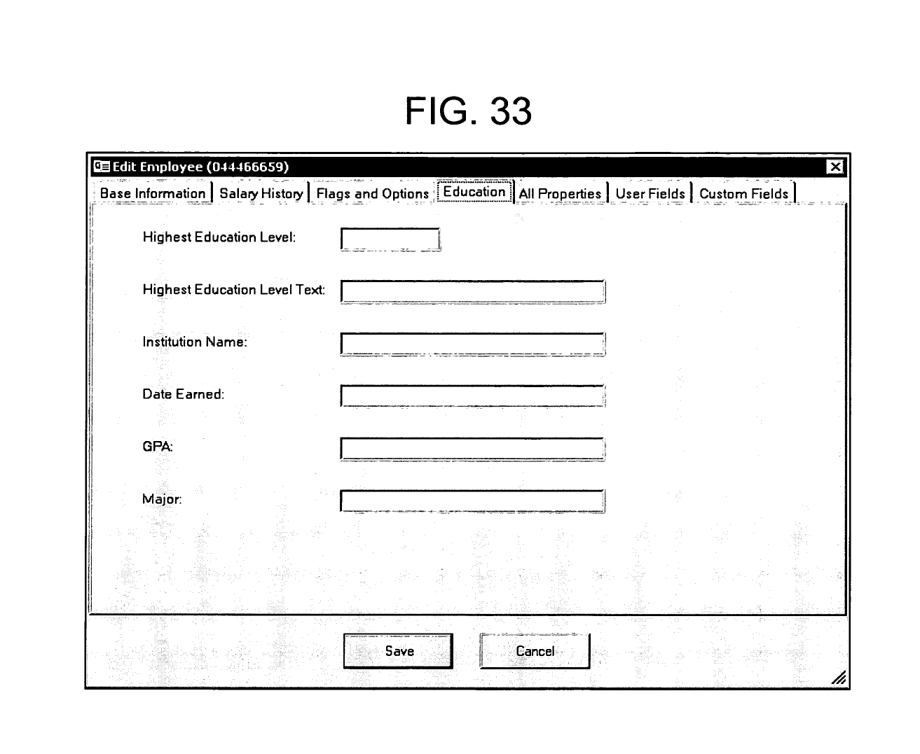

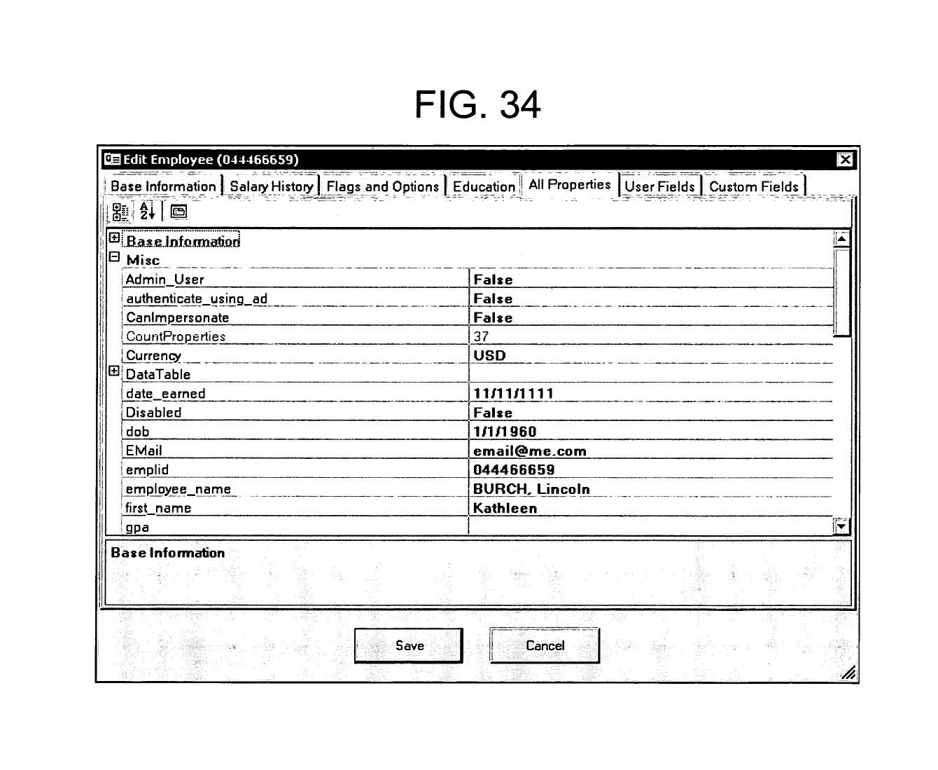

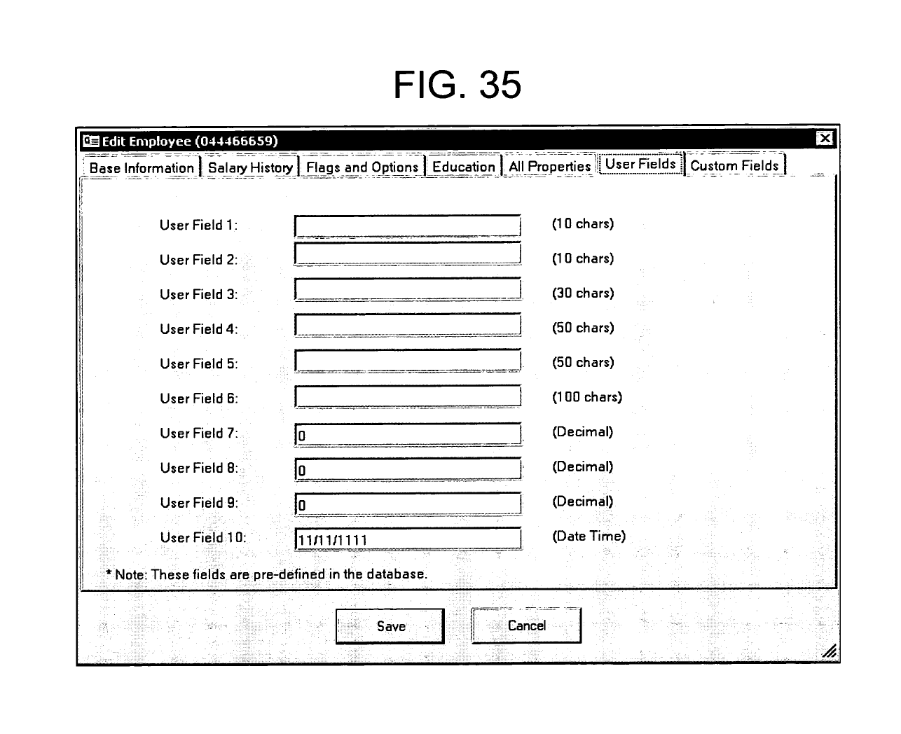

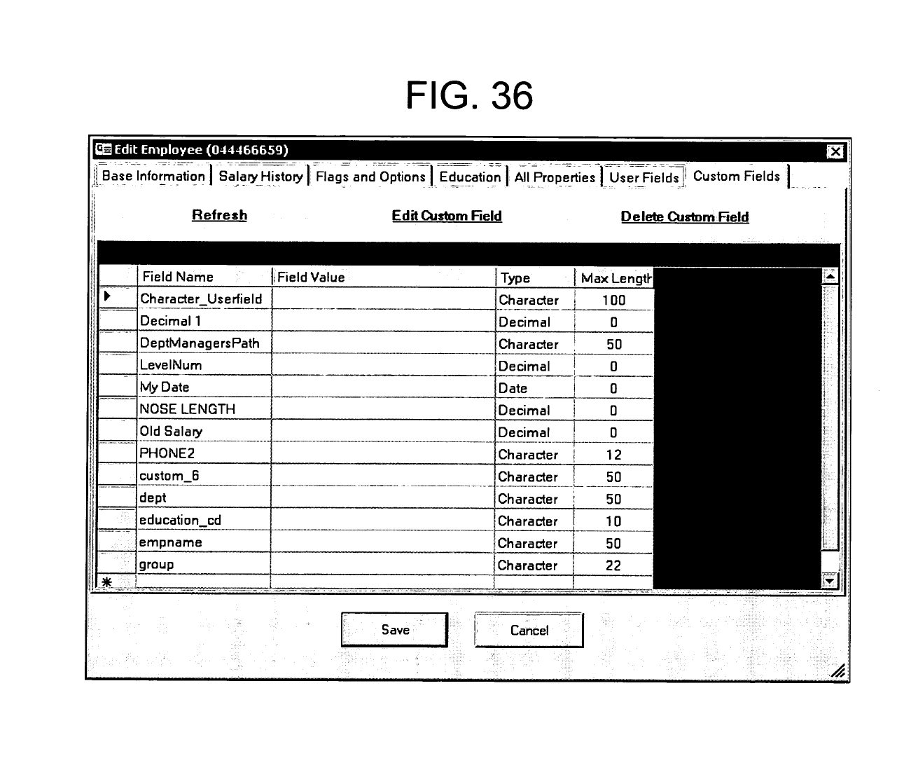

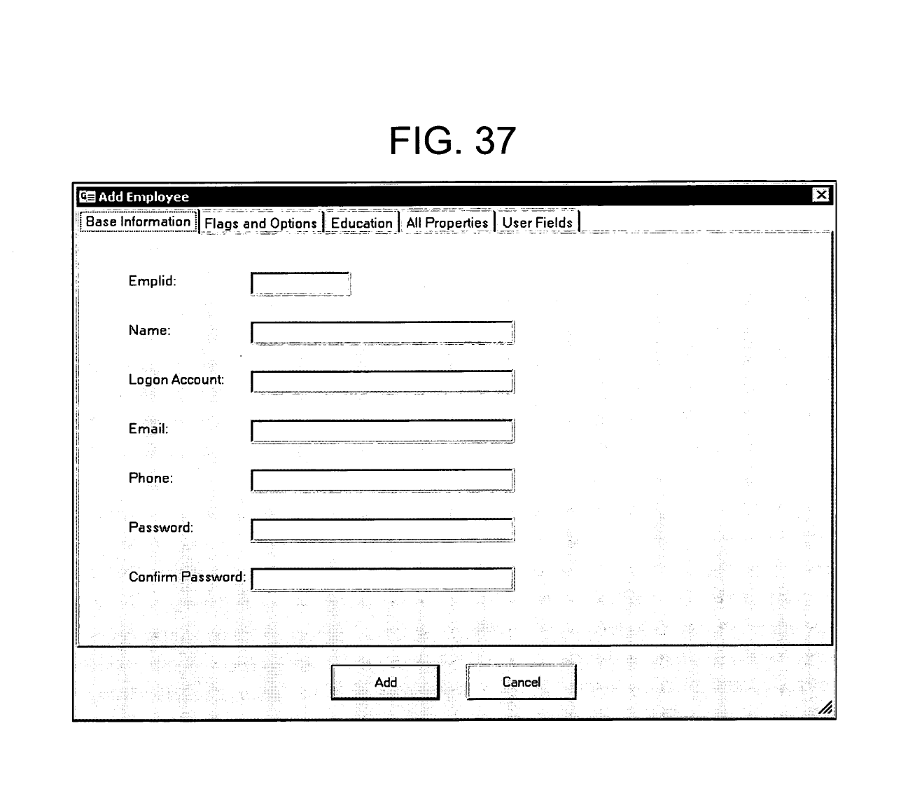

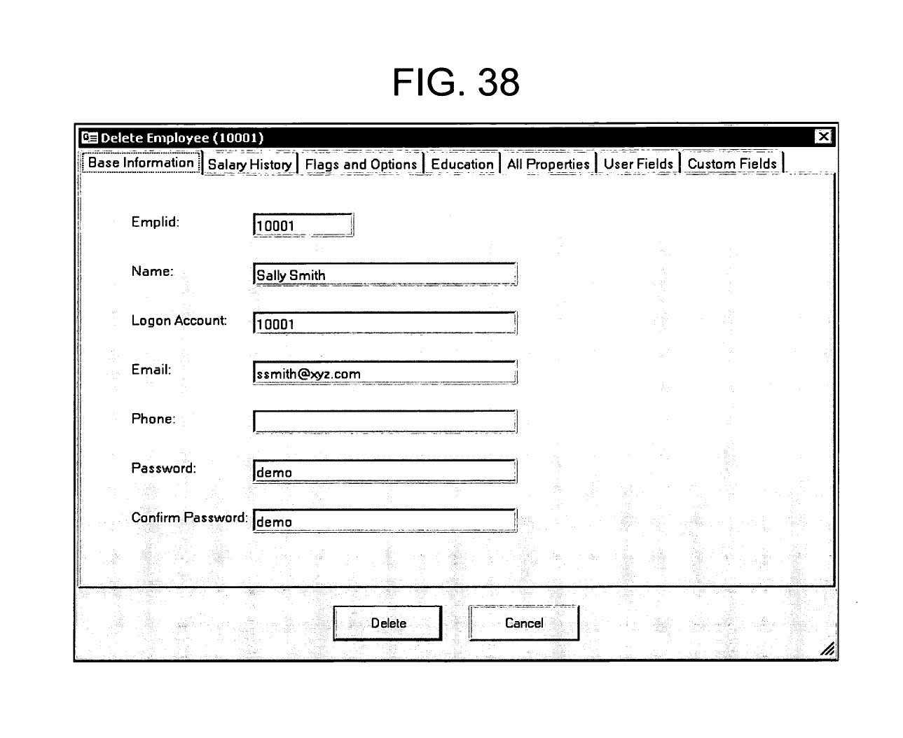

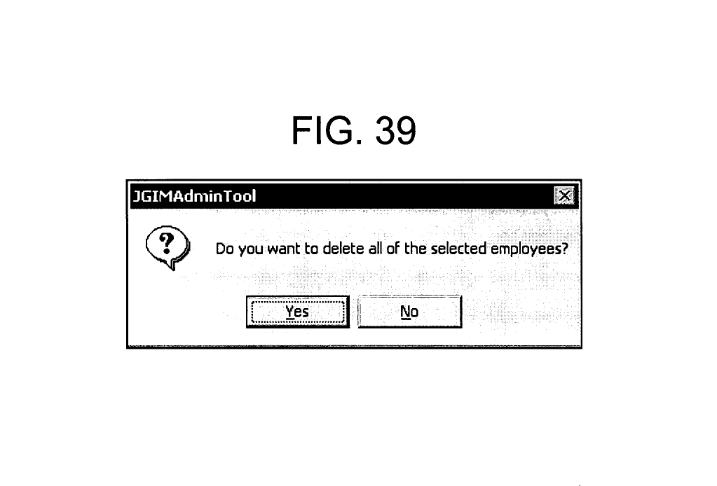

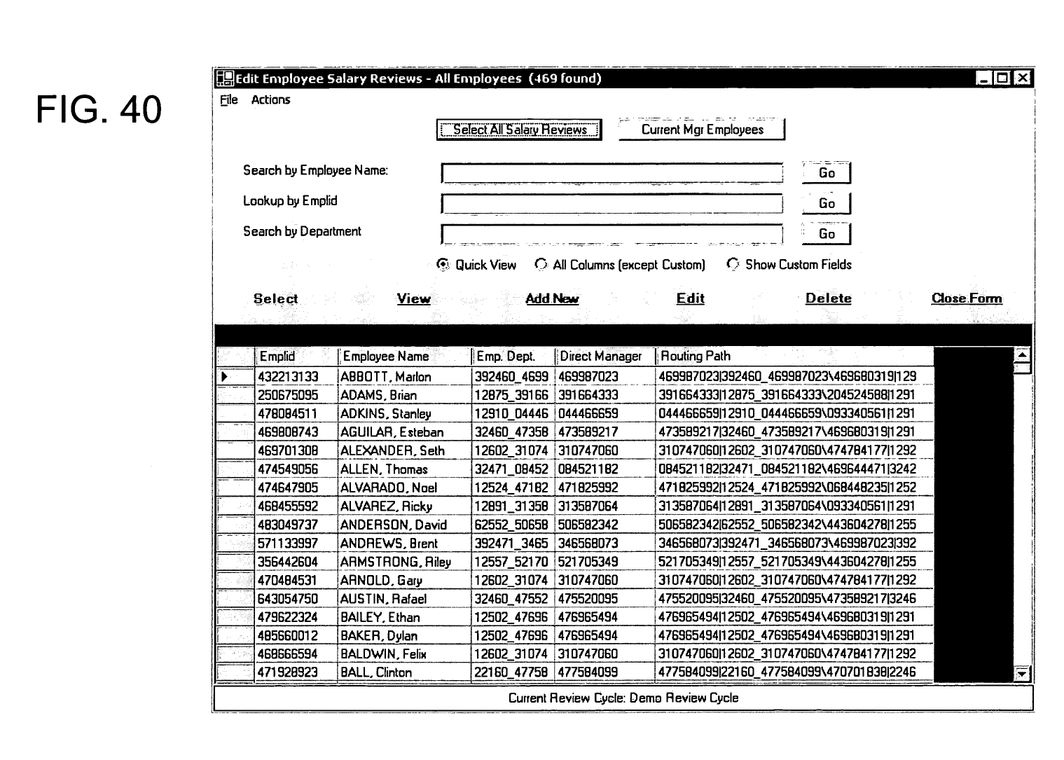

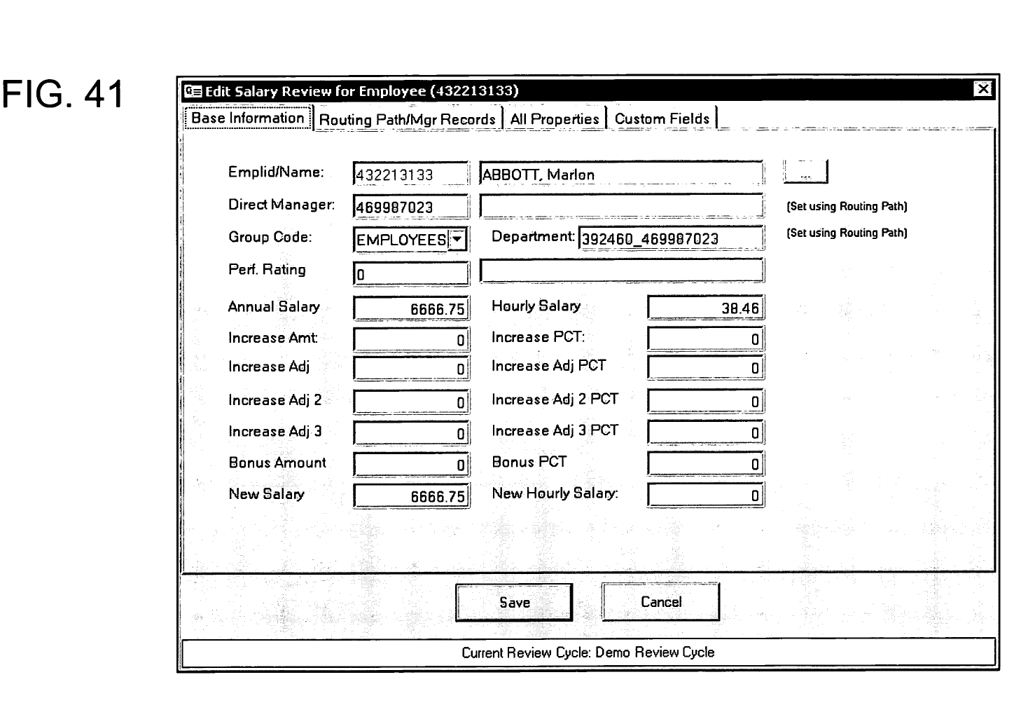

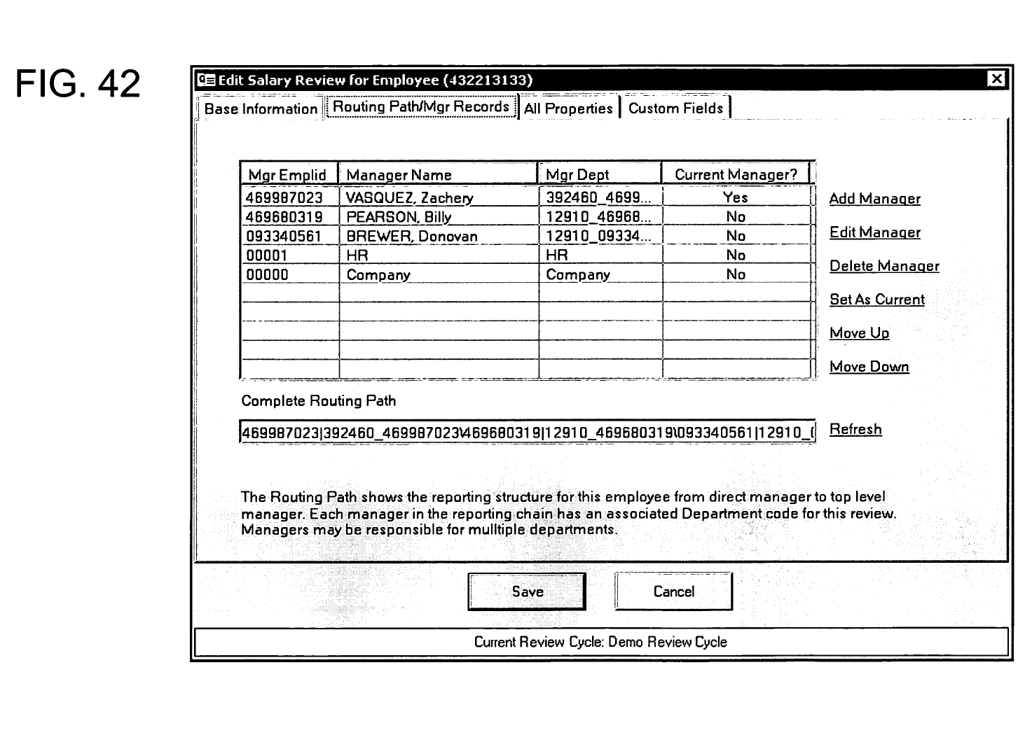

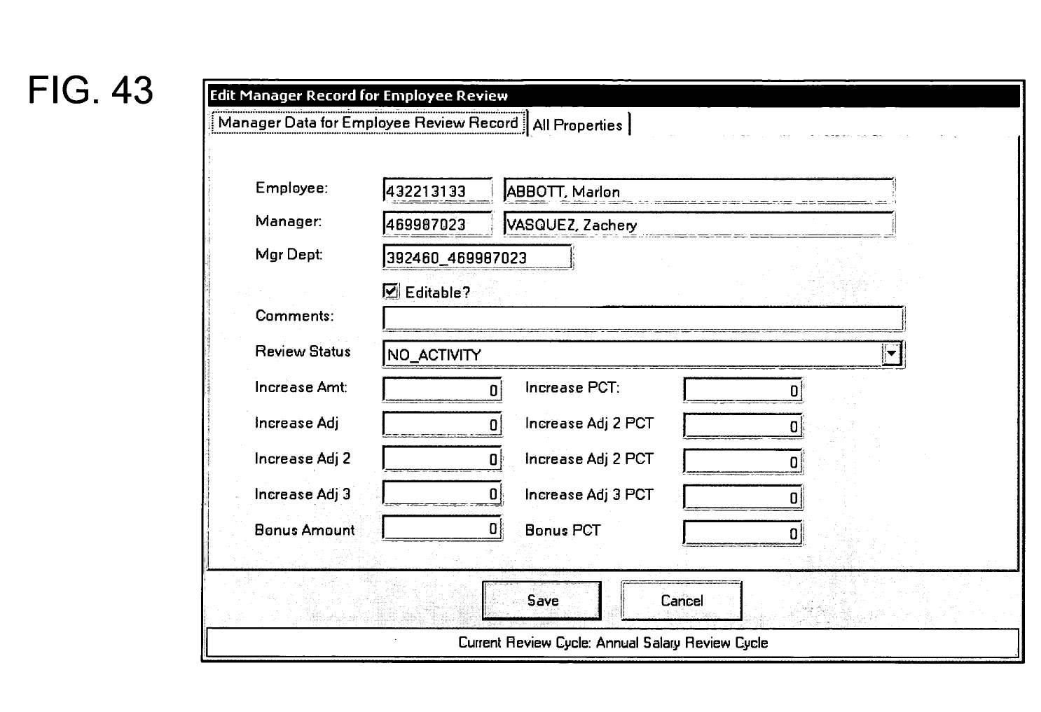

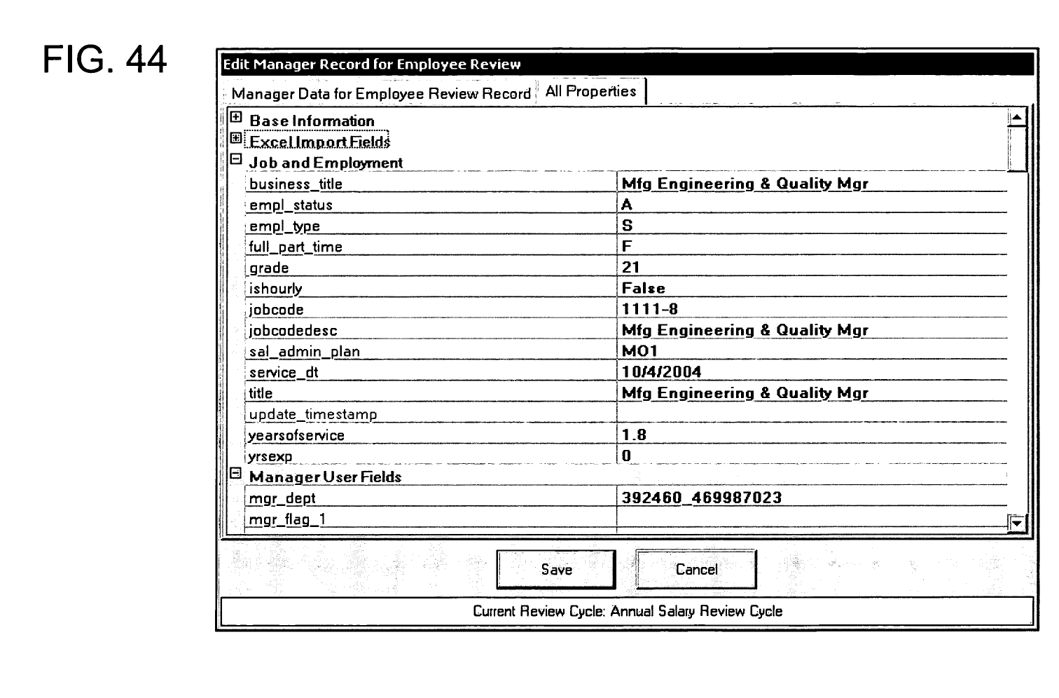

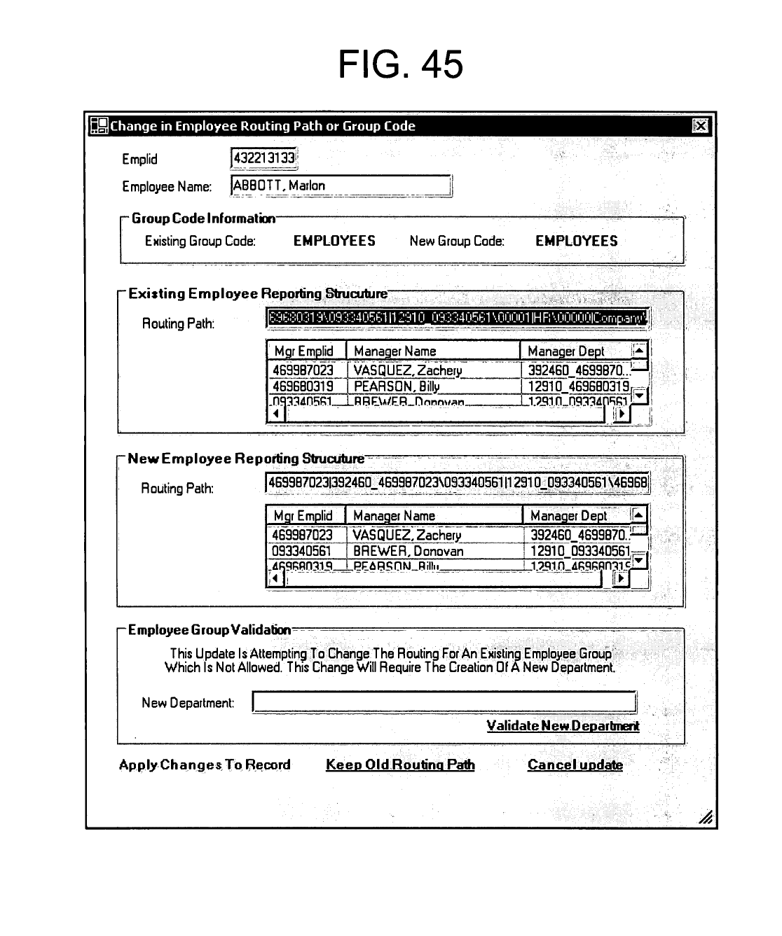

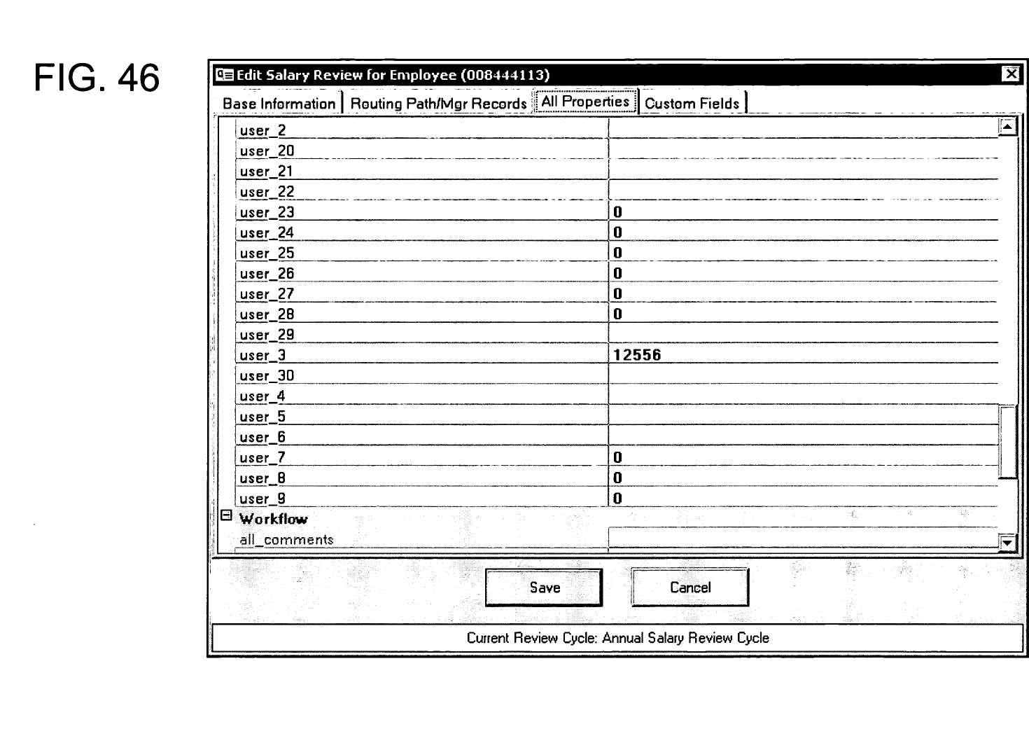

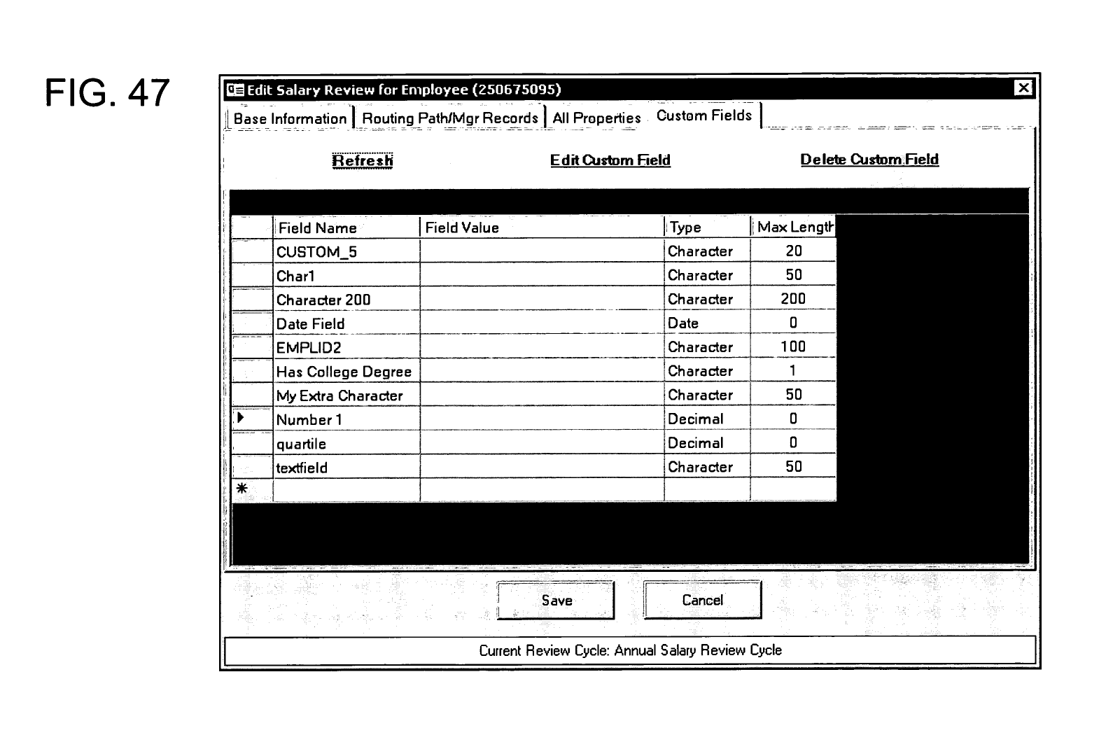

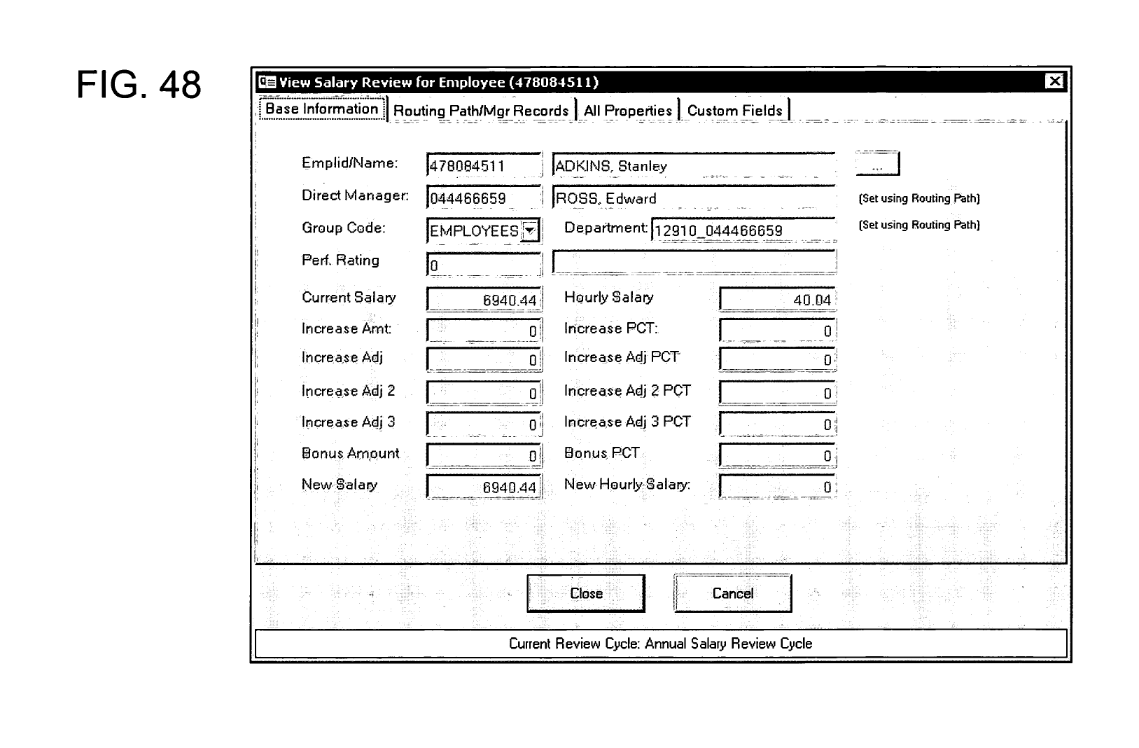

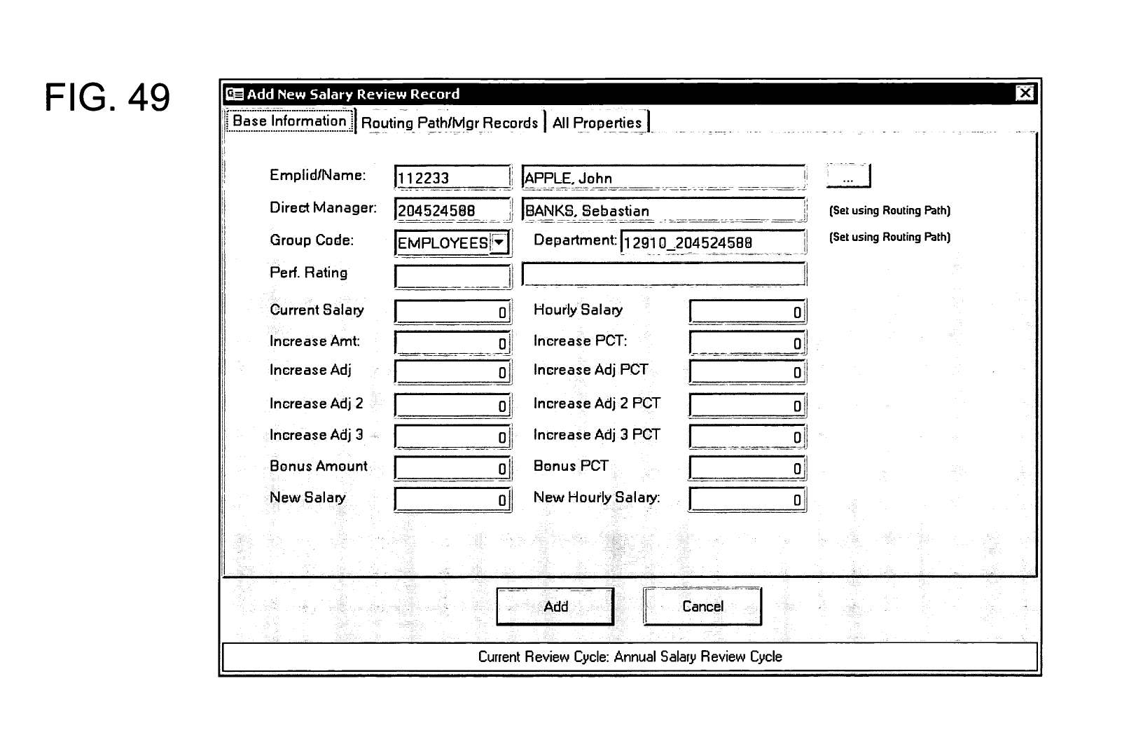

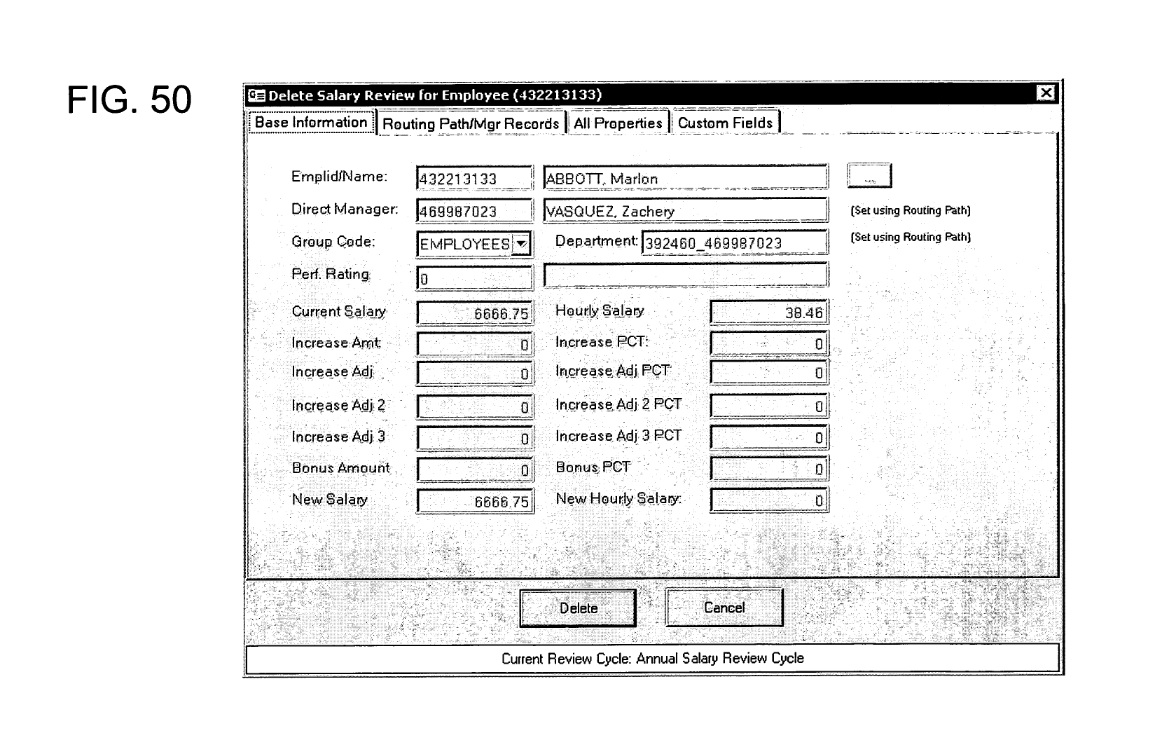

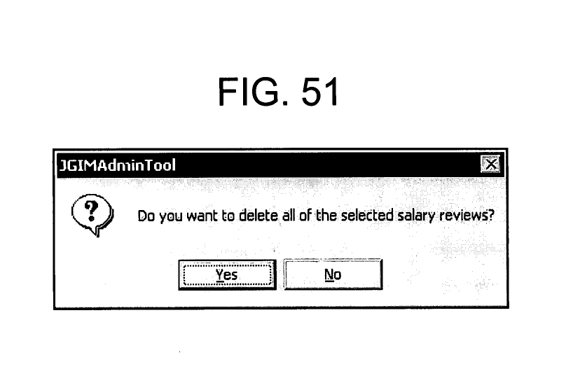

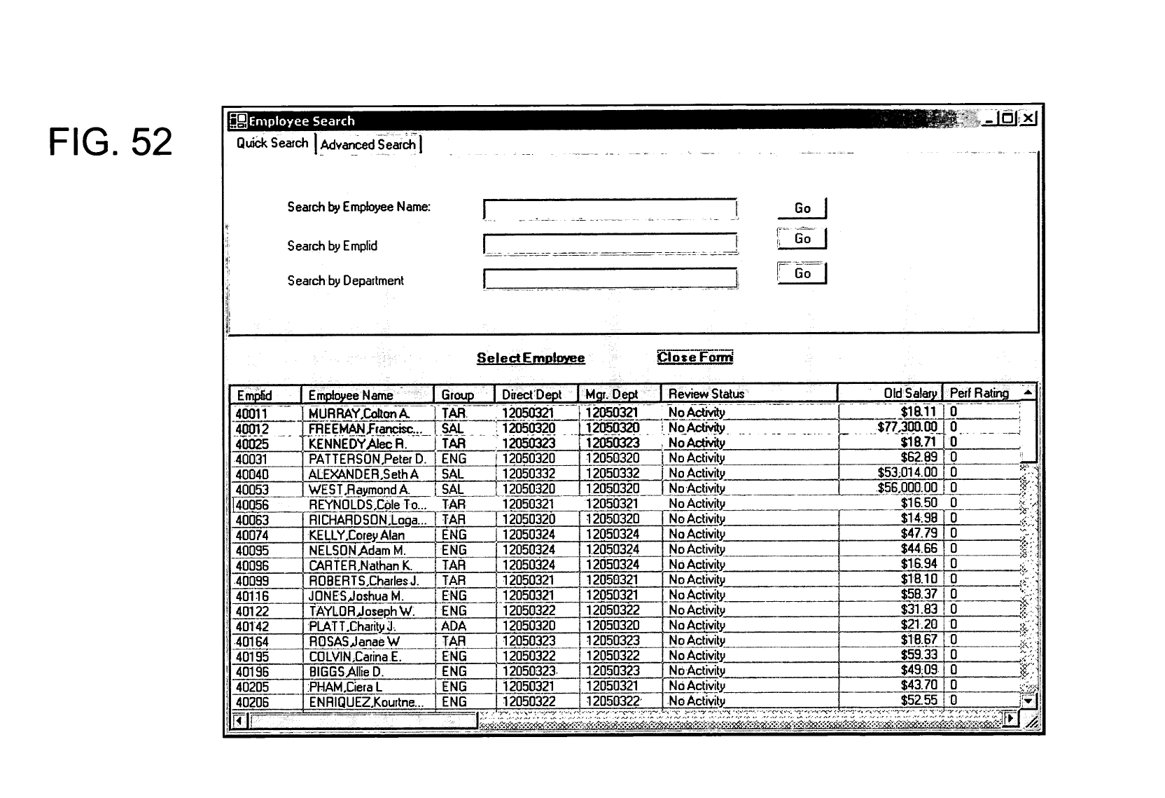

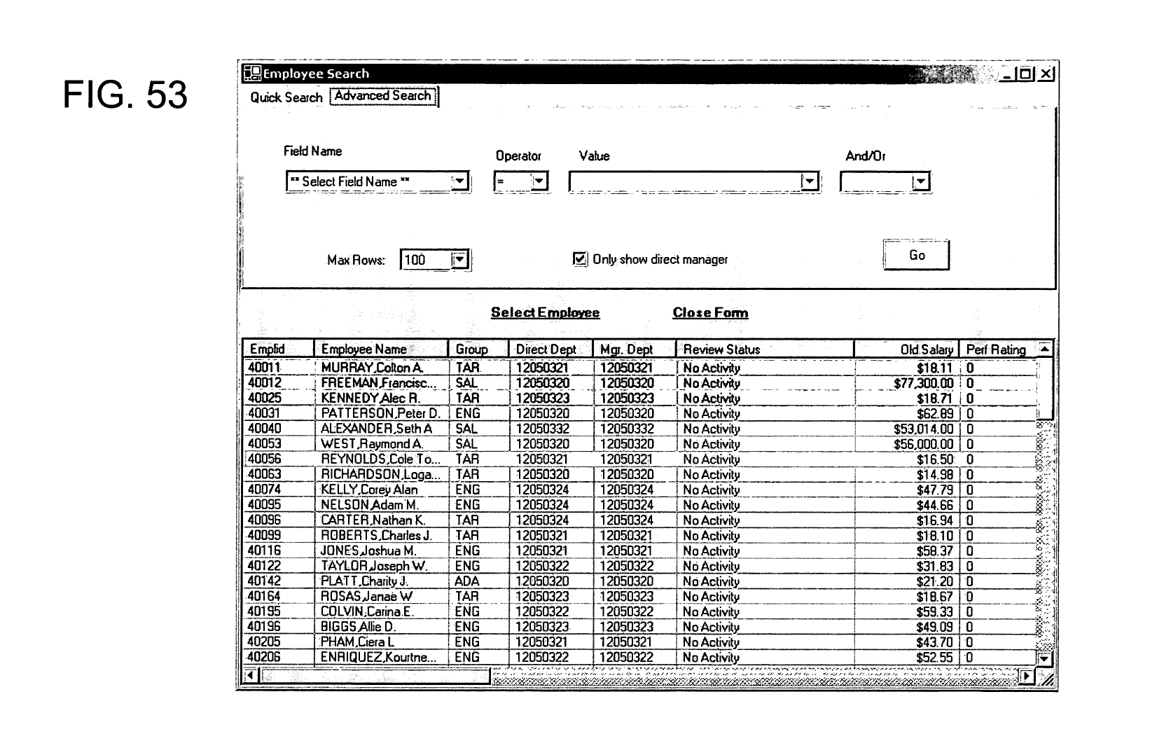

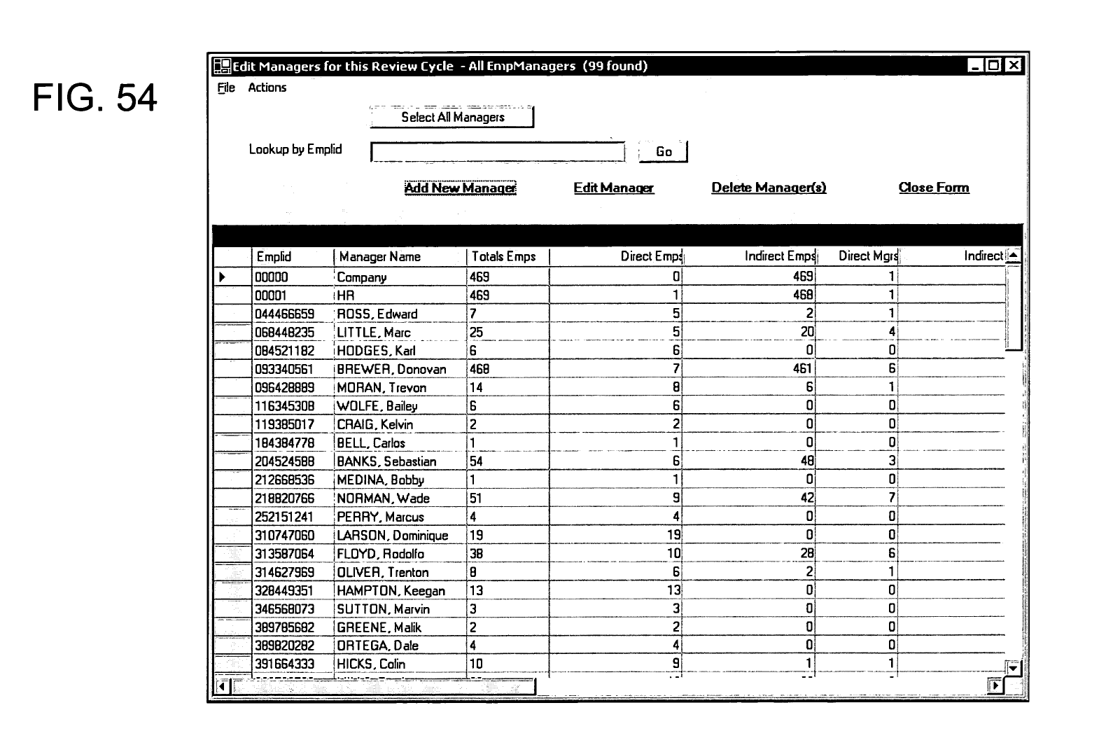

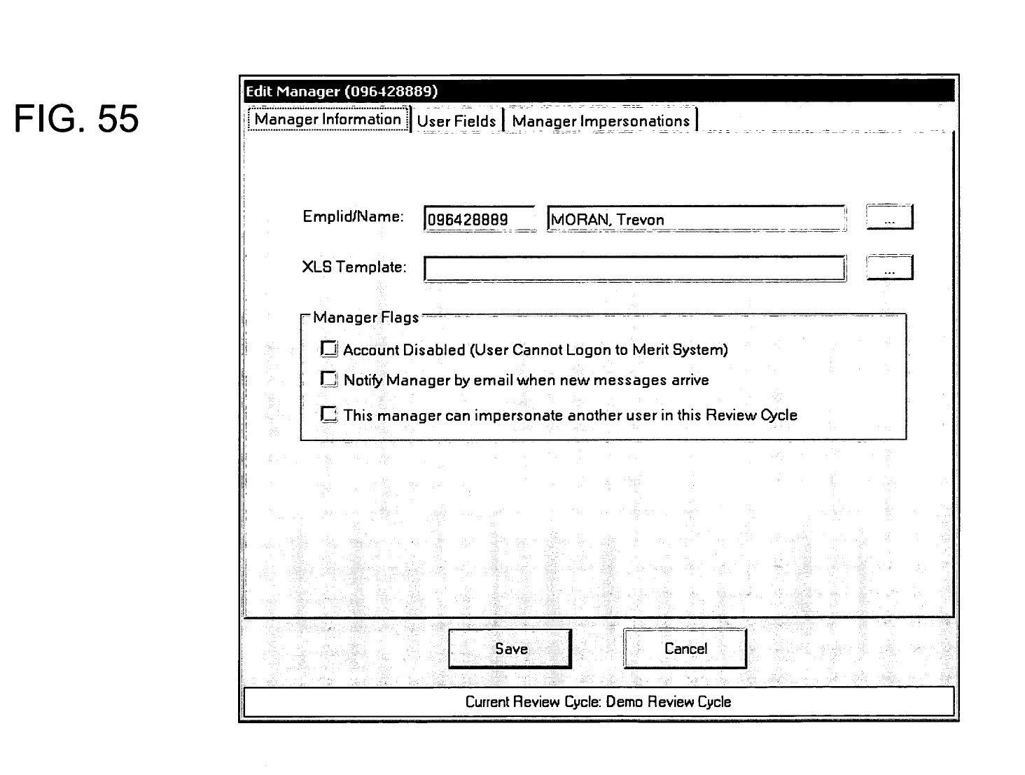

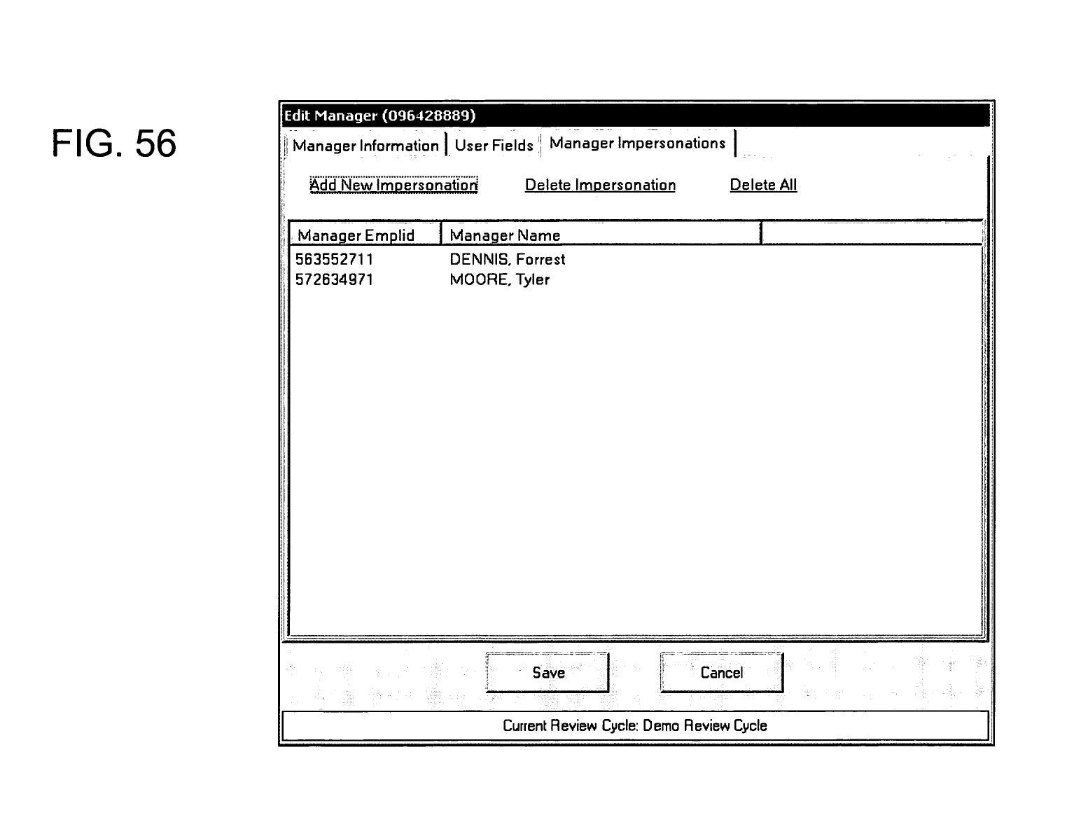

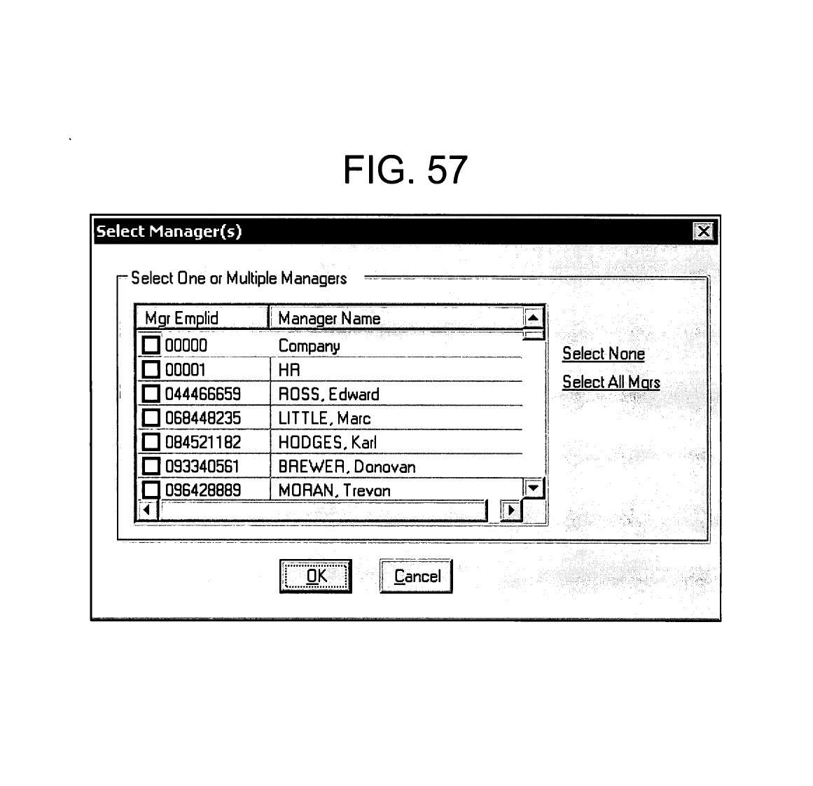

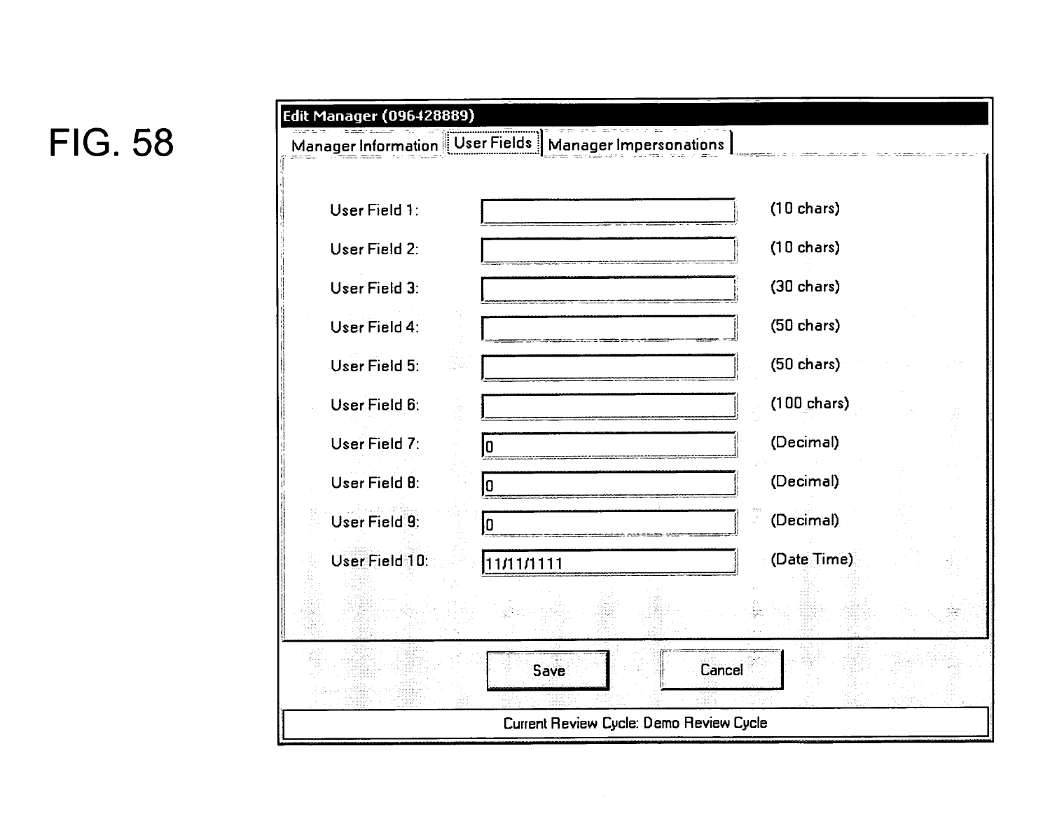

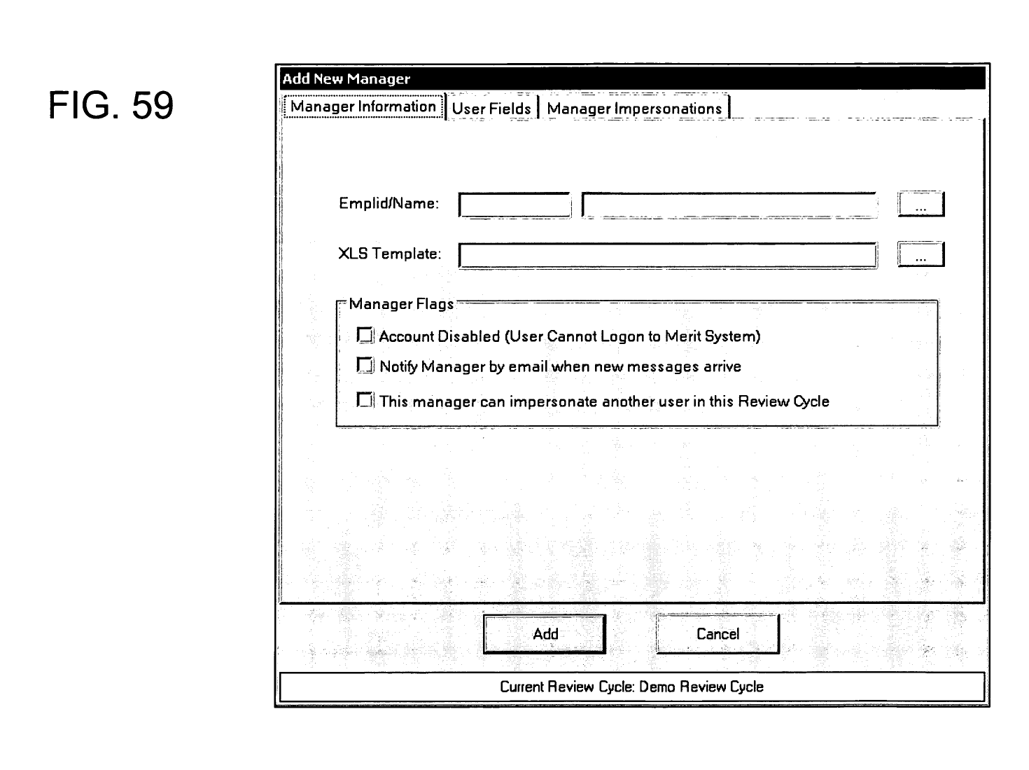

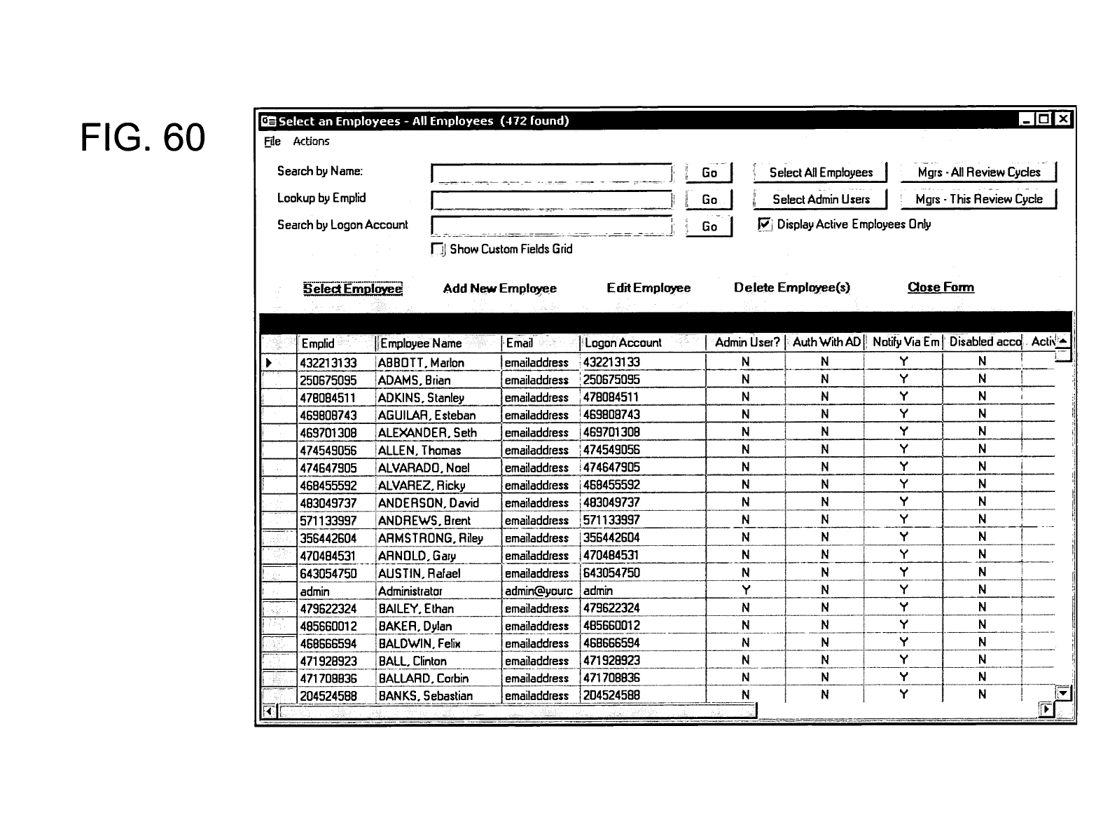

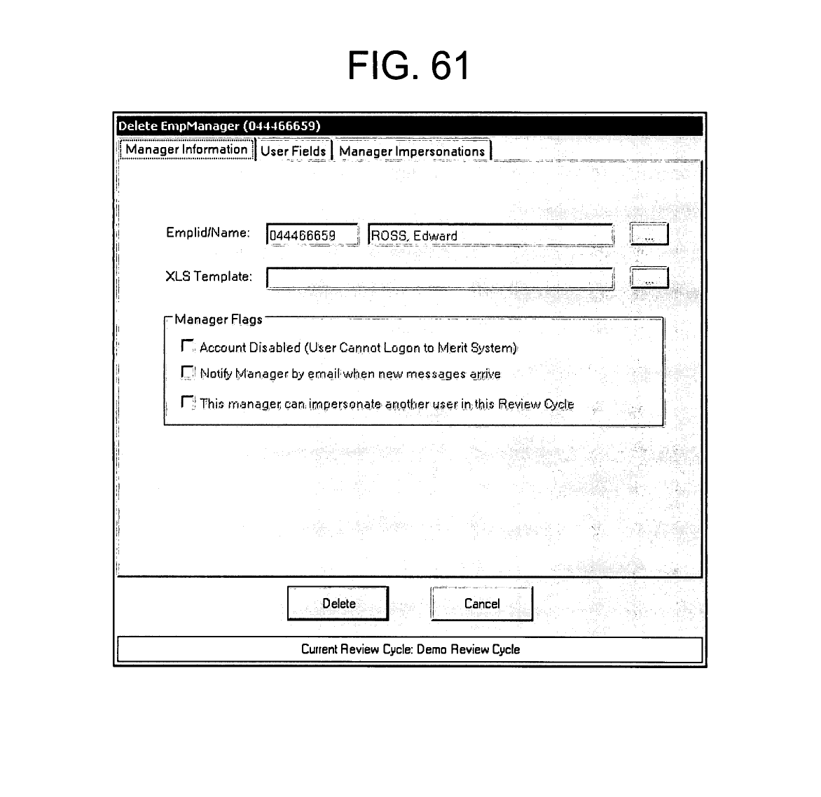

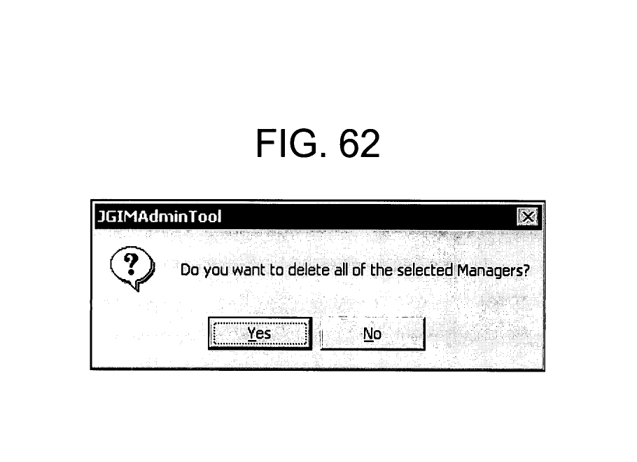

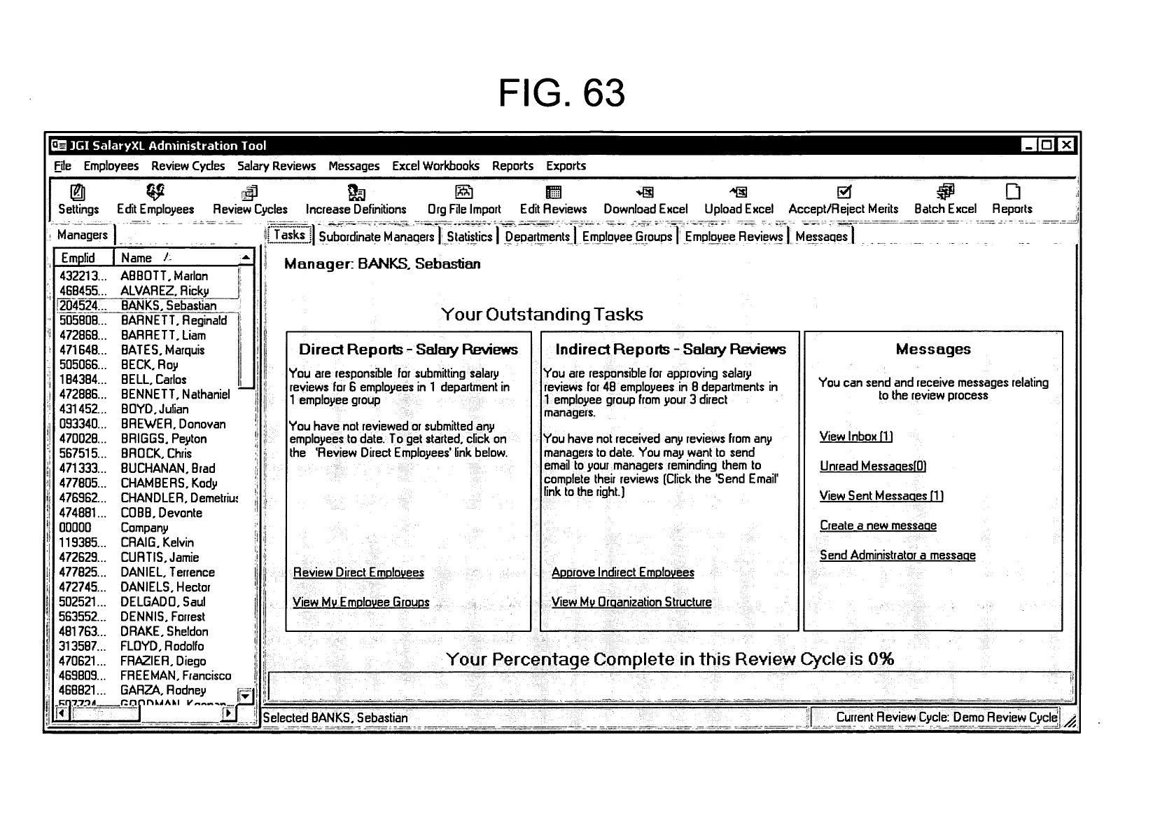

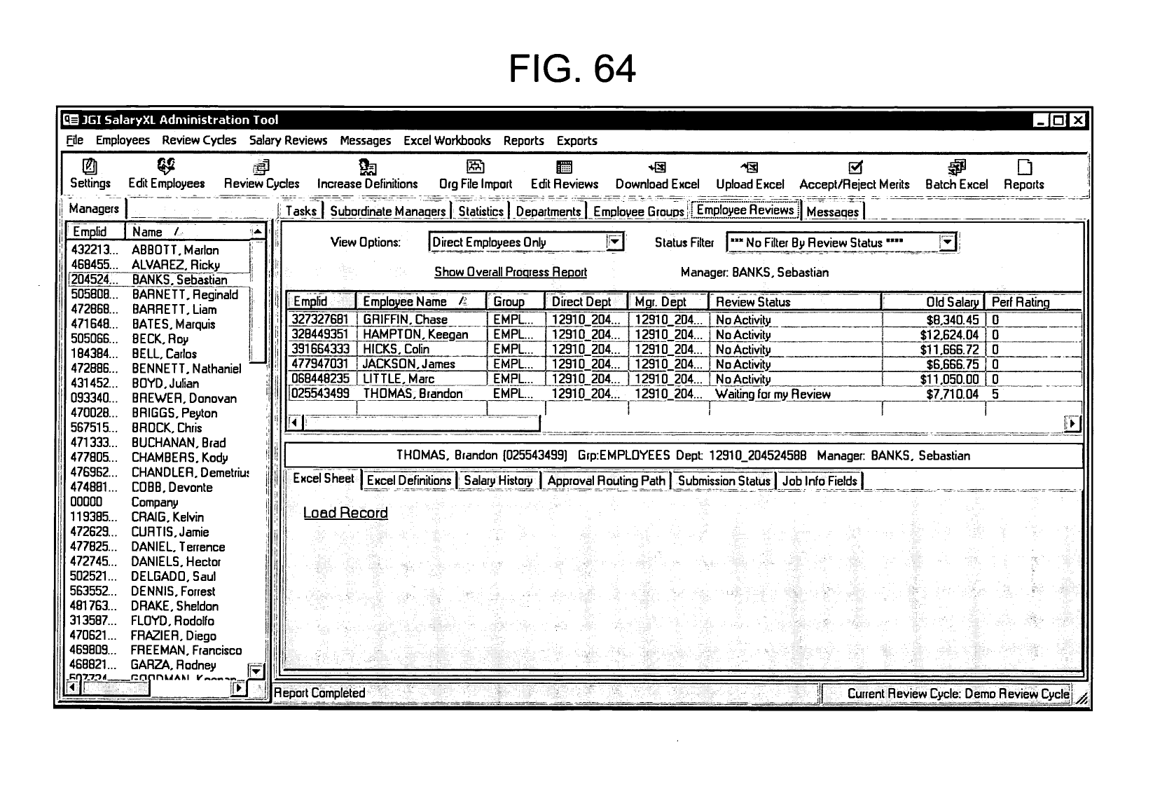

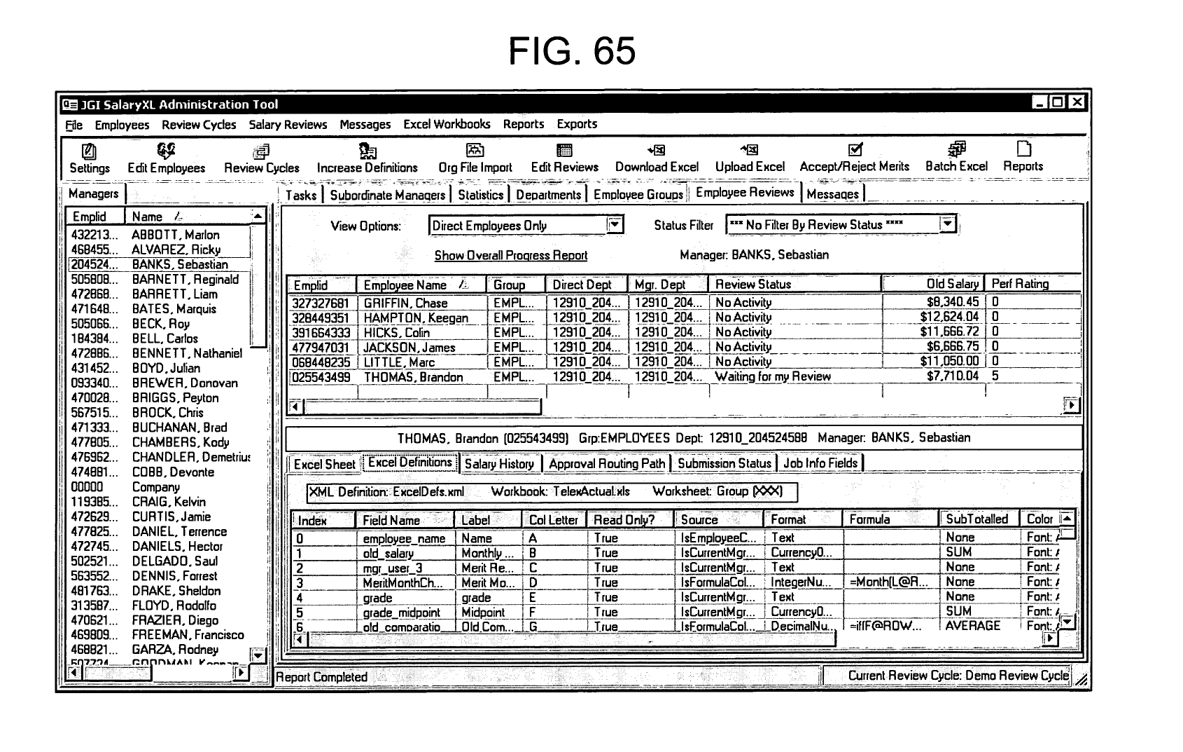

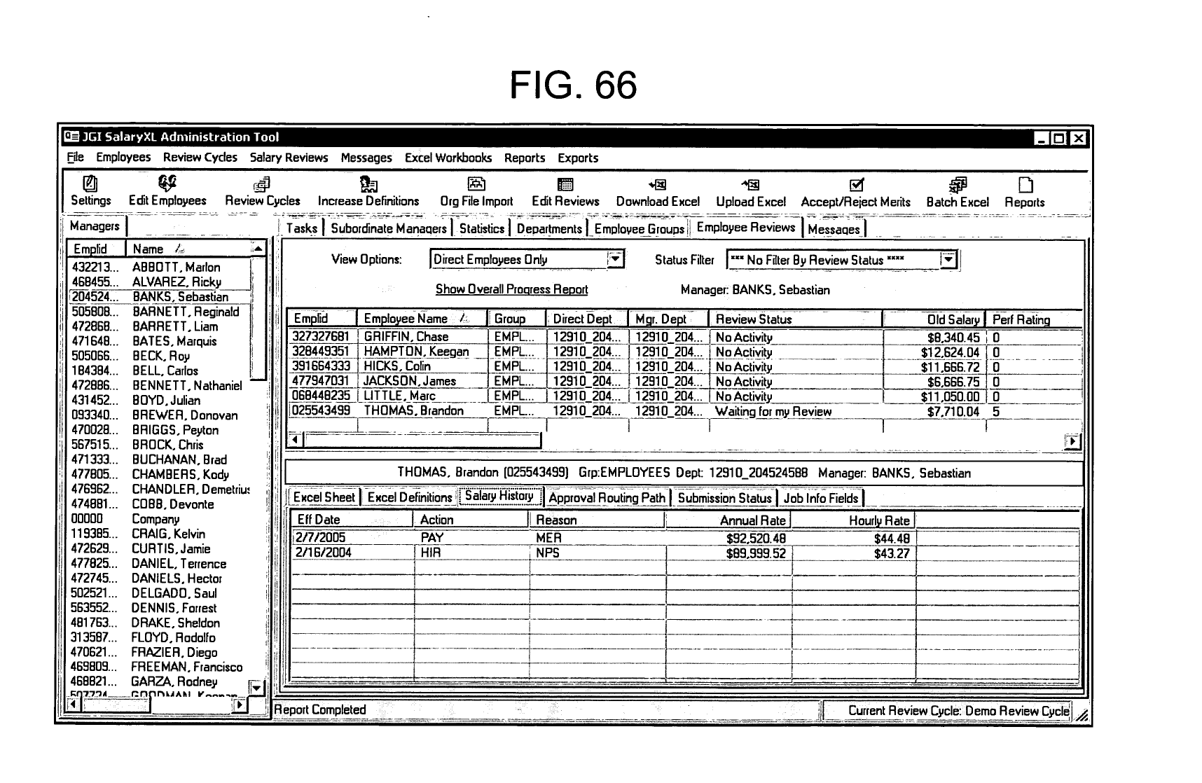

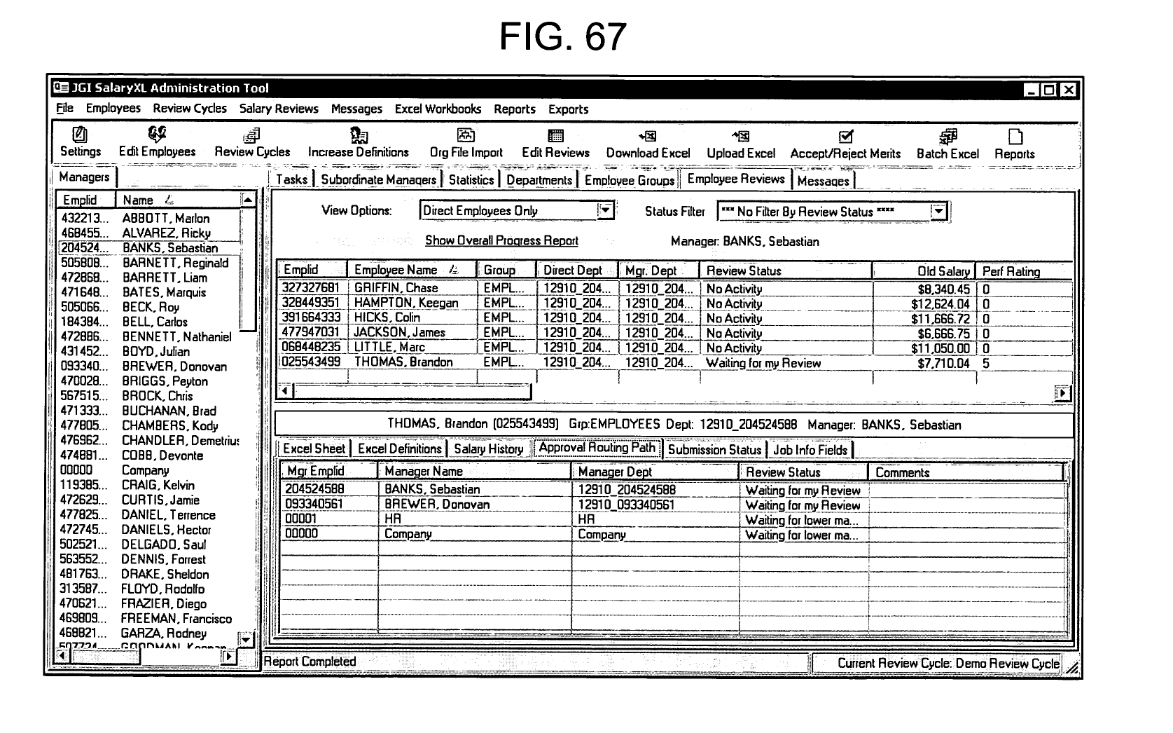

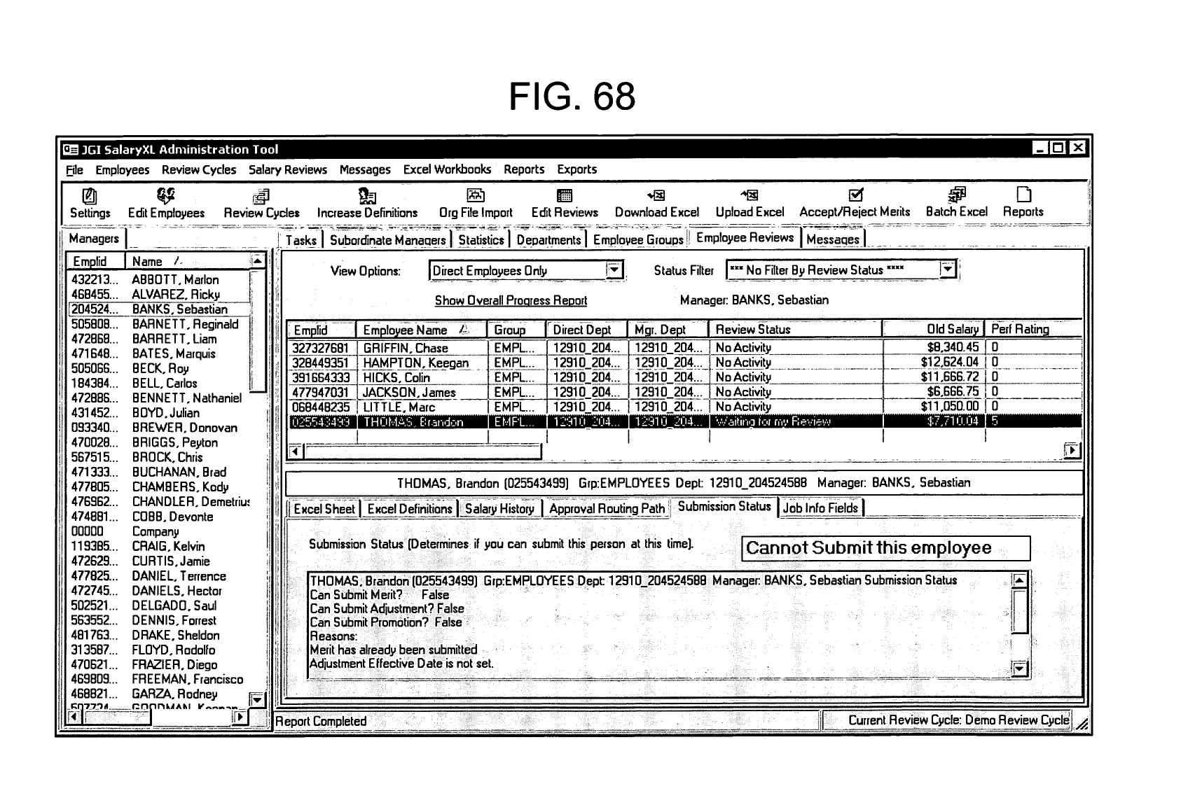

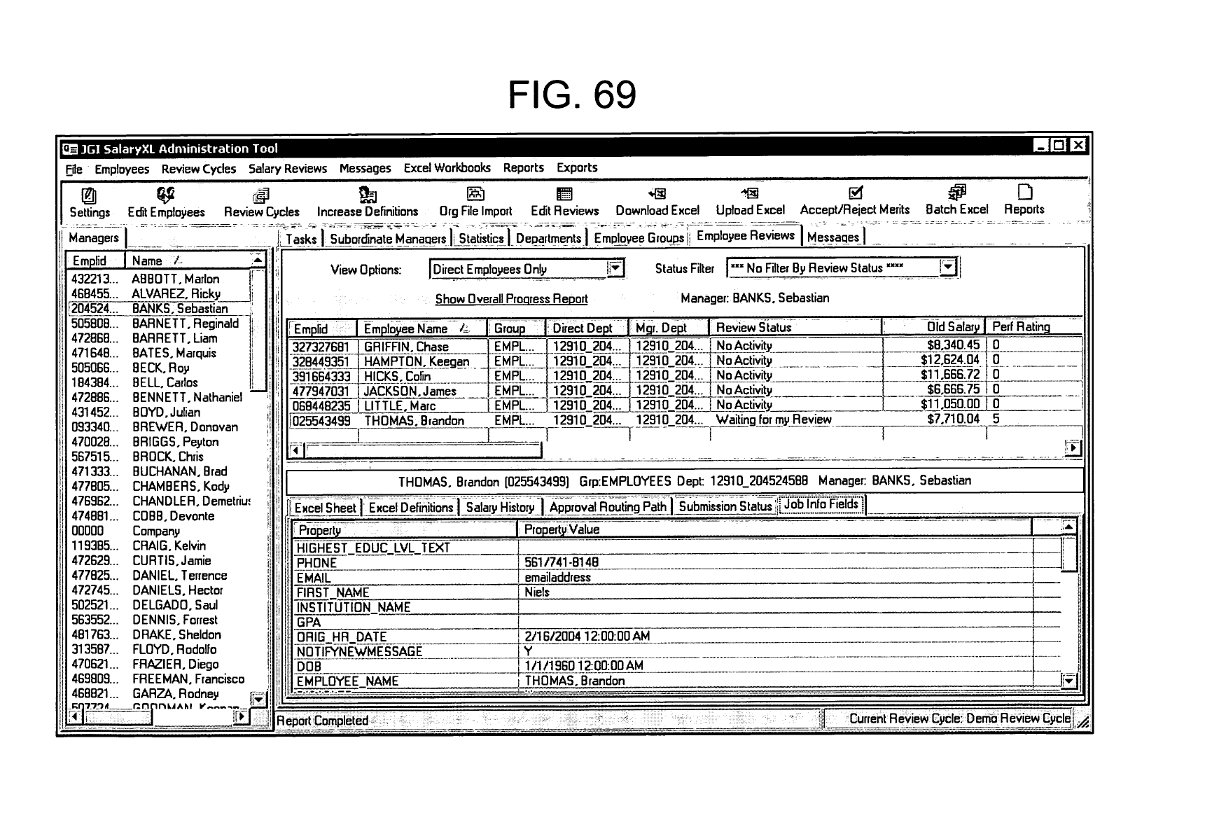

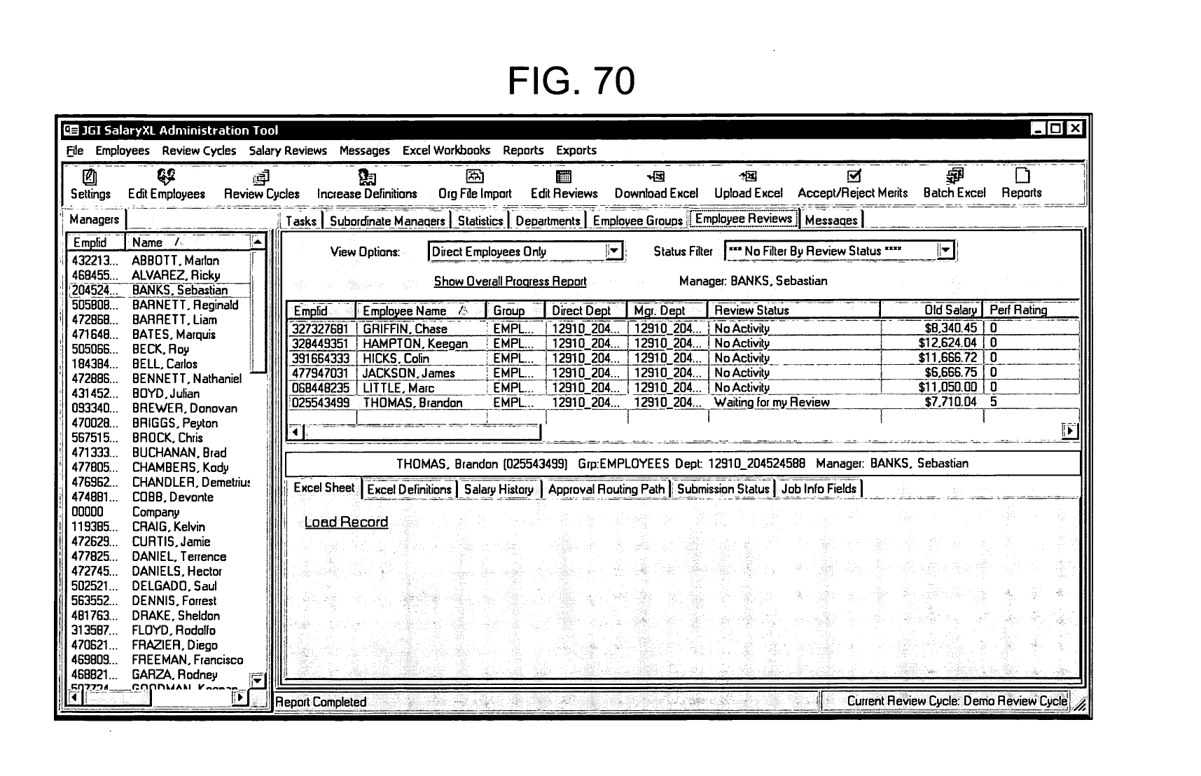

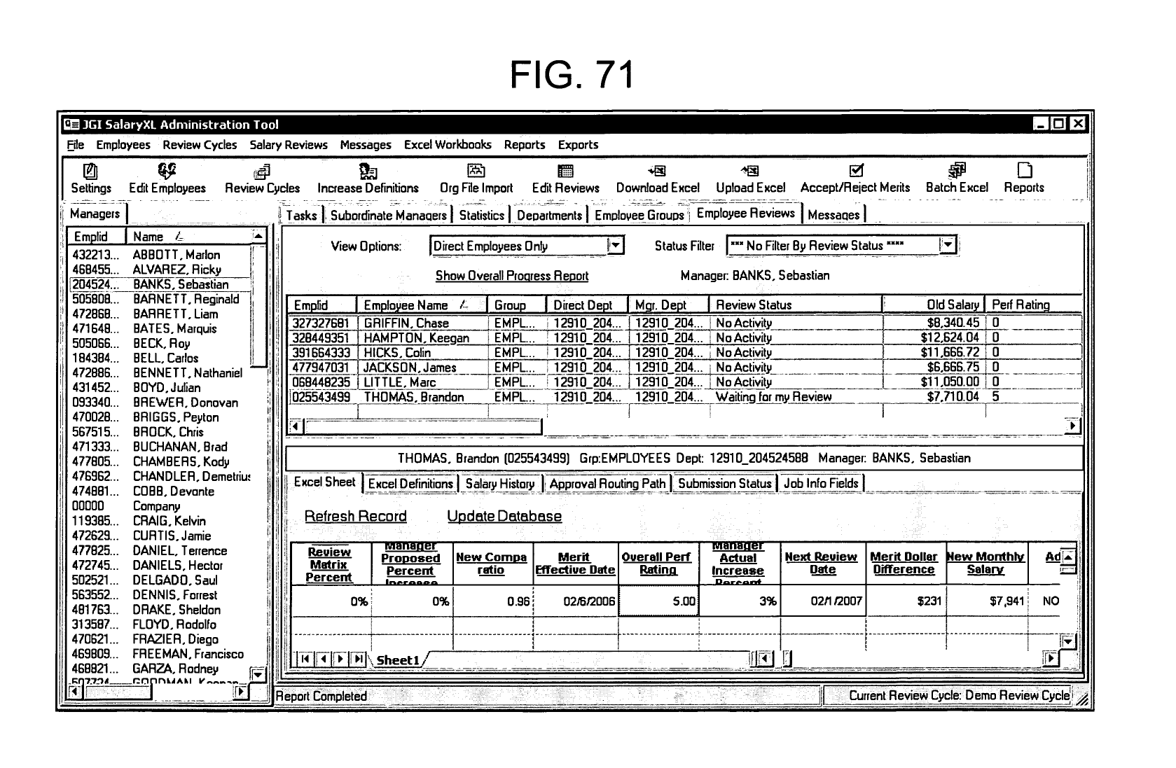

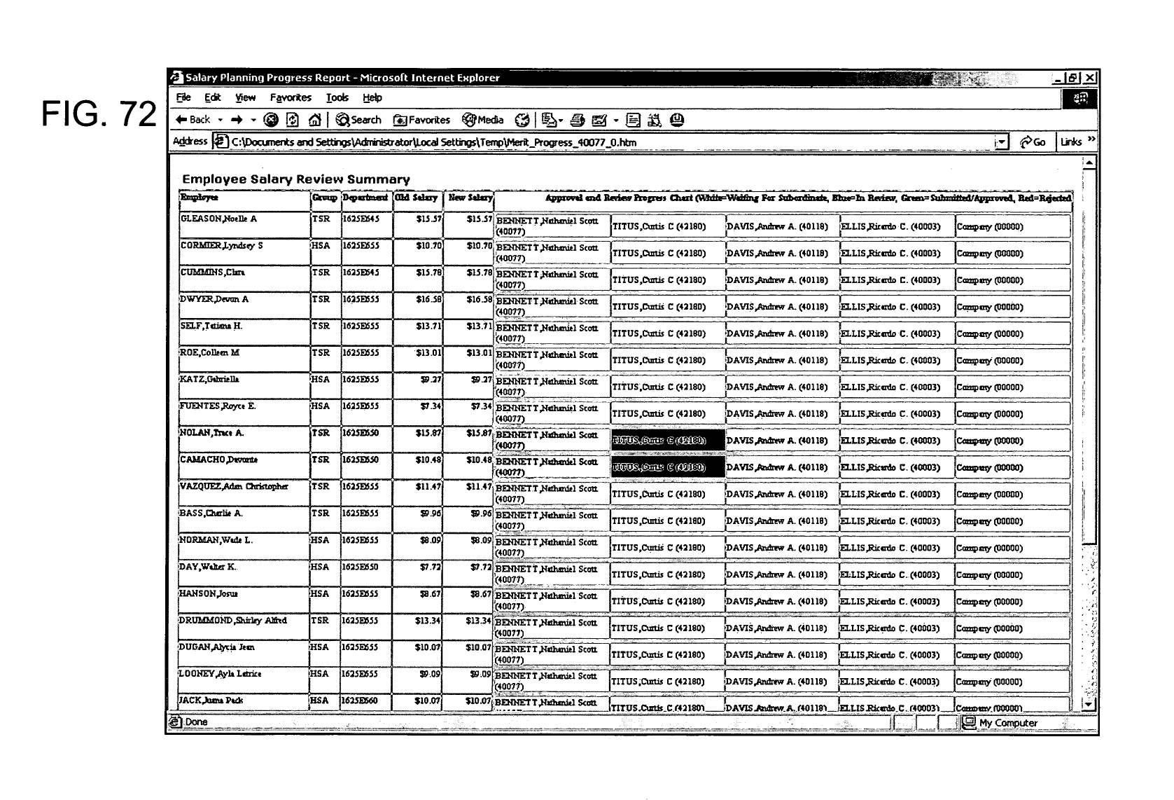

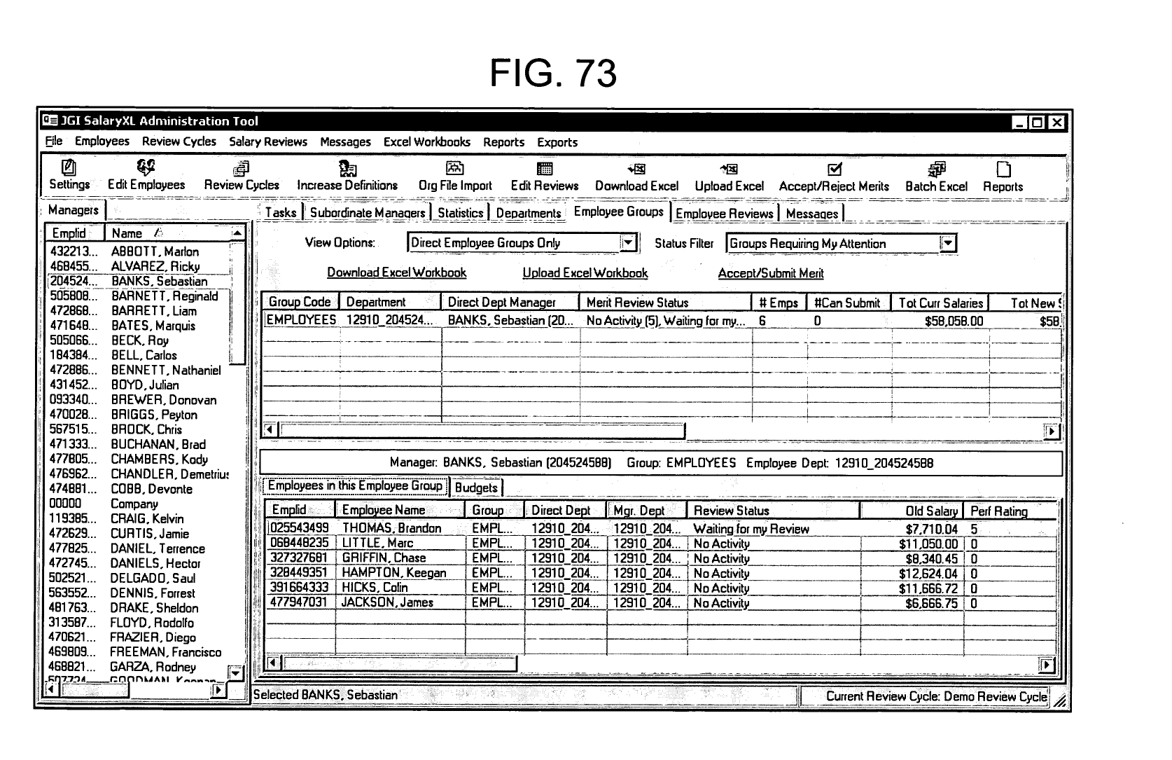

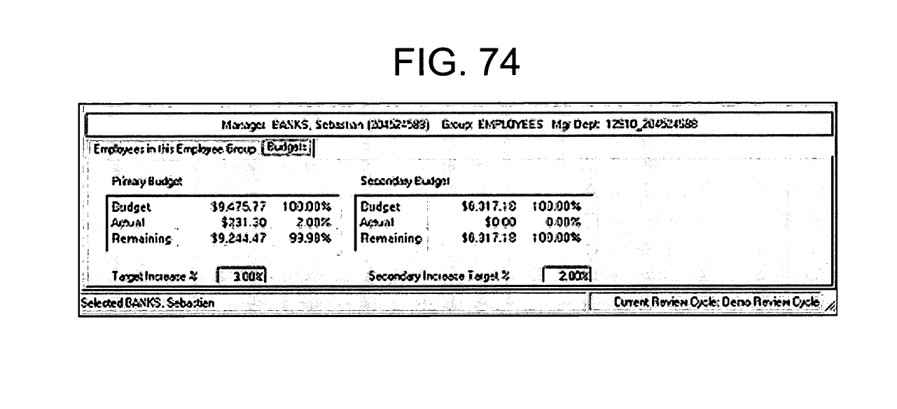

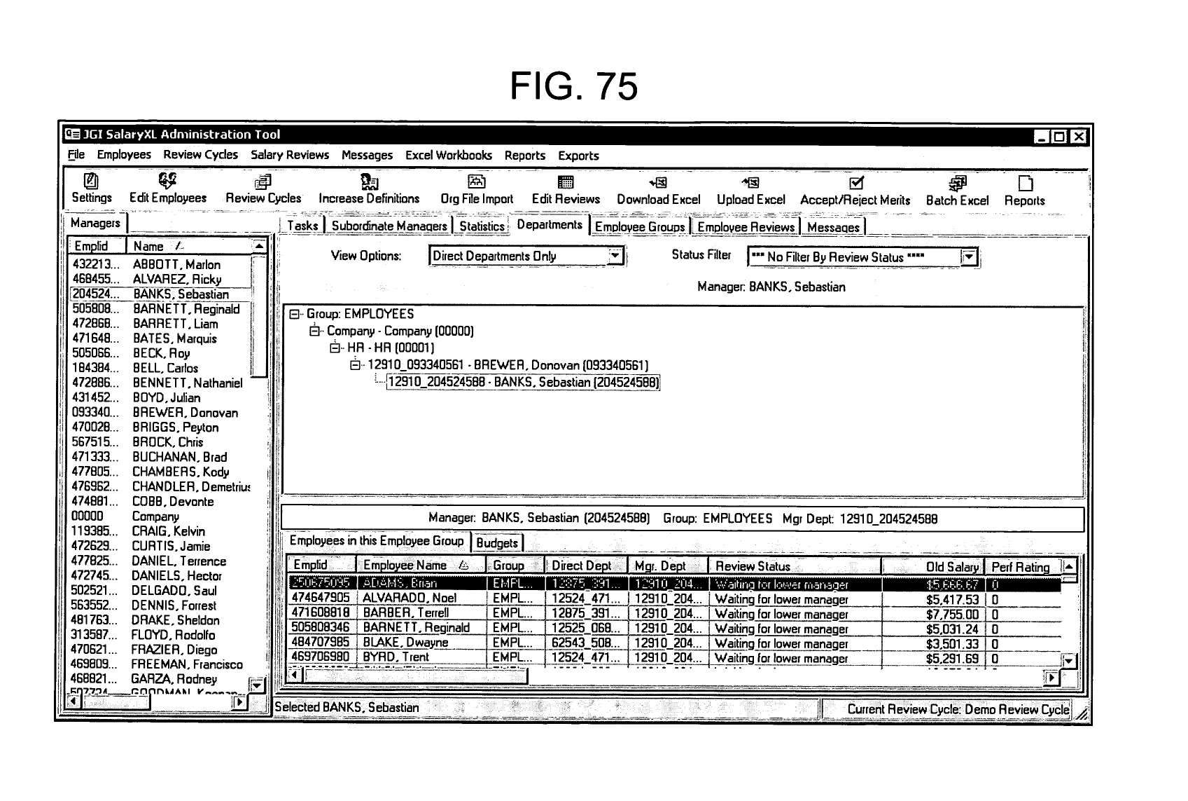

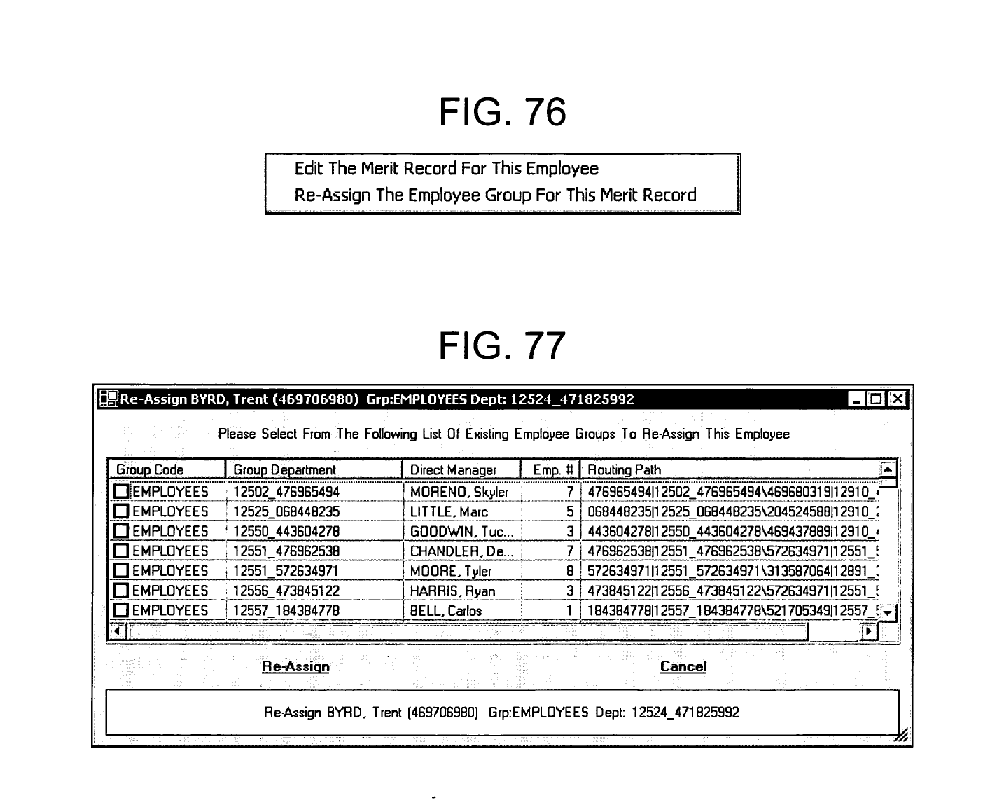

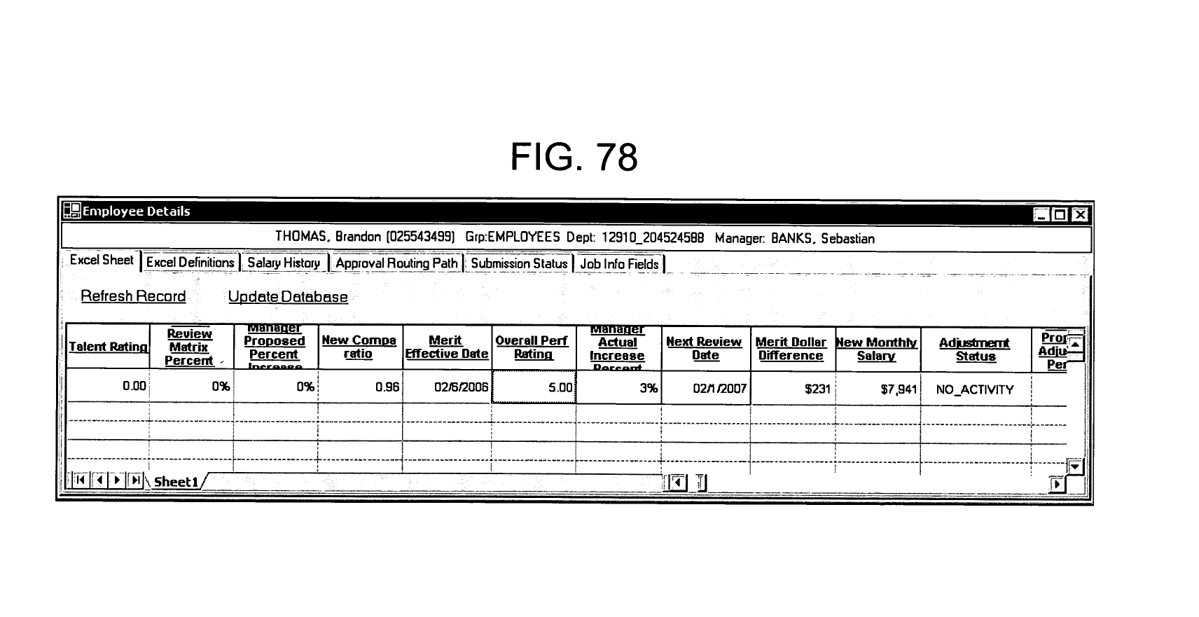

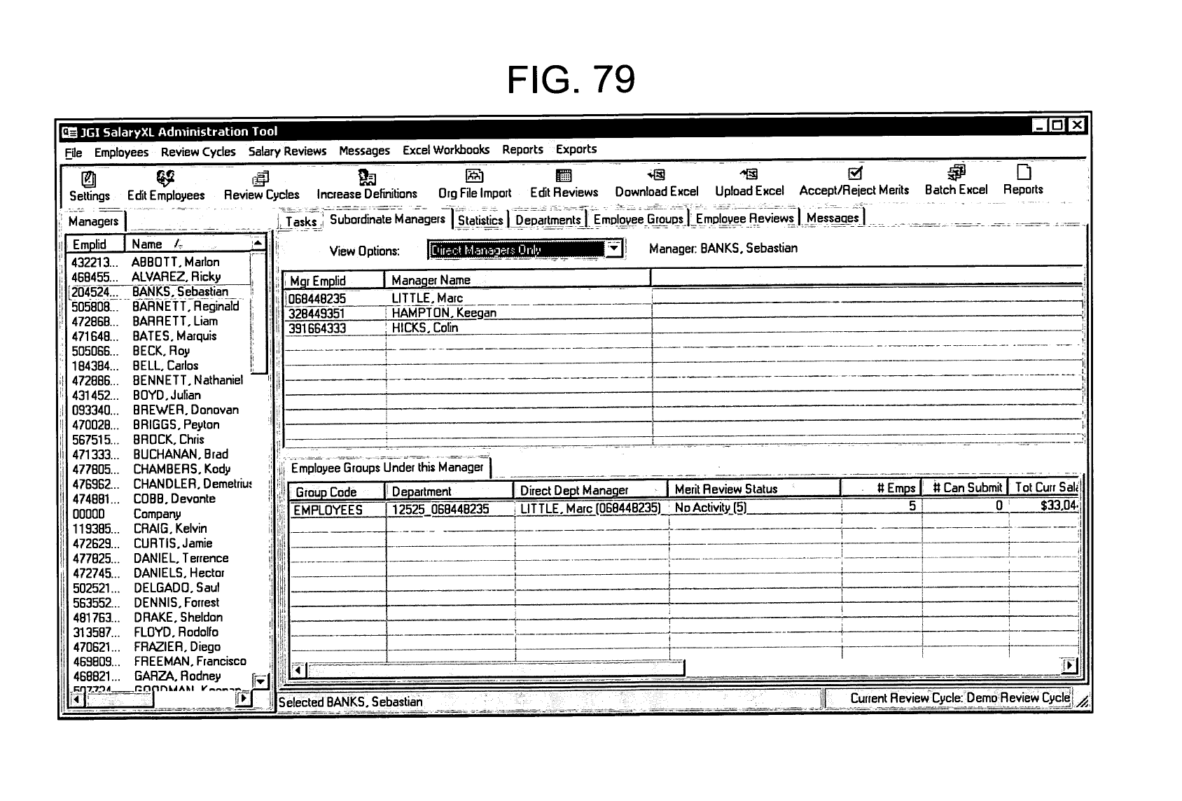

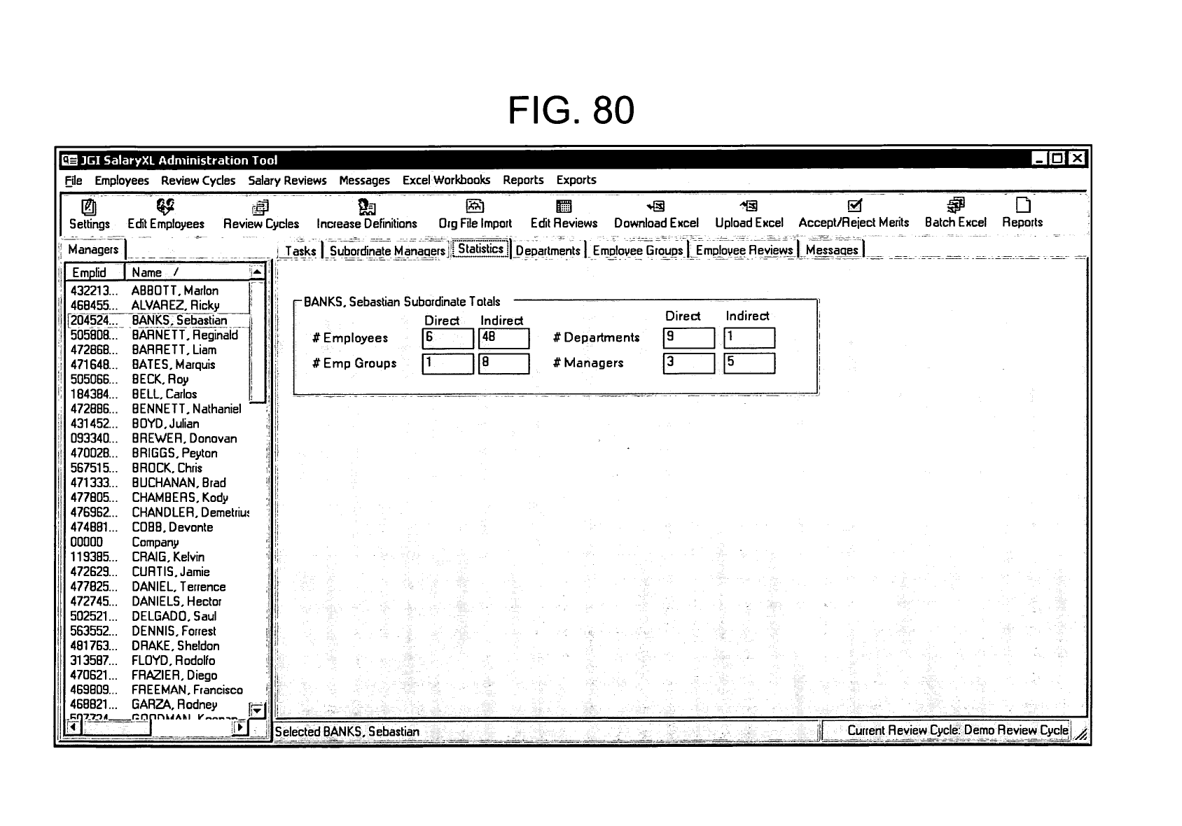

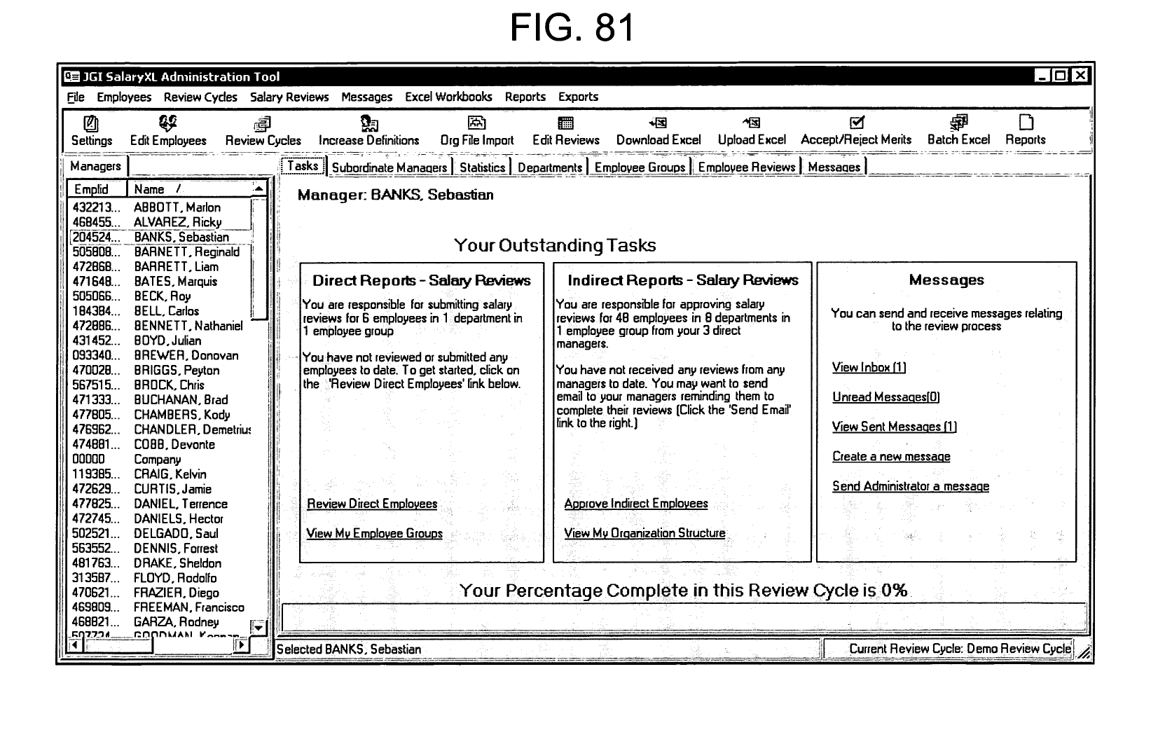

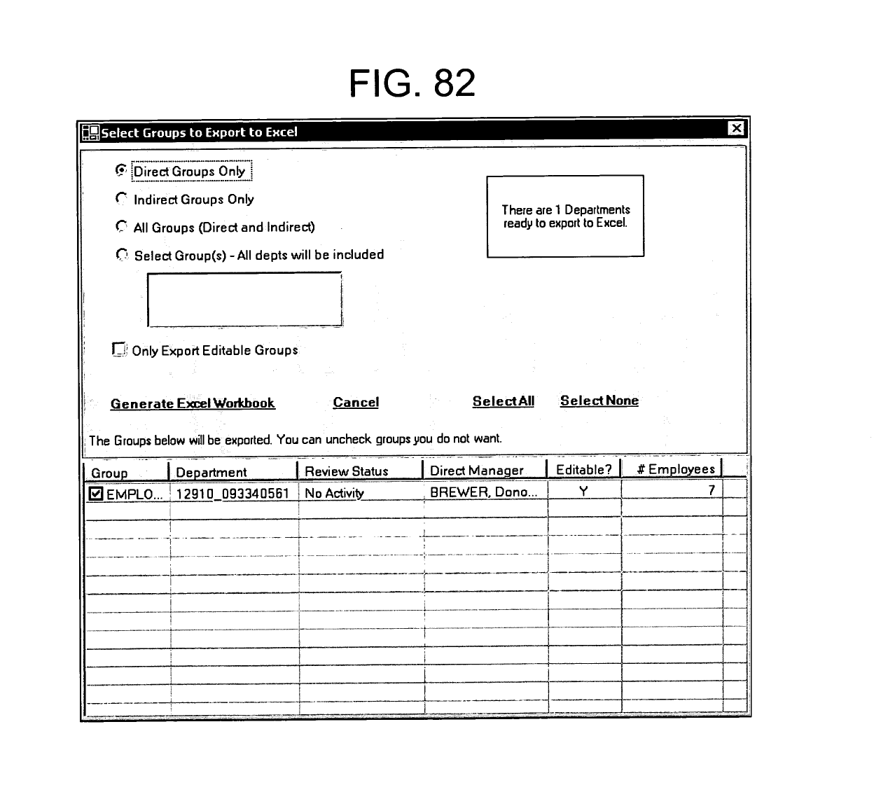

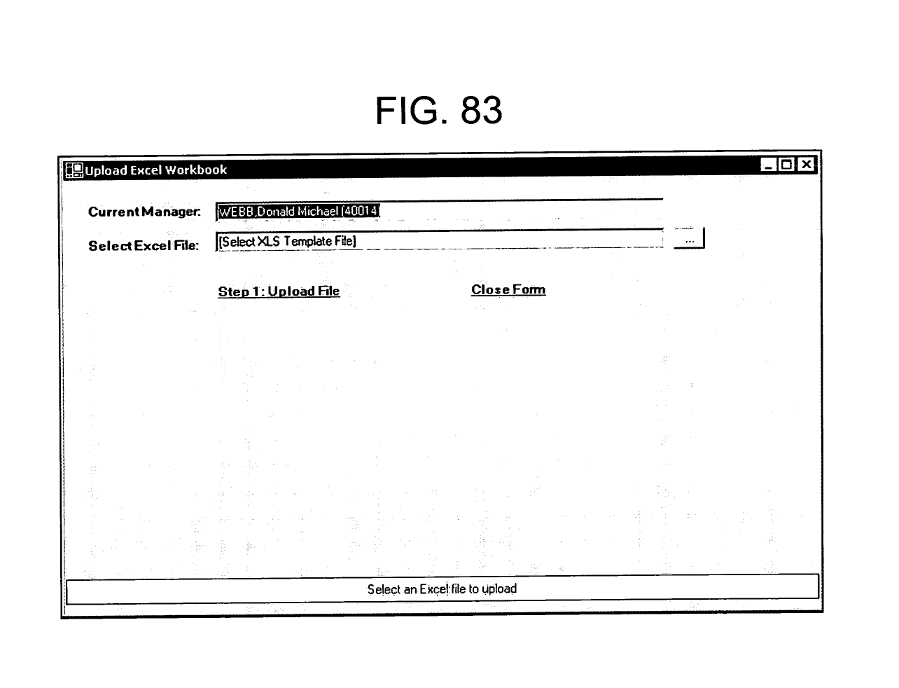

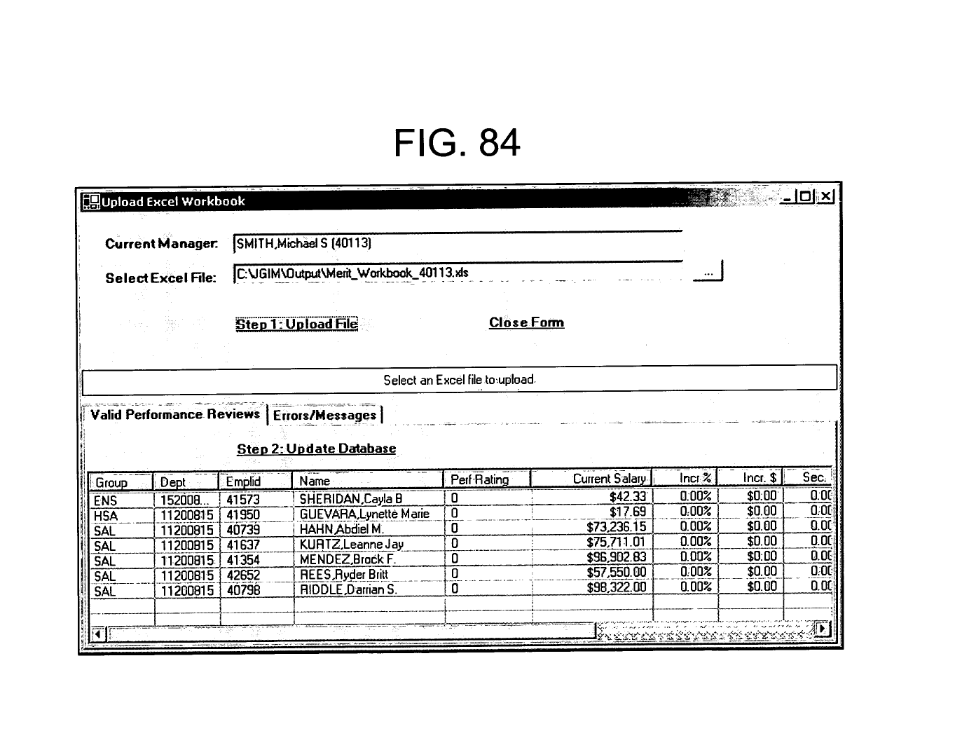

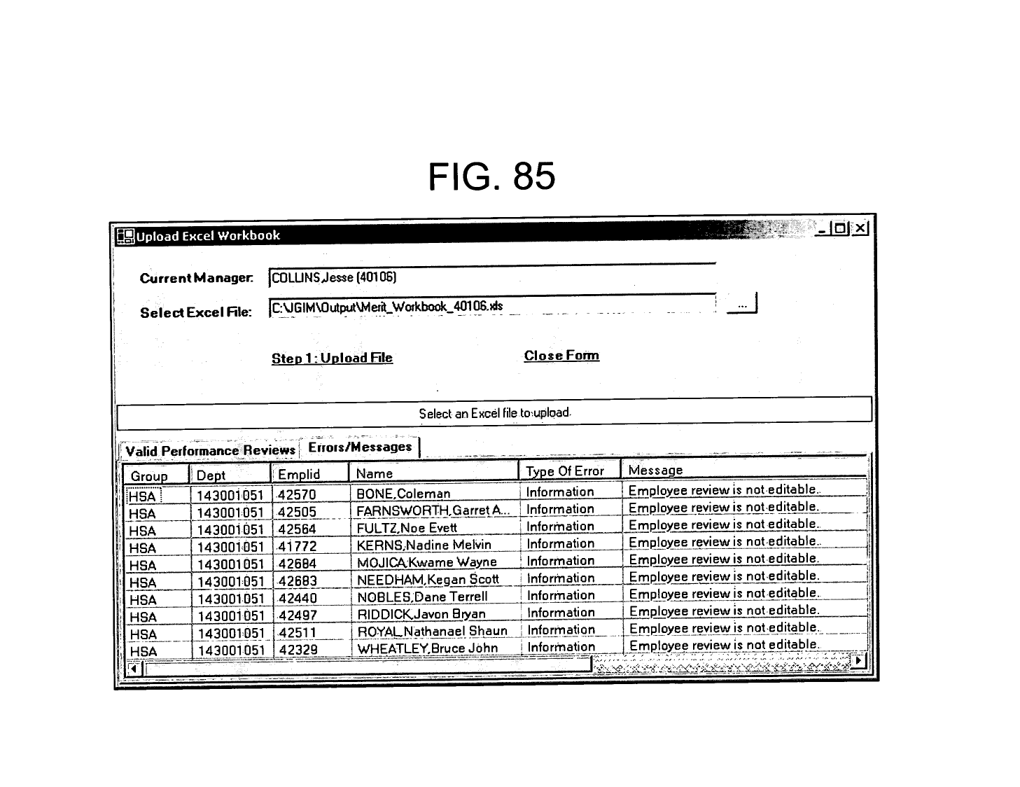

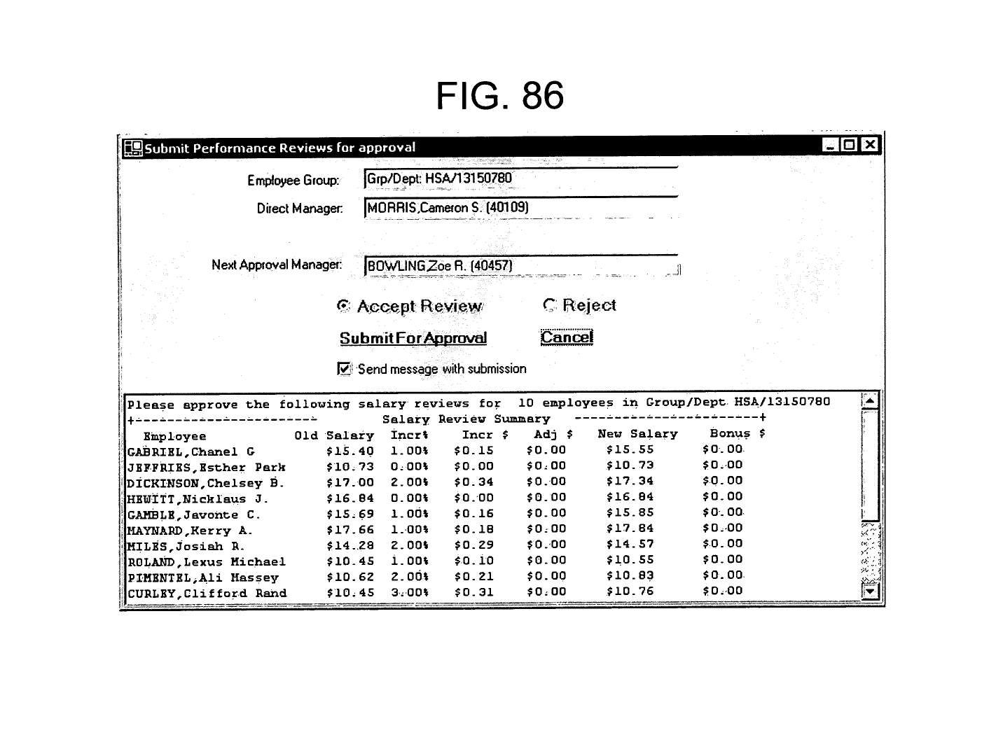

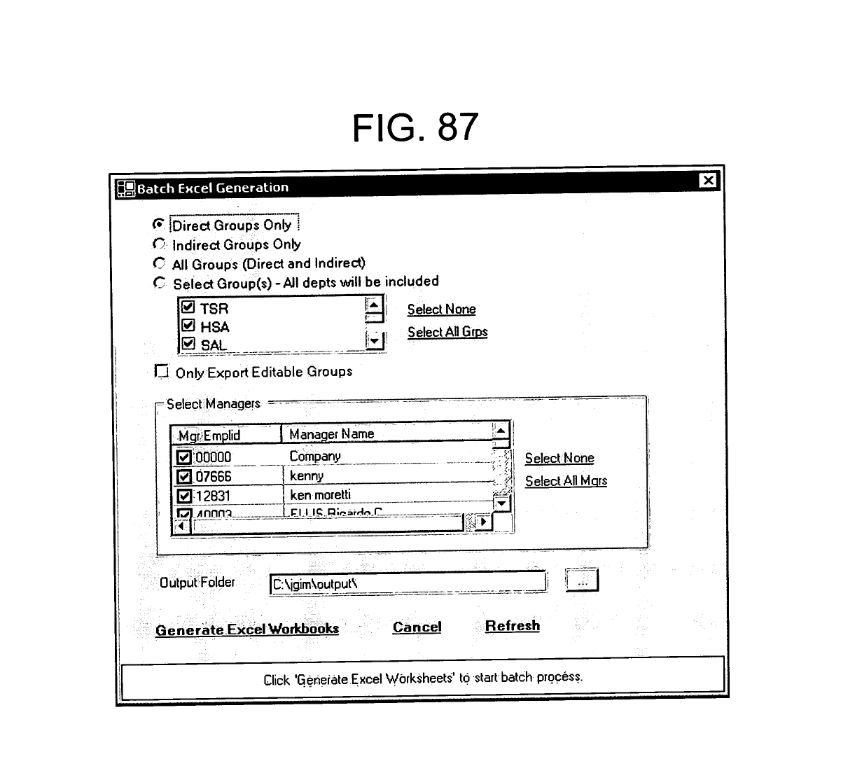

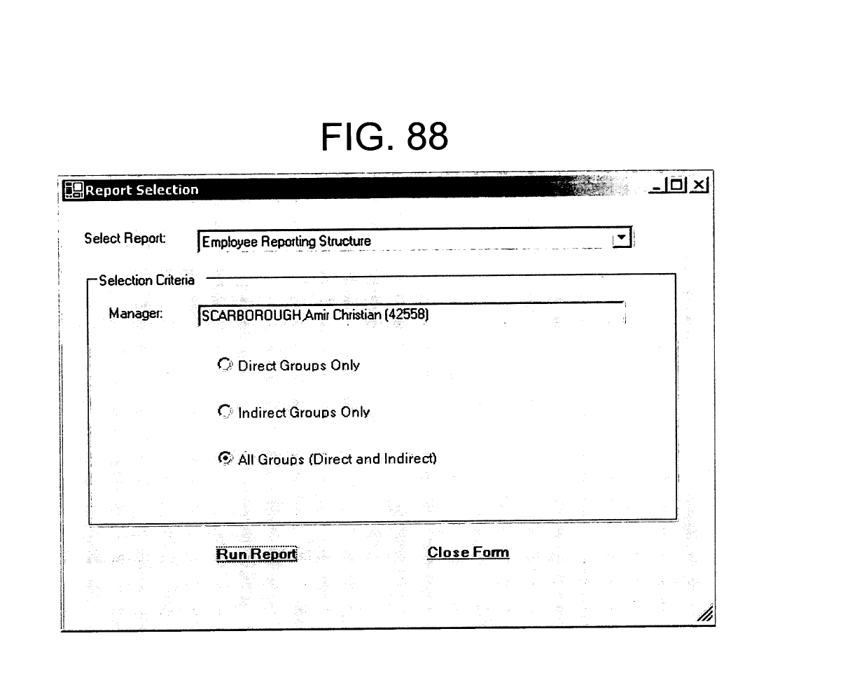

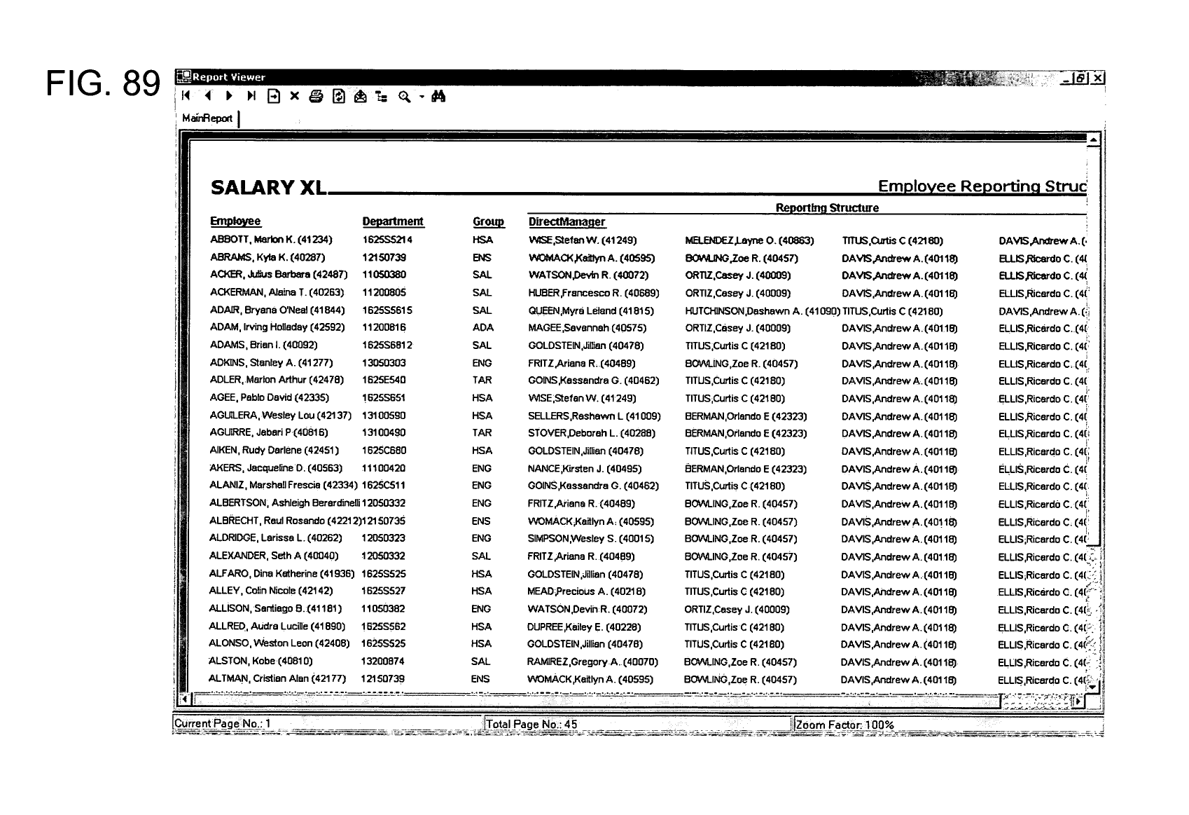

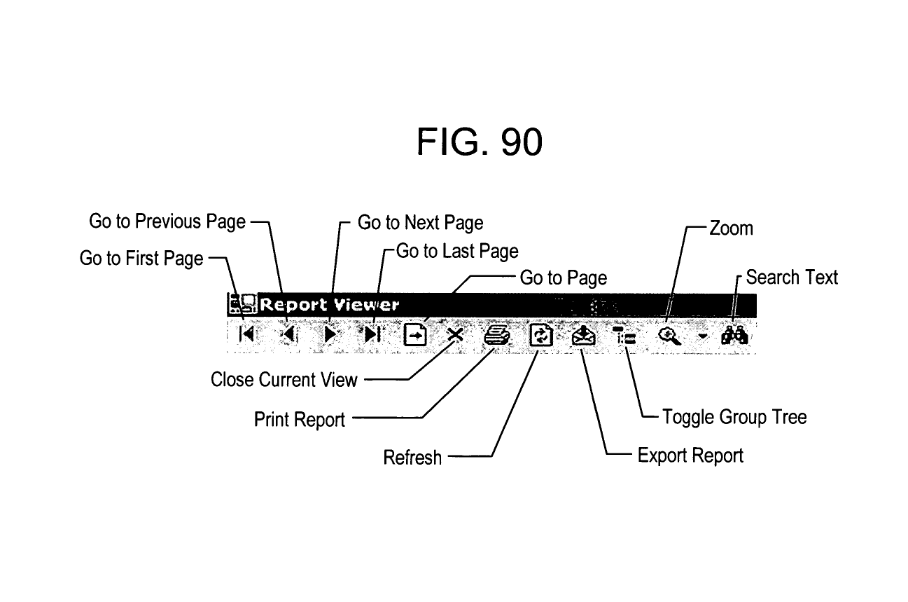

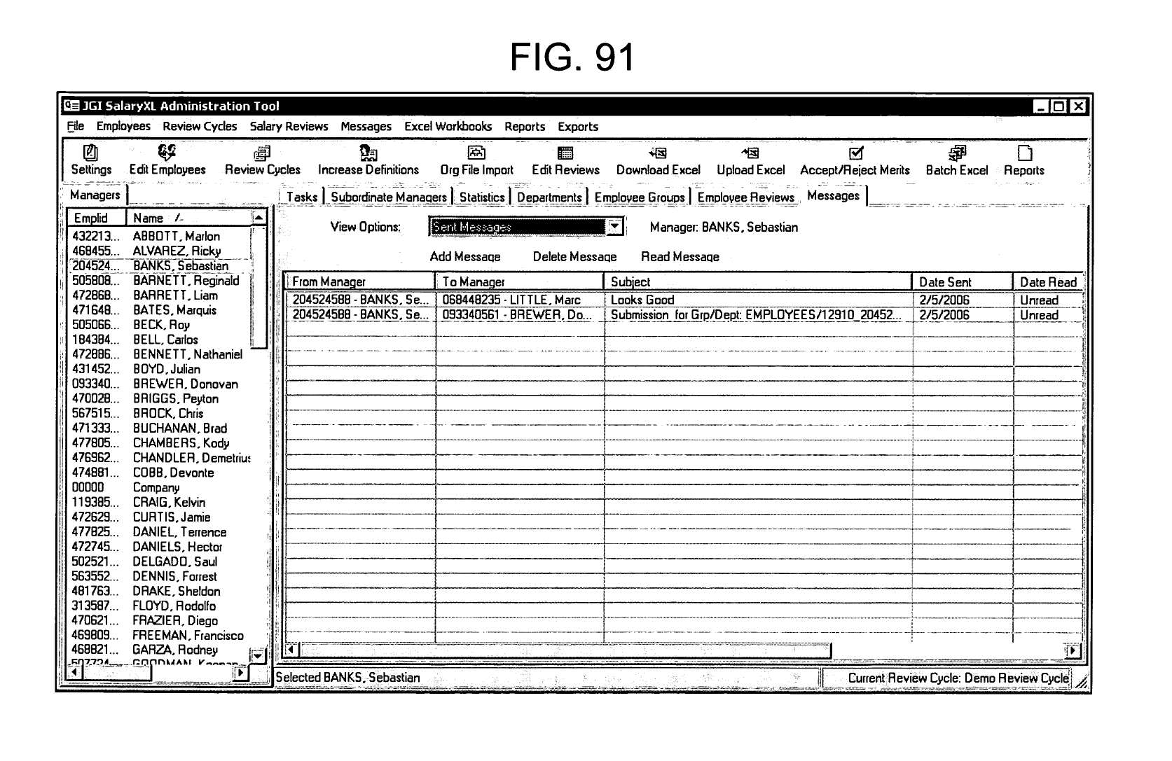

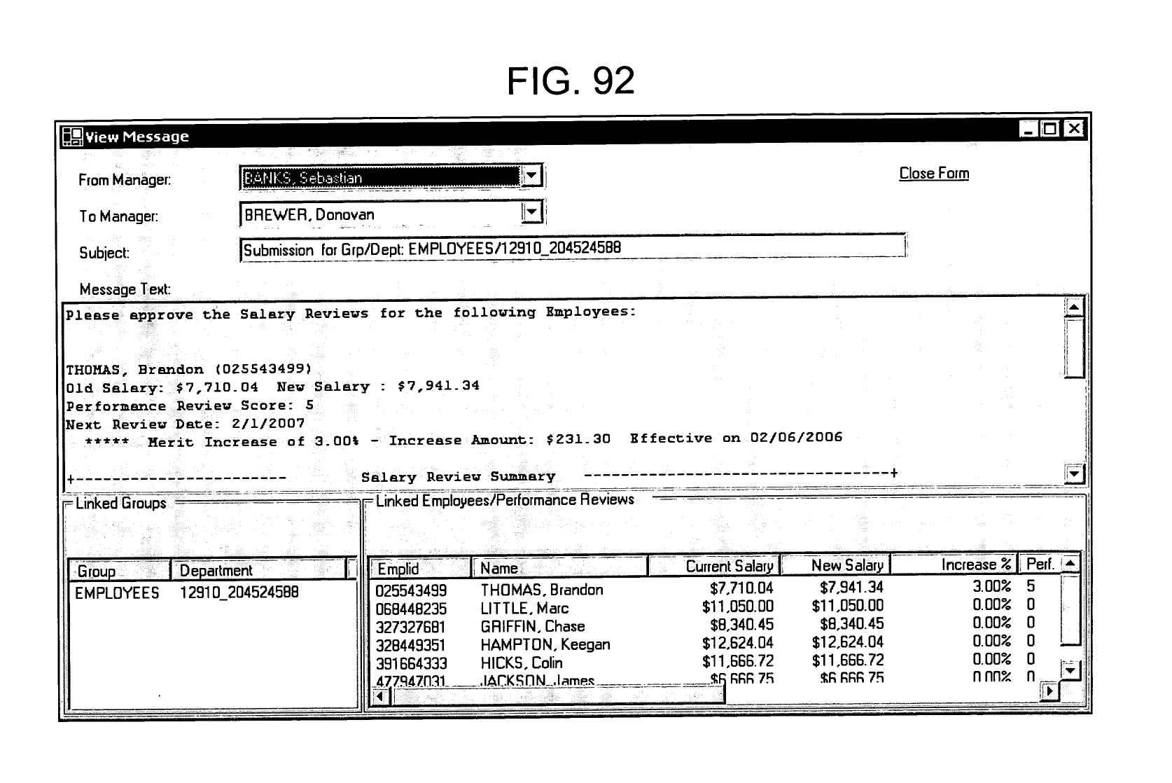

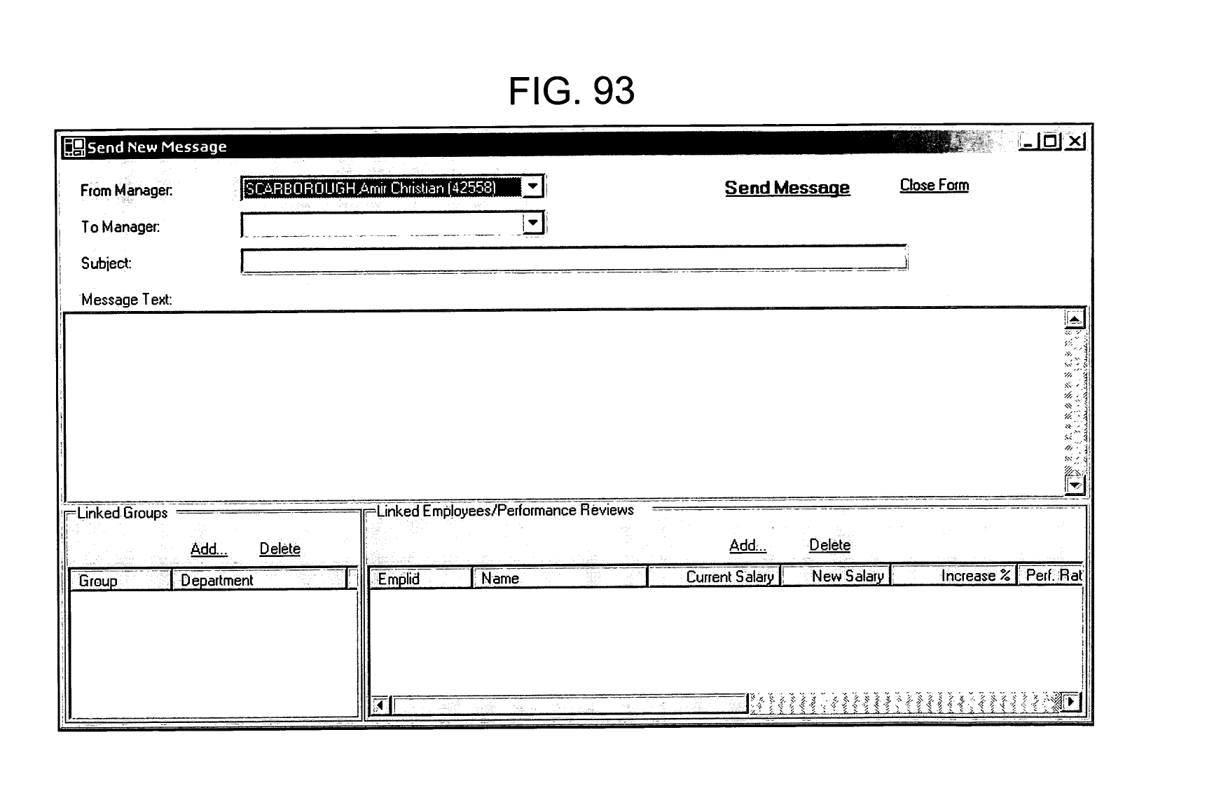

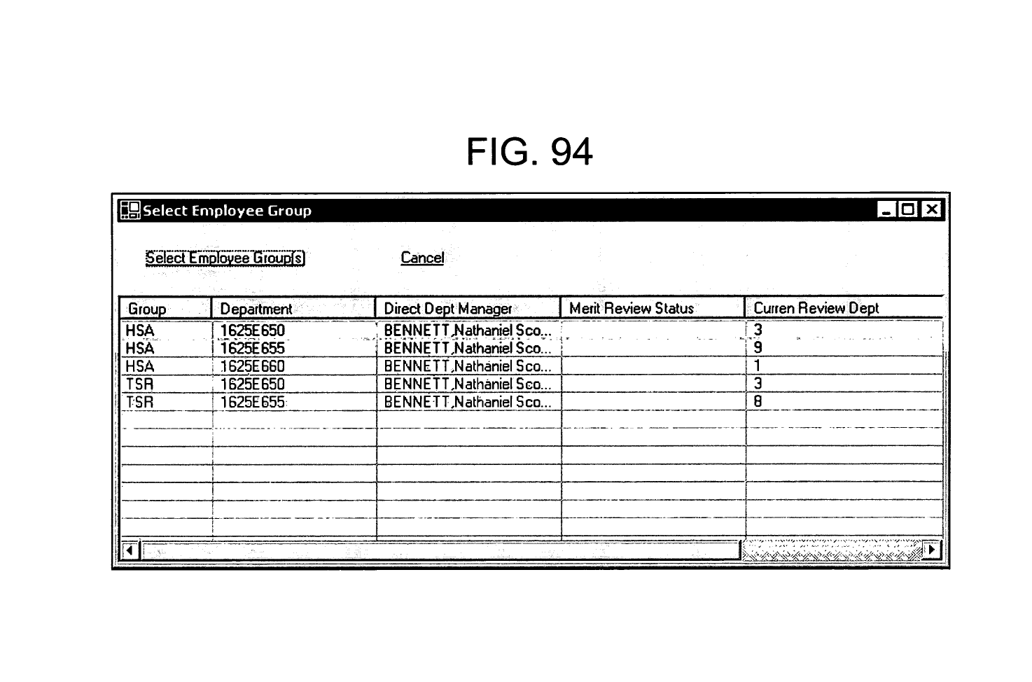

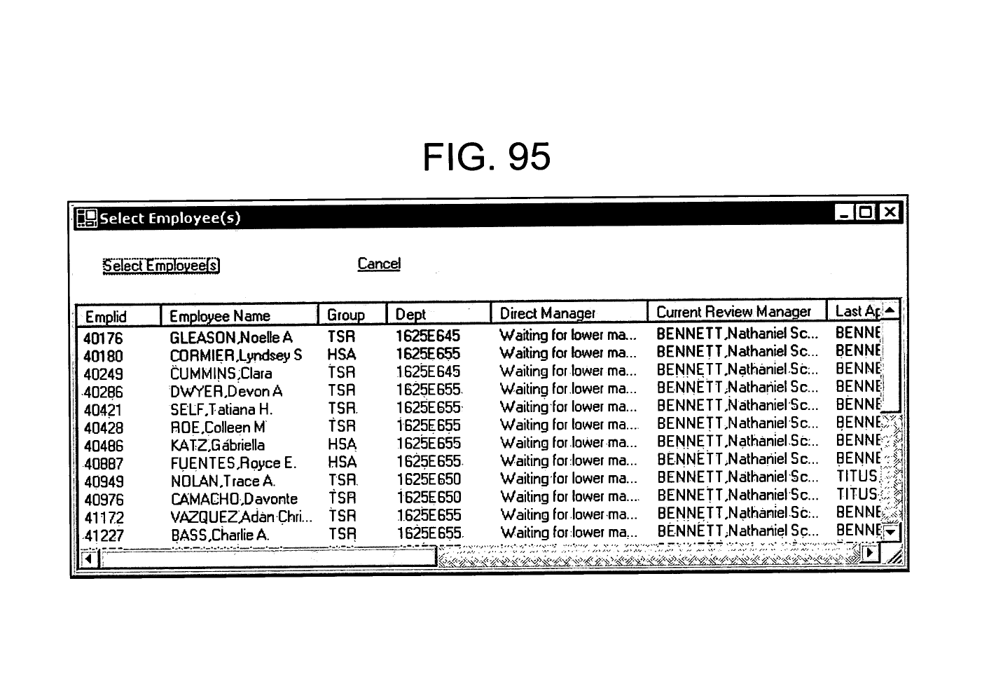

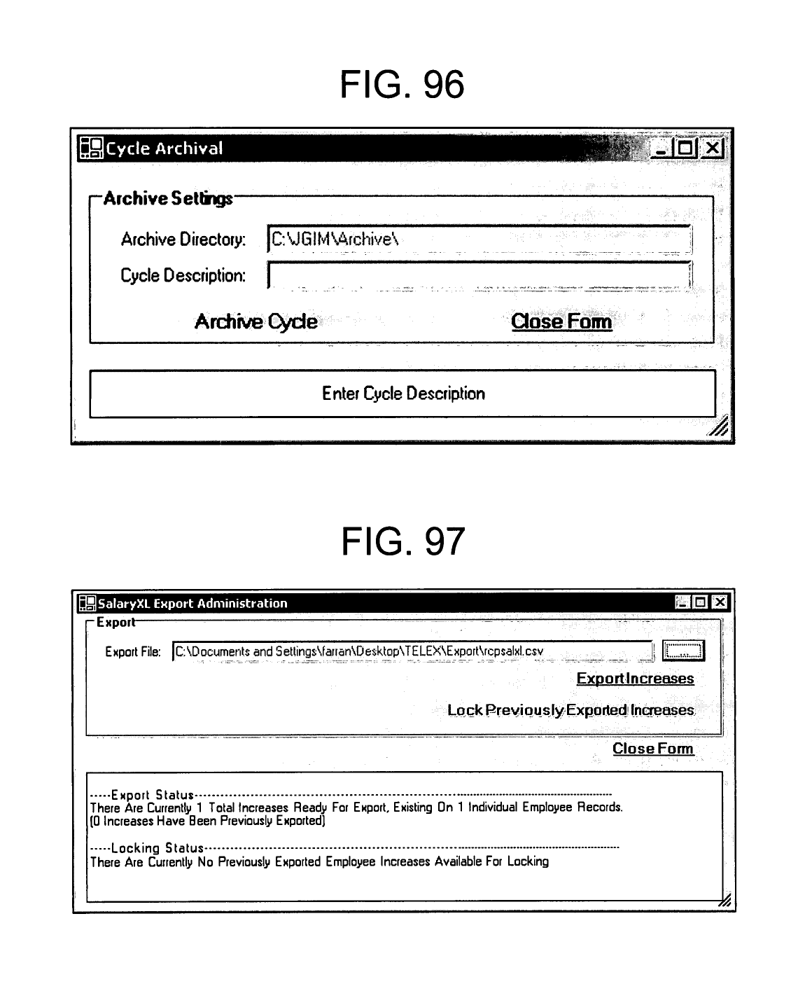

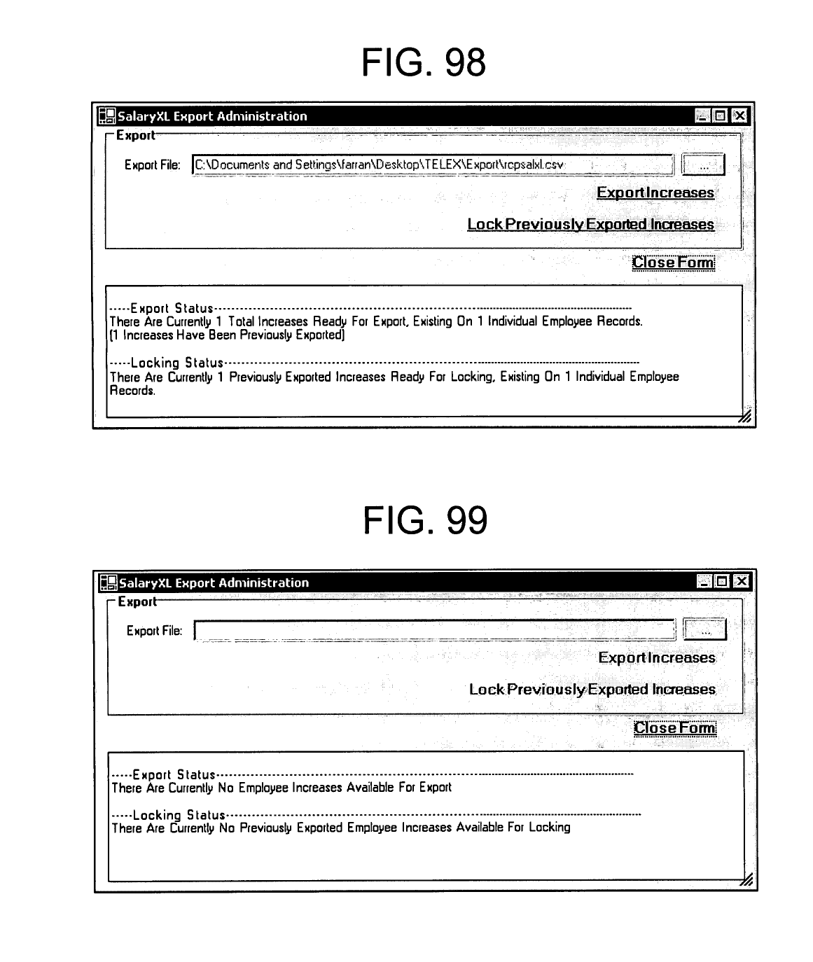

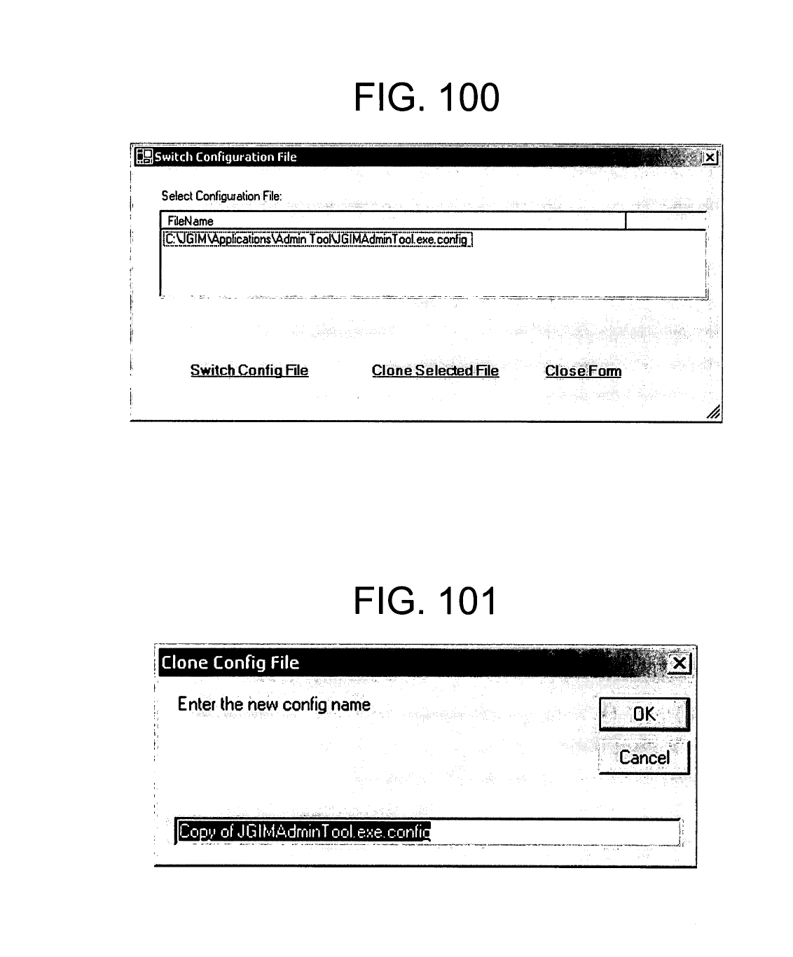

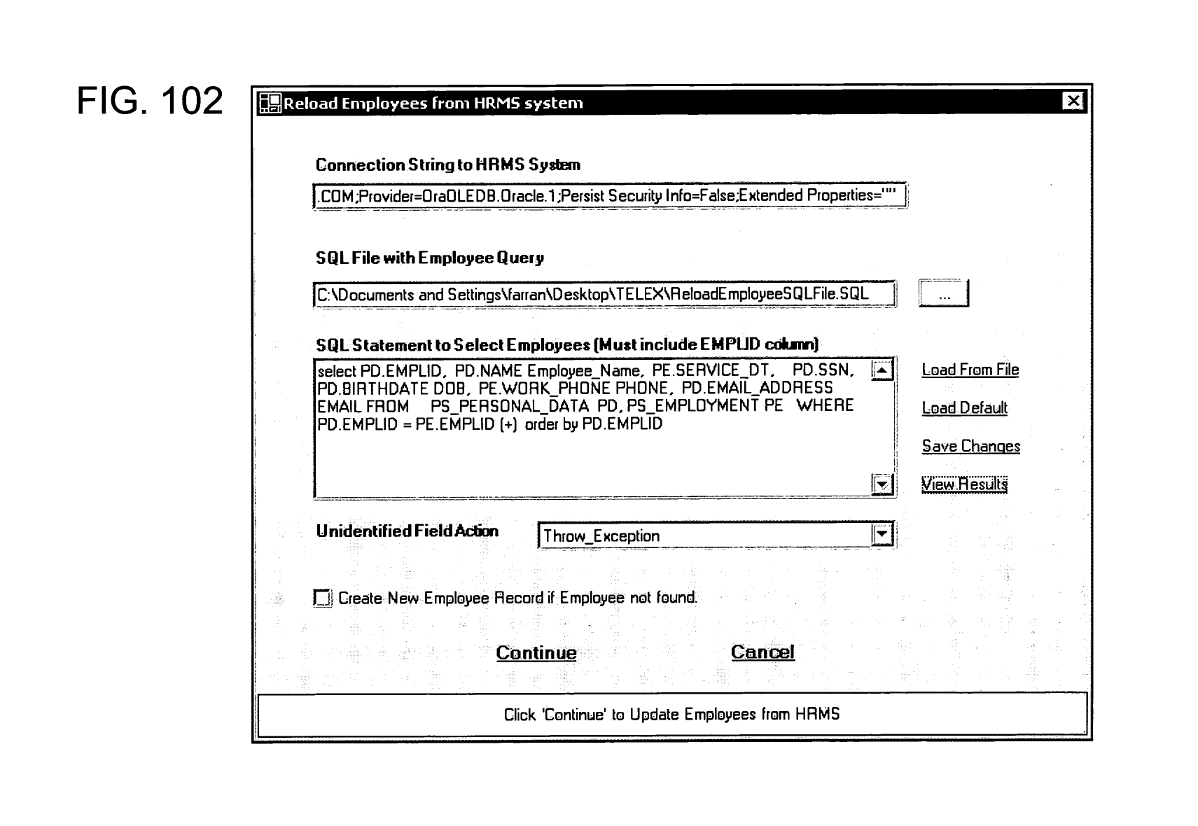

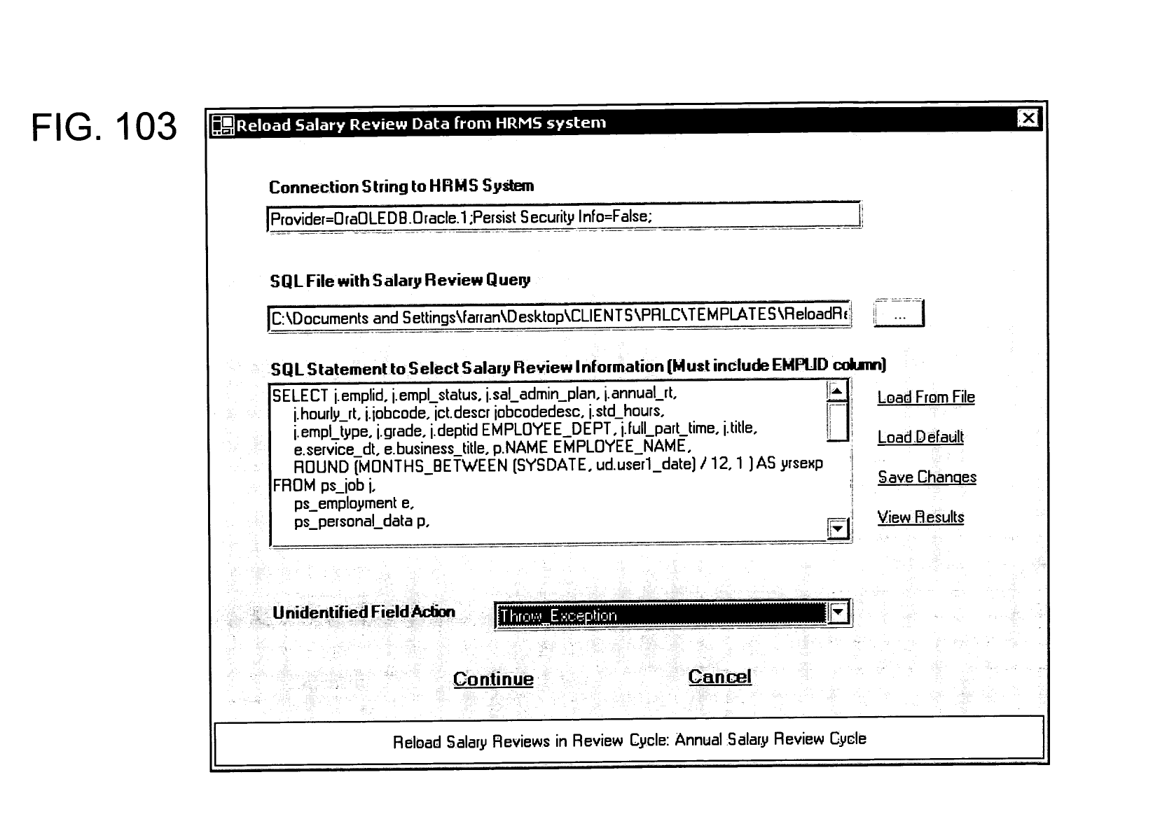

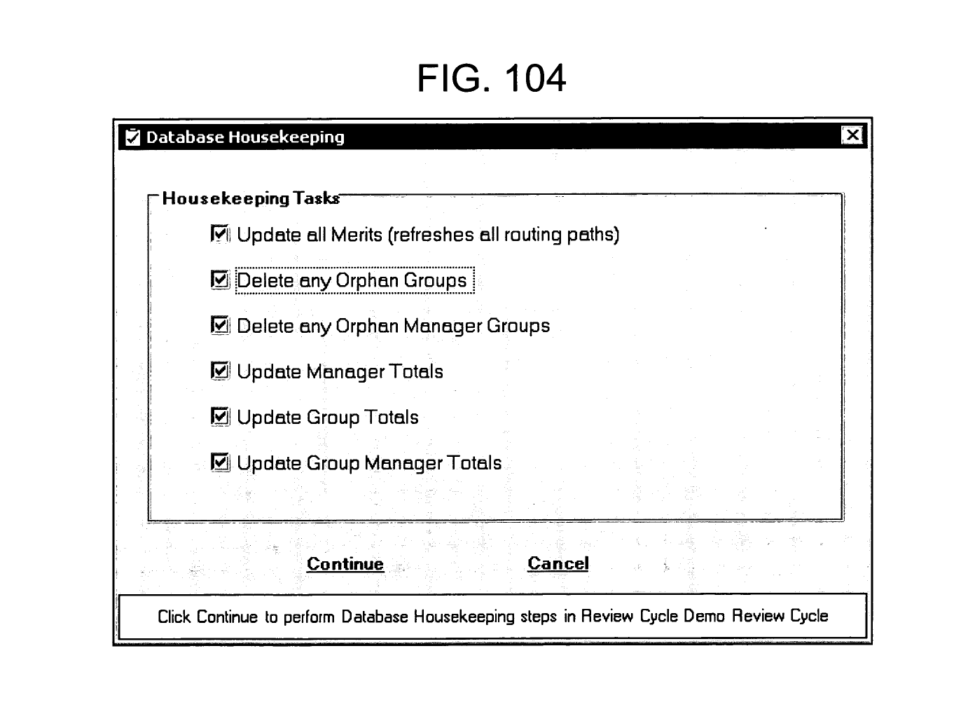

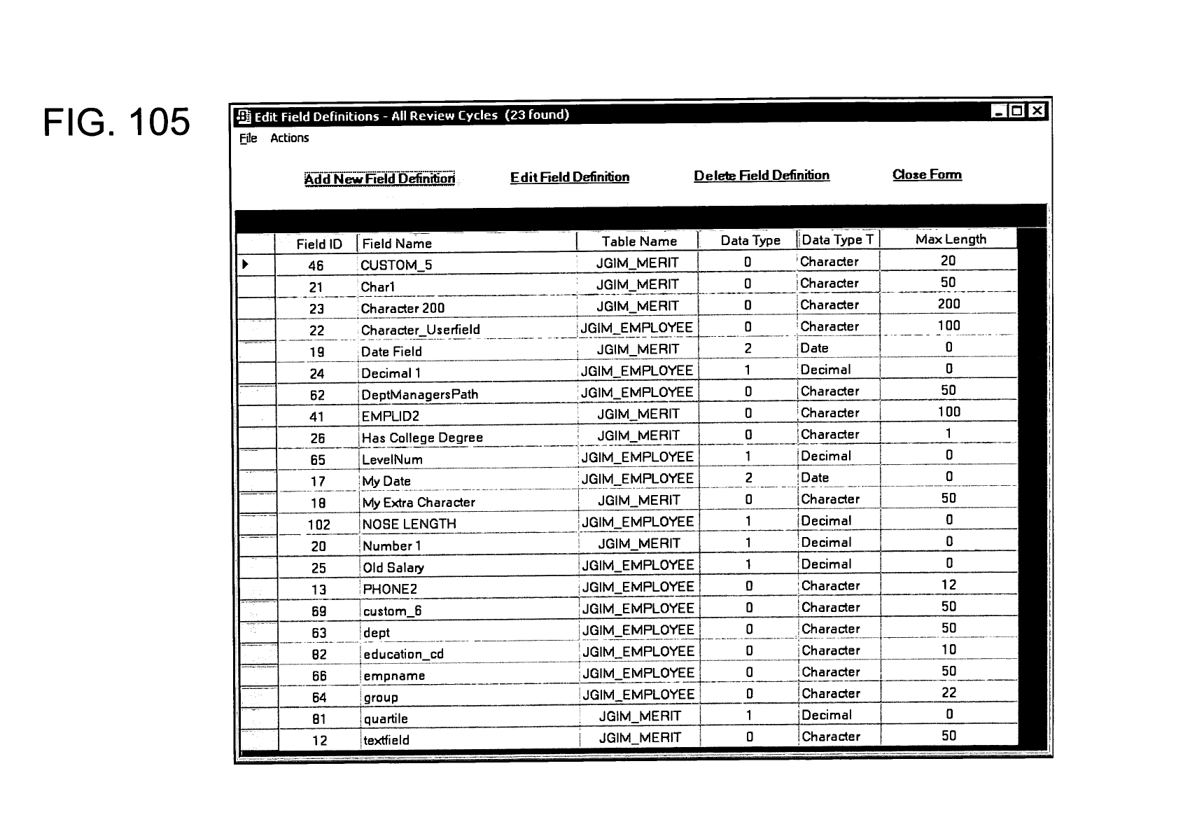

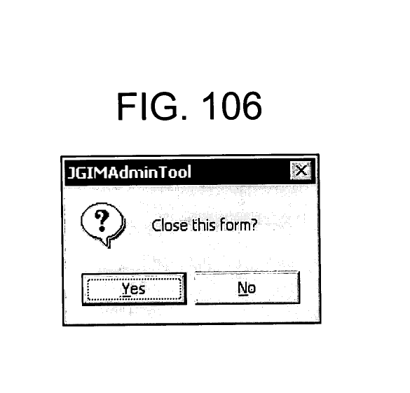

To exit the SalaryXL Administration Tool choose Exit from the File menu. A Close Confirmation dialog box will appear (see FIG. 106). Follow these steps:

Click Yes to exit and close the SalaryXL Administration Tool.

Click No to cancel and keep the SalaryXL Administration Tool open.

Thus, SalaryXL advantageously leverages an organization's spreadsheets that organizations have invested a lot of time and energy into and managers know how to use. And besides Excel is far and away the best user interface for any financial modeling task. SalaryXL brings control and structure into the often confusing and overwhelming task of salary planning. Most companies are using a manual Excel-based process and the vast majority is very unhappy with it. It's not the spreadsheets that are the problem—It's the lack of management and control that cause the pain. SalaryXL solves such salary planning problems while leveraging what is already in place. Unlike more expensive solutions, SalaryXL is simple, easy to use, and can be implemented in just a few weeks. SalaryXL allows leveraging of not only existing HRMS (e.g., ADP, Lawson, PeopleSoft, Oracle, etc.), but also current manual Excel-based salary planning processes as well. SalaryXL provides managers with the ability to use the spreadsheets they are familiar with, while inserting control, management, and sophisticated workflow into the process. The novel spreadsheet (e.g., Excel)-centric approach allows maintaining of the elements of a current process that work.

Exemplary features of SalaryXL include Use your existing Spreadsheets, Real-time Salary Reviews, Online and Offline updates, Integrated with your current HRMS, Standard & Ad-hoc reporting, Monitor Manager status in real-time, Multiple Custom Increase components, Integrated Approval/Notification, Segment your organization as necessary, Integrated Job and Salary History info, Intuitive and easy to use, Drastically reduces the time required for preparation and execution of salary planning cycles, Tracks and Enforces budget targets, Eliminates Errors, Ideal user interface for financial modeling application, Accommodates any organizational structure, Flexible Reporting, and Affordable.

With SalaryXL, Salary Planning for Compensation Managers/Administrators can include using the SalaryXL—Salary Planning Admin. tool to set up your Merit Cycle, including pulling the necessary information from your HRMS system and segment your employee population into any number of groups. SalaryXL allows you to grab data from other systems as well. Now check out your organization. The structure of your organization is displayed via an easy-to-use graphical tree-like presentation. Tweak your organization, using the organizational tool to make changes to the organization structure so it meets the real-world requirements of each salary planning cycle. Then, spreadsheets are taken and transformed into custom Excel templates that specifically meet your needs. Any number of templates can be created to meet the exact needs of all of your managers. These templates generate Excel spreadsheets on-the-fly from real-time data and enforce your specific unique business rules and calculations. Impersonations can be set up so Administrators and interim managers can do the salary reviews they need to.

Once the salary planning cycle begins Comp Managers can manage and control the salary planning cycle in flight, including seeing the status of any manager at any point in time, monitoring overall process and budgets, making review changes and adjustments, drilling down with custom reports, receiving notification and handling real-time events, such as Terminations, LOAs, Transfers, etc., and communicate, manage and control the process. When the cycle is complete, information is extracted and updates are sent to HRMS.

With respect to Salary Planning for the Managers/Users, managers can perform salary planning tasks quickly and easily via an intuitive web-based application, including using existing sign-on/authentication, SalaryXL tells you exactly where you are in the process and exactly what tasks you need to perform, Download spreadsheets and work off-line at your convenience, or use our unique online review feature to work with your spreadsheet online.

SalaryXL allows performance of salary reviews with all the information you need at your fingertips, including Previous reviews and manager comments, salary history, job info, whatever you need, Submit reviews for management approval, Approve/Reject the reviews of subordinate managers, and Send “what if” scenarios to management and subordinates

Organizations are often far more complicated then they are spelled out in your HRMS. Dotted line reporting, Managers wearing multiple hats, and other common organizational anomalies can twist your “Reports To” tree into a pretzel. However, SalaryXL's organizational approach allows you to Specify a unique approval path for every group in your organization, Add managers, and Allow managers to stand in for other managers. You can sculpt your organization—Making it perfect for each salary planning cycle.

Using Excel-Centric Architecture—Your unique rules can be enforced with minimal or no programming. No matter how strange or unusual your business rules are, SalaryXL can incorporate them with minimal or no programming. If your rules can be stated using an Excel formula, SalaryXL can accommodate them. With the unique Excel-Centric architecture, one can create templates that match your existing spreadsheets and incorporate your look and feel, your data elements, sorting and grouping, and more. As your managers access their spreadsheets, templates are loaded with real-time review data. The managers can work with them online or download them and work offline at their convenience. Spreadsheets can be locked, guaranteeing that certain Managers can change only the appropriate information.

SalaryXL can provide Integrated Messaging and Notification so that Mangers can be notified via email when new tasks arrive. Messages within SalaryXL contain the relevant salary reviews, with no need to go searching. Further features include Any Number of Groups—Employees can be segmented into any number of groups, and Multiple Increase Components—Supports up to 5 increase components and associated budgets. Via the Excel-Centric architecture, one easily implement custom business rules for functionality including Min and Max salary ranges for job codes, Increase to minimum before applying increases, Prorated salary calculations based on employment date, and Unique display of routing information and salary history. Still further features include Batch Generation—Generate any or all spreadsheets in Batch and automatically email them to the appropriate managers, and Email Interface—Allows managers to submit reviews via email.

SalaryXL employs Net technology, allowing one to fully leverage the Microsoft Platform. Virtually all HRMS systems can be accommodated. Supporting databases for salary planning data can reside in Oracle or SQL server. Both premise-based and hosted models are available.

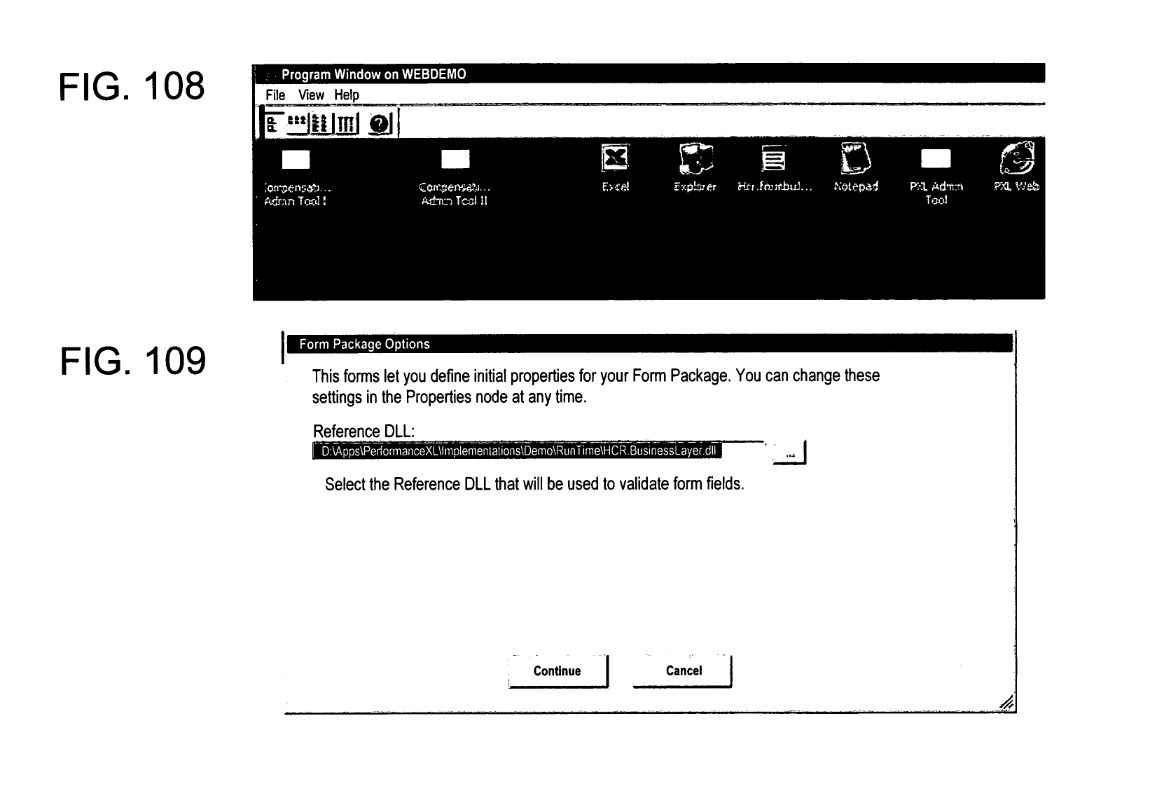

Although the exemplary embodiments have been mostly described with respect to salary or compensation planning, the exemplary embodiments can be employed for performance management (also referred to as PerformanceXL), as will be appreciated by those skilled in the relevant art(s). For example, FIG. 108 illustrates an exemplary system for salary planning or performance management, according to further exemplary embodiments of the present invention. Accordingly, the exemplary system of FIG. 108 operates in a manner similar to the exemplary system described with respect FIGS. 1-106. Common functionality between the exemplary systems will not be further described for the sake of brevity.

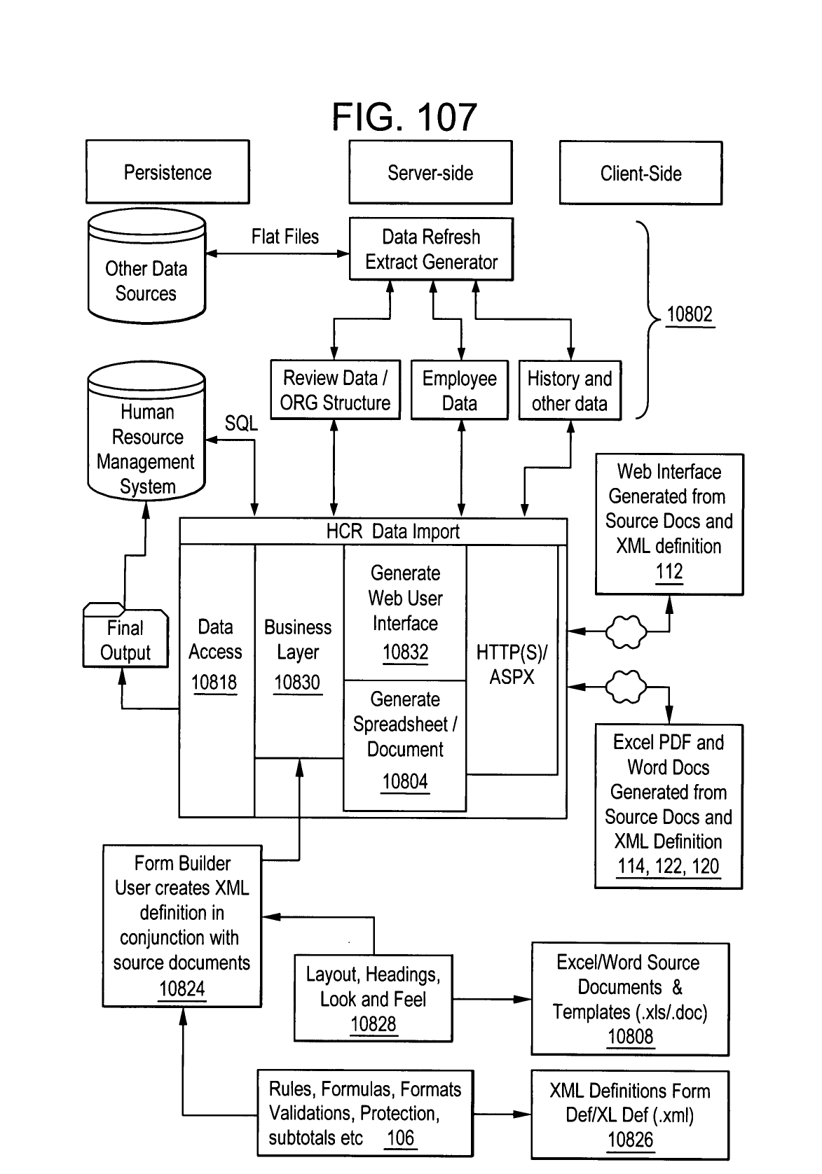

In FIG. 107, the exemplary system includes a subsystem 10802 that operates in a similar manner as described with respect to subsystem 102 of FIG. 1 and including review data/ORG structure, employee data, and history and other data importing components. In addition, provided are a data access component 10818, business layer component 10830, web user interface generation component 10832, spreadsheet and word processor document generation component 10804, and a form builder component 10824. The form builder component 10824 can employ the layout, headings, and look and feel 10828 of source spreadsheet and word processor documents 10808, along with rules, formulas, formats, validations, protections, subtotals, etc., 106 and XML definitions form 10826.

The form builder component 10824 allows users to take existing documents that companies are using for Performance management and other purposes and utilize them via the PerformanceXL embodiments. The user indicates areas of interest and maps them into the PerformanceXL database. Further attributes can be defined to modify the look and feel and provide additional functionality by utilizing work flows and Competencies (e.g., Data Templates) that you can define within the exemplary system by creating scripts using .net code that can be linked to individual fields of forms. The result of this configuration is a Form definition (.PRT file) which can then be used to render the documents via html or PDF for online access or create downloadable MS word documents or MS Excel documents that can be downloaded and utilized offline and uploaded to the exemplary system at a later time. The format of MS Word or excel files that are downloaded are defined within the form package via an Excel Template (e.g., for MS Excel) or a Word formfield template (e.g., for MS Word). Cell references are use in Excel to determine where the information defined in the form definition is placed. Similarly, Bookmarks in the Word form field template are used for the same purpose for Word. The overall look and feel of online and downloaded forms is determined by the source document. This is the initial Word or Excel document that is pulled into the form builder component 10824 in the process described below. Changes to the source document will automatically appear in all online forms. Further, HTML can be generated automatically from the MS Word document so that the online version of the document closely mimics the original source document.

In an exemplary embodiment, the form builder component 10824 can be accused, for example, by a Log in to the web site of the exemplary system and performance of the following steps:

1. Double click on HCRFormBuilder icon (see FIG. 108).

2. Open file, for example:

D:\Apps\PerformanceXL\Implementations\Demo\Templates

3. Open appropriate Word document.

4. Save As a .PRT file.

5. The user is then prompted to select the Reference DLL file that will be used to validate the form fields using the PerformanceXL Business Layer 10830 (see FIGS. 107 and 109).

6. Apply the most recent DLL file (Business Layer), for example:

D:\Apps\PerformanceXL\Implementations\Demo\bin\HCRBusinessLayer.dll

7. Open the saved .PRT file.

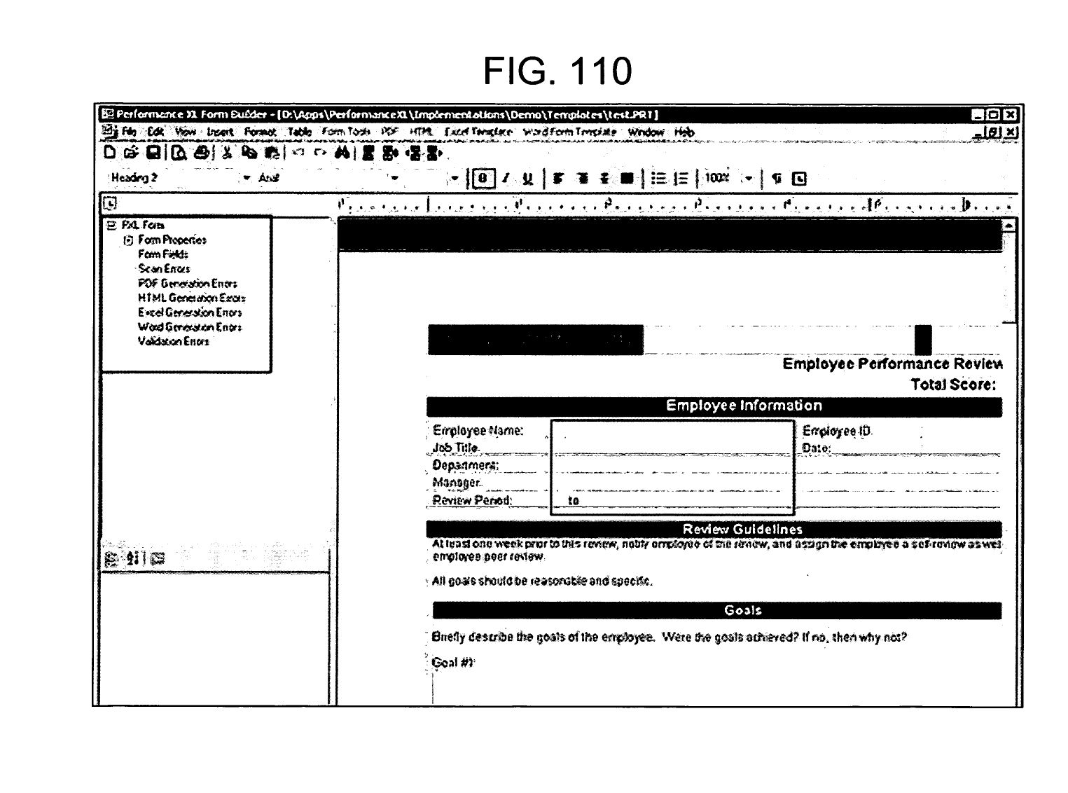

The FormBuilder opens the .PRT file in form builder mode, and displays the Form Tree on the left and the actual form for editing on the right (see FIG. 110).

The form is ready for formatting.

Entering Field Tags

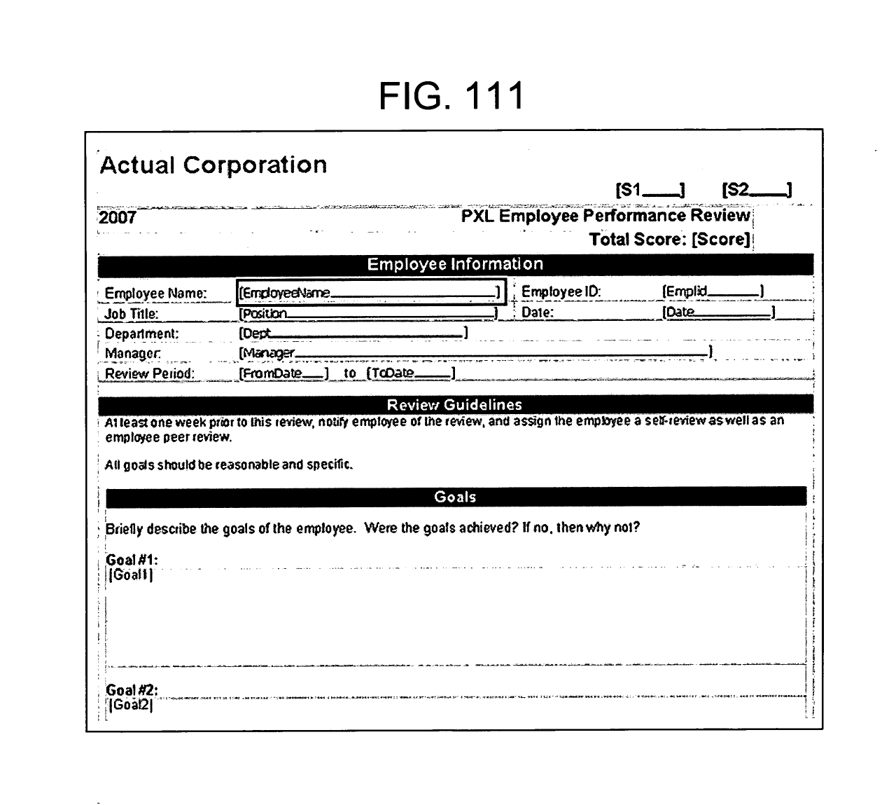

Manually insert tags into the document for each field in the form. The tags must be enclosed in square brackets ([ ]) and should be named corresponding to the selected field name. For example, for field name ‘Employee Name’ the tag should be entered into the form as ‘[EmployeeName______]’ where the extra spaces or other suitable methods can be used to allow for field expansion. The example shown in FIG. 111 displays how the form looks after tags are inserted for each field name. Each tag identifier must be unique. No form can have more than one tag with the same tag name.

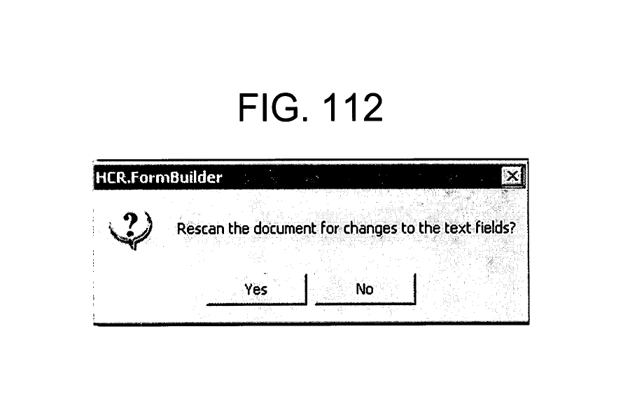

After tags have been inserted into the form, select F2. A pop-up appears asking whether the user wants to rescan the document for changes to text fields. Select ‘YES’ to scan the document (see FIG. 112). ‘Update Field Positions (Rescan Document for Tags)’ can also be accessed by selecting ‘Form Tools’ from the Form Builder toolbar.

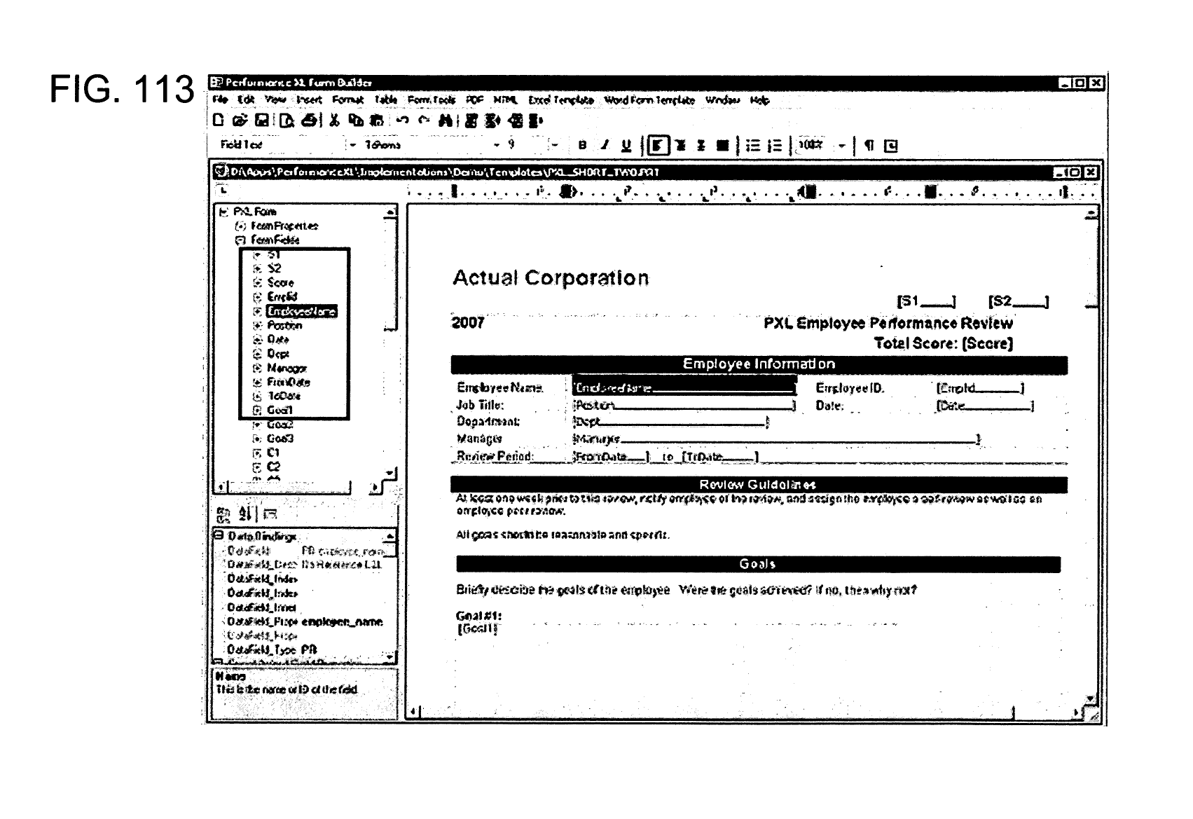

All tags that have been inserted, now appear as Form Fields in the Form Tree (see FIG. 113).

Defining Form Field Definitions

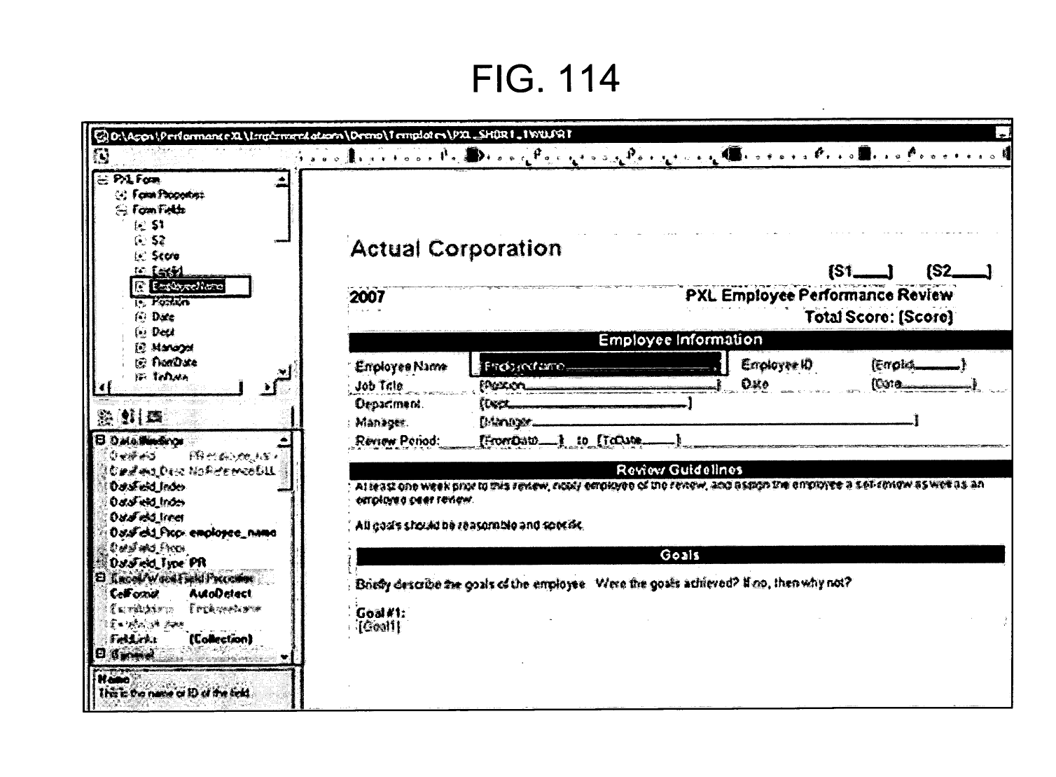

Click on a Field Name to define the field's attributes, such as Data Binding, Excel/Word Field Properties, General, HTML Field Properties, PDF Field Properties, Scripts, and Source Document Properties (see FIG. 114). There are default definitions set up for each field when the form is generated. In many cases the defaults are not edited, particularly for the HTML Field Properties, PDF Field Properties, Scripts and Source Document Properties fields.

The first items to define for a field are the DataField_Type and the DataField_Property (see FIG. 115).

The DataField_Type and DataField_Property fields are extracted from the Reference DLL. The pull-down displays the list of definitions for each DataField. Each DataField_Type displays its own set of DataField_Property fields. The DataField_Property fields in the pull-down may not match the tag created for the specific field. For example, the tag [JobTitle] on the form may appear in the DataField_Property as ‘Title’. Choose the most relevant field name. If the Reference DLL has not been defined, then no definitions will appear in the pull-down. The Reference DLL can also be defined under Form Properties if not applied when creating the .PRT file.

Typically, a form will contain three different DataField_Types:

PR=Performance Review Object

PRCompetency=Single Competency Object

PRGoal=Career Goal Object

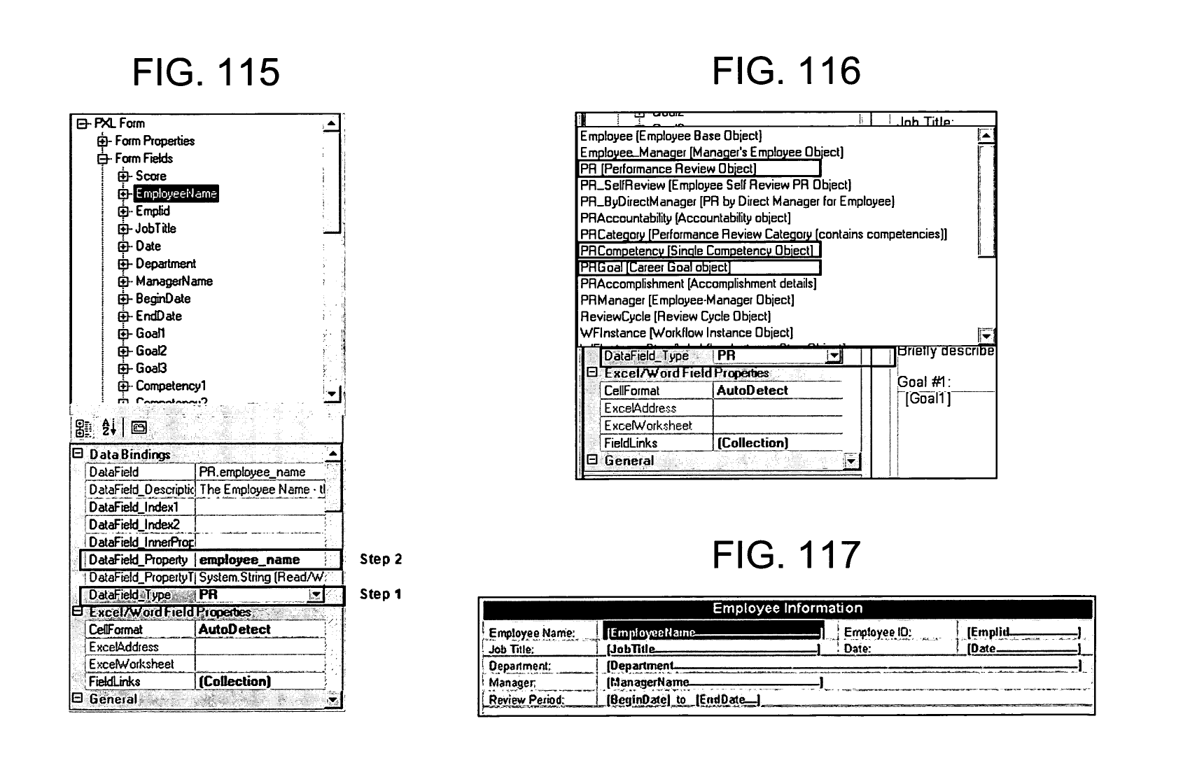

As shown in FIG. 116, use the pull-down to select the appropriate DataField_Type.

PRObject

The DataField_Type=‘PR’ references a general Performance Review Object, such as any of the fields found in the Employee Information section of the form (see FIG. 117).

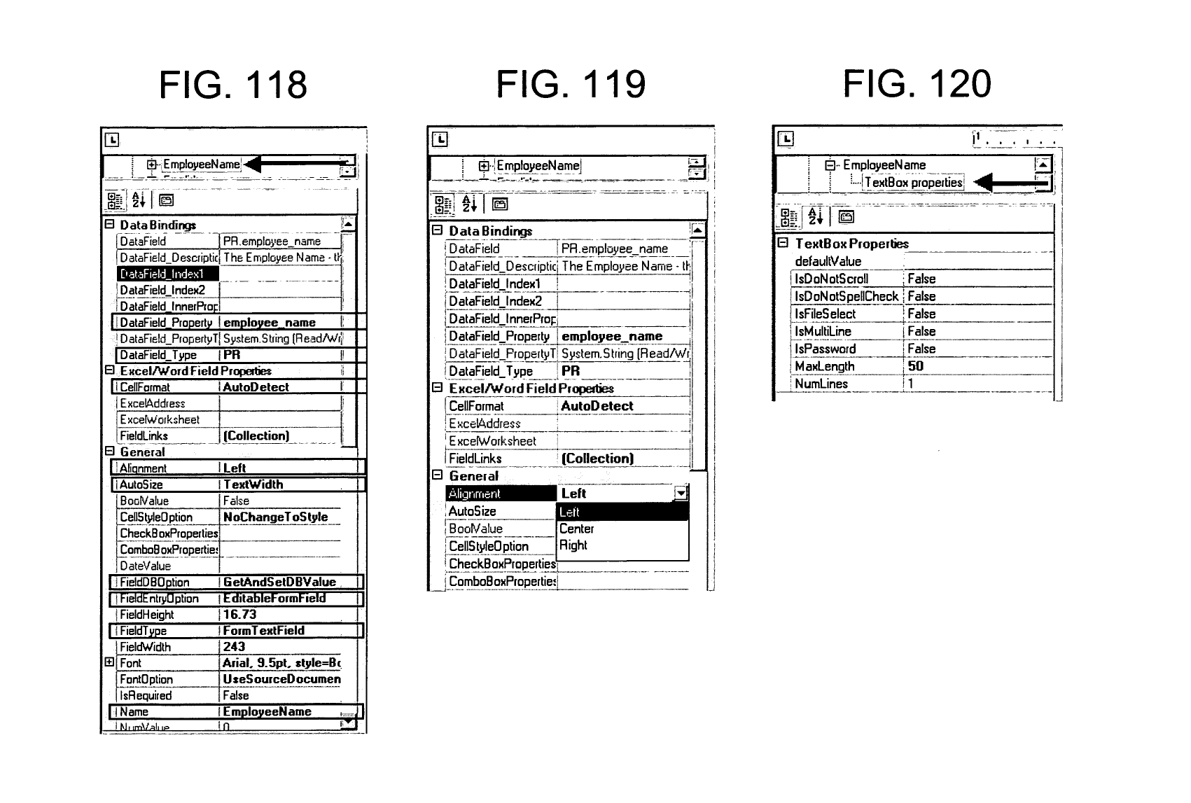

All PR fields will typically be defined as shown in FIG. 118. Using [EmployeeName] as a generic example, the field definitions would be set up as follows.

All of these field definitions can use a pull-down. Therefore, if a user wanted to change the TextAlignment for this form field to ‘Left’, the user selects the appropriate definition from the pull-down (see FIG. 119).

As shown in FIG. 120, the FieldType has been defined as ‘FormTextField’. Therefore, the TextBox Properties need to be defined. The default values, as shown in FIG. 120, typically meet the needed criteria.

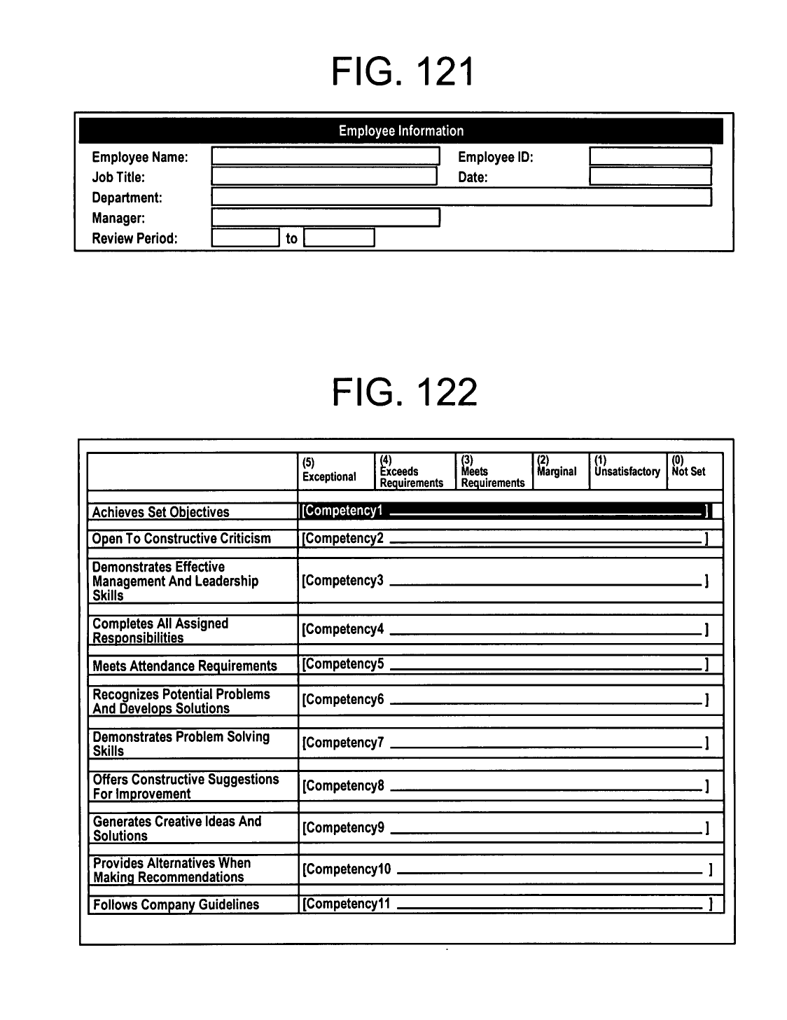

At any time, after the form fields have been created and defined the user can hit F6 to ‘Generate Run Time Package’ and then F10 to ‘Generate PDF file’ to view the completed form (see FIG. 121). ‘Generate Run-Time Package’ can also be accessed by selecting ‘Form Tools’ on the Form Builder toolbar; and, ‘Generate PDF file by Role’ can be accessed by selecting ‘PDF’ on the toolbar. Similar functions are available to generate and view results in HTML, MS Word, MS Excel, and the like, formats.

PRCompetency

The DataField_Type=‘PRCompetency’ references a Single Competency Object as defined by the user via a Data Template. A performance rating, or score, is typically assigned to each competency. The rating can be entered either manually or selected via radio button, check boxes, combo list, etc.

As shown in FIG. 122, for example, there are 11 competencies, and each competency has five possible ratings, where:

5=Exceptional

4=Exceeds Requirements

3=Meets Requirements

2=Marginal

1=Unsatisfactory

0=Not Set

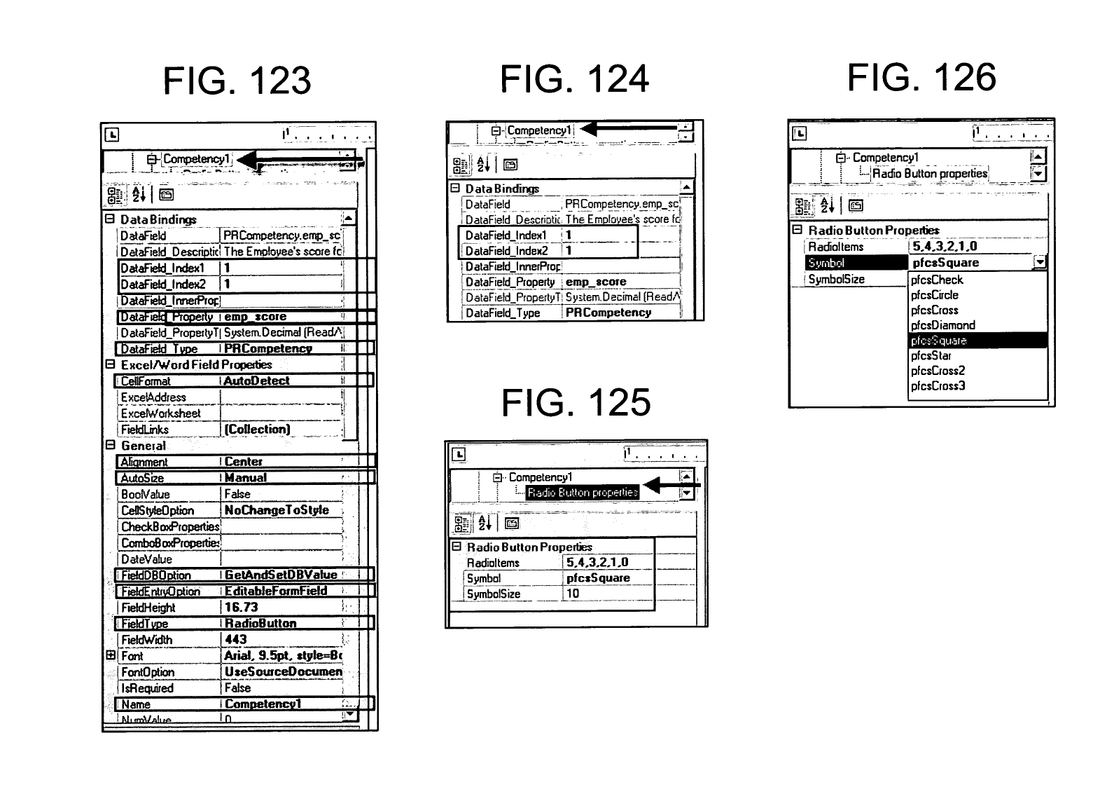

In this example, each PRCompetency is defined so that the user will choose the appropriate rating for the competency by selecting a radio button. The field definitions are shown in FIG. 123.

For a form with multiple competencies, further Data Bindings must be defined, specifically the DataField_Index1 and DataField_Index2 fields. Since the DataField_Property is the same for all competencies, e.g., emp_score, the DataField_Index definitions define the placement of the competencies in relation to the form and one another (see FIG. 124).

Therefore, [Competency1] is defined as follows:

DataField_Index1=1

DataField_Index2=1

[Competency2] is defined as follows:

DataField_Index1=1

DataField_Index2=2

[Competency3] is defined as follows:

DataField_Index1=1

DataField_Index2=3; etc.

If there were another set of competencies, then the DataField_Index1 field would be defined as ‘2’ and the first competency would be defined where DataField_Index2=1, etc.

As shown in FIG. 125, the FieldType has been defined as ‘RadioButton’. Therefore, the Radio Button Properties need to be defined (see FIG. 126). For each radio button, the ratings must be defined as they appear on the form, e.g., 5, 4, 3, 2, 1, 0. In addition, the radio button symbol and size must be selected (see FIG. 126).

At any time, after the form fields have been created and defined the user can hit F6 to ‘Generate Run Time Package’ and then F10 to ‘Generate PDF file’ to view the completed form. Similar functions are available to generate and view results in HTML, MS Word, MS Excel, and the like, formats.

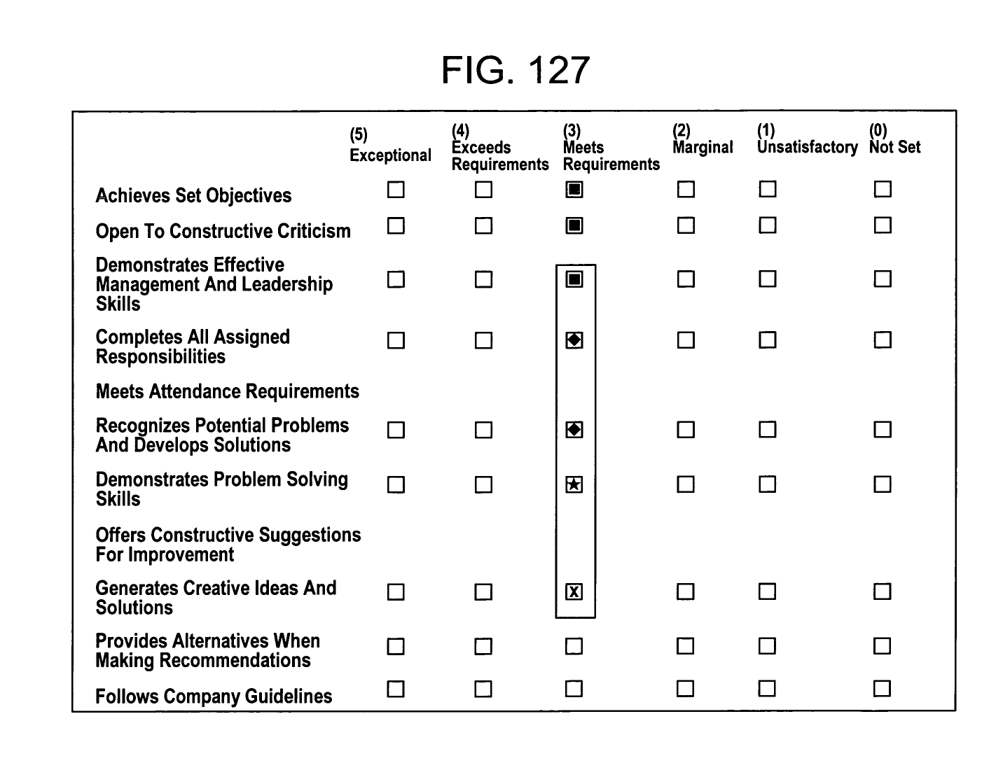

For exemplary purposes only, different radio button symbols were used for defining the competencies, as shown in FIG. 127.

The PRGoal Object is used as an example. Elements can also be defined in terms of Performance Review information, Employee Base information, Manager Information, Competencies, Competency categories, accountabilities, Employee self review information, Accomplishments, and the like. All the properties described below are for exemplary purposes only, as various other properties and options for each property can be employed, as will be appreciated by those skilled in the relevant art(s).

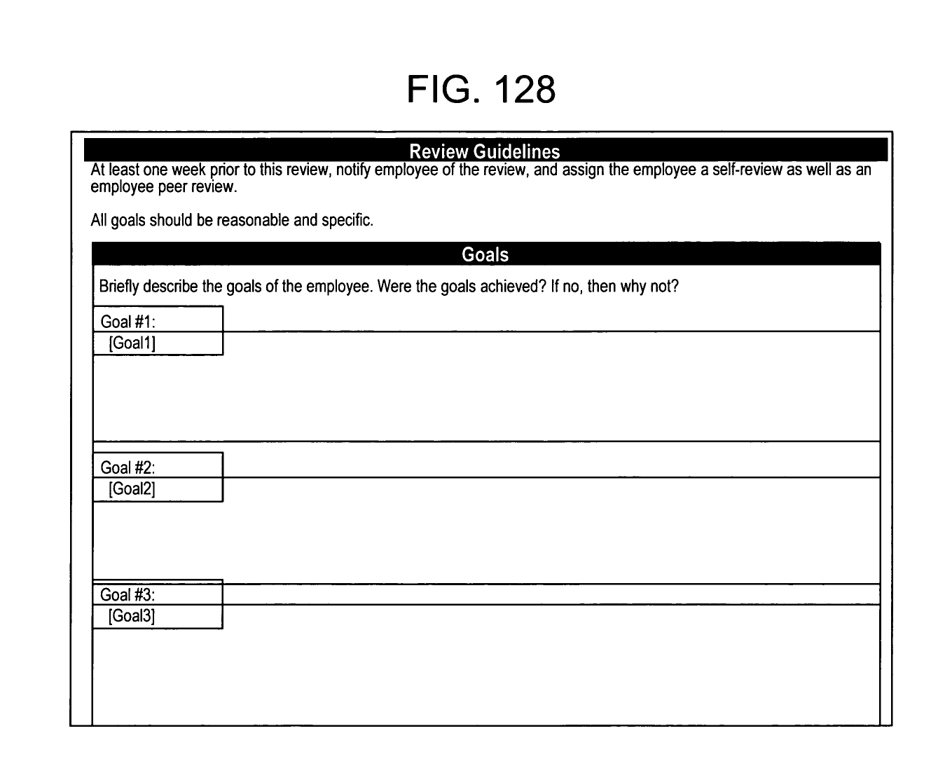

The DataField_Type=‘PRGoal’ references a Career Goal Object. Each Goal in the form needs to be separately defined (see FIG. 128).

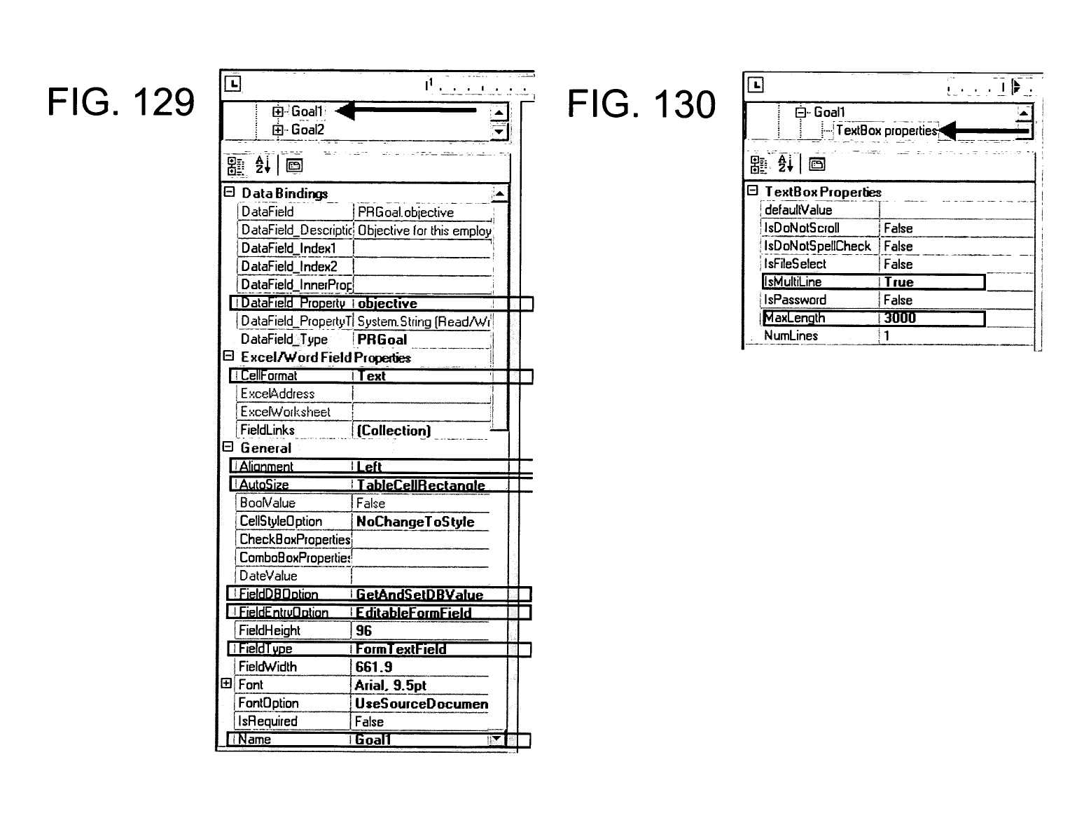

Using [Goal 1] as an example, the field definitions would be set up as shown in FIG. 129. As shown in FIG. 129, the AutoSize field has been set to ‘TableCellRectangle’ to accommodate multiple lines of input. In the same manner, FieldType has been defined as ‘FormTextField’ and the TextBox Properties are defined where the ‘IsMultiLine’ property is set to ‘True’ and the ‘MaxLength’ property is set to accept up to 3,000 characters (see FIG. 130).

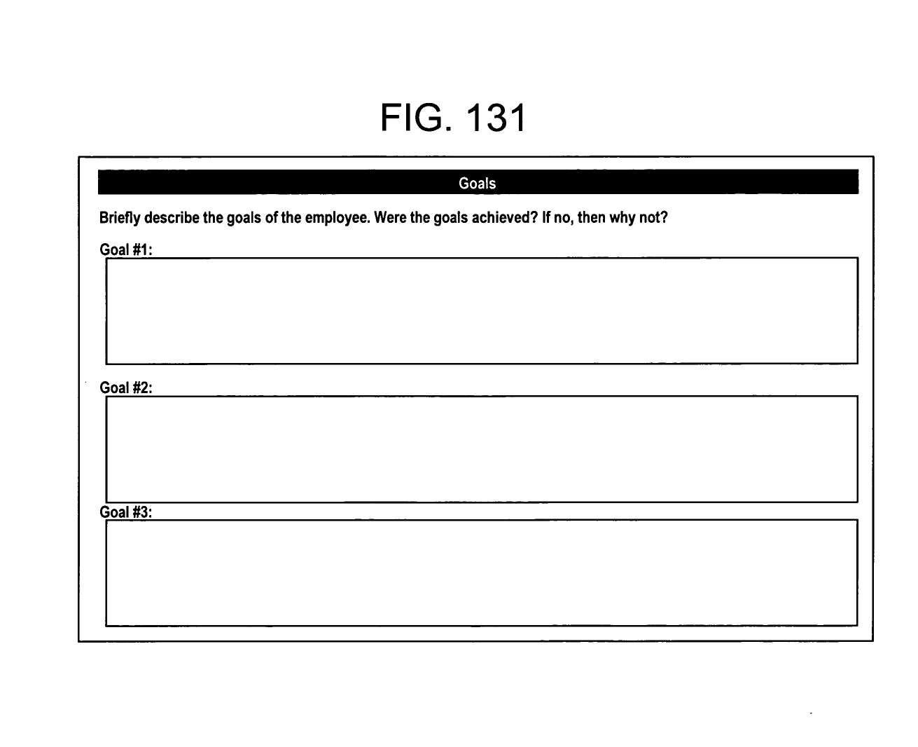

At any time, after the form fields have been created and defined the user can hit F6 to ‘Generate Run Time Package’ and then F10 to ‘Generate PDF file’ to view the completed form (see FIG. 131). ‘Generate Run Time Package’ can also be accessed by selecting ‘Form Tools’ on the Form Builder toolbar; and, ‘Generate PDF file by Role’ can be accessed by selecting ‘PDF’ on the toolbar. Similar functions are available to generate and view results in HTML, MS Word, MS Excel, and the like, formats.

Additional Comments

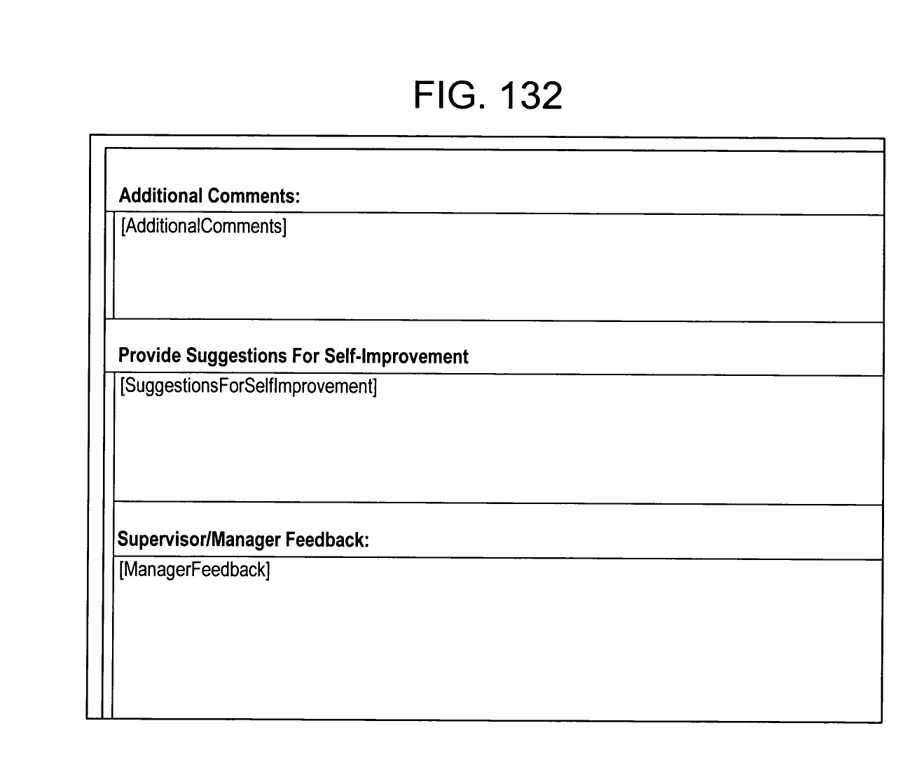

Typically there is a section on any given form for Additional Comments, Manager Feedback, etc., as shown in FIG. 132.

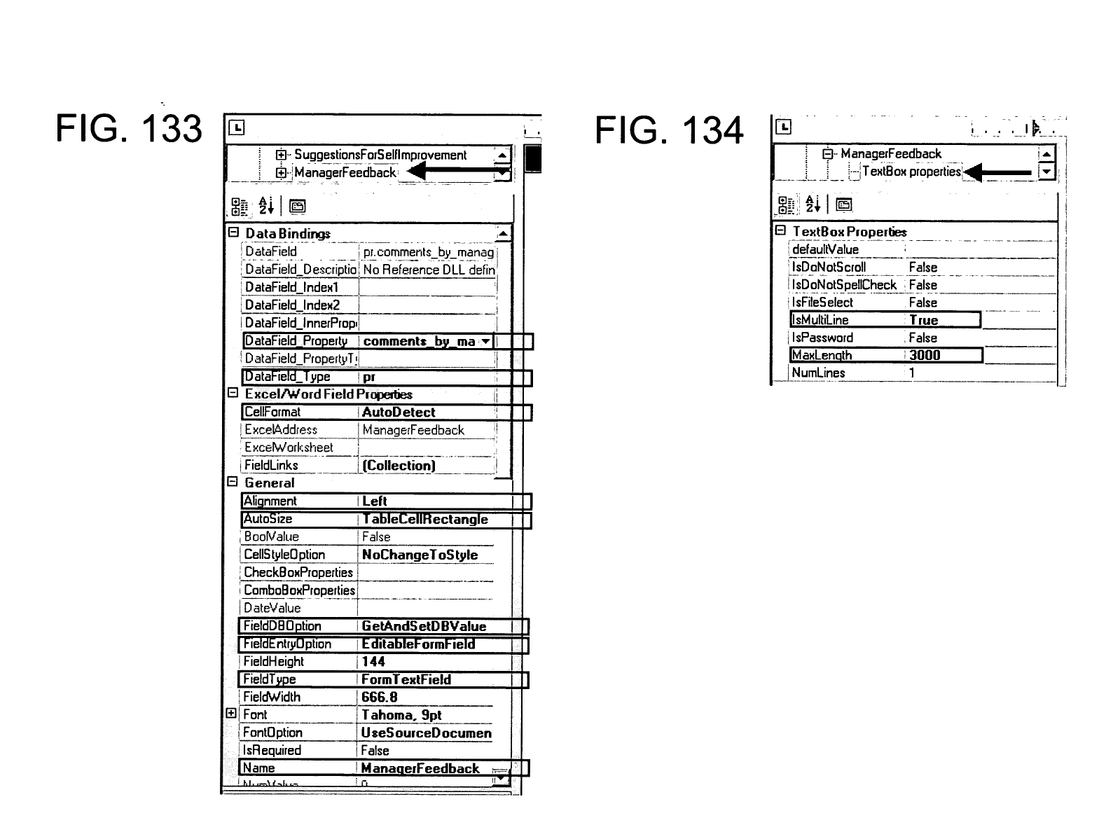

Using [ManagerFeedback] as an example, the field definitions would be set up as shown in FIG. 133. The above is a good example of where the tag created [ManagerName] is different than the DataField_Property=‘comments_by_manager’ label as extracted from the Reference DLL, although both refer to the same form field.

As shown in FIG. 133, [ManagerName] is a Performance Review Object (PR). Most of the field definitions will be the same as those indicated in the Employee Information section; however, there are a few differences.

The AutoSize field has been set to ‘TableCellRectangle’ to accommodate multiple lines of input. In the same manner, FieldType has been defined as ‘FormTextField’ and the TextBox Properties are defined where the ‘IsMultiLine’ property is set to ‘True’ and the ‘MaxLength’ property is set to accept up to 3,000 characters (see FIG. 134).

At any time, after the form fields have been created and defined the user can hit F6 to ‘Generate Run Time Package’ and then F10 to ‘Generate PDF file’ to view the completed form (see FIG. 135). ‘Generate Run Time Package’ can also be accessed by selecting ‘Form Tools’ on the Form Builder toolbar; and, ‘Generate PDF file by Role’ can be accessed by selecting ‘PDF’ on the toolbar. Similar functions are available to generate and view results in HTML, MS Word, MS Excel, and the like, formats.

Signatures

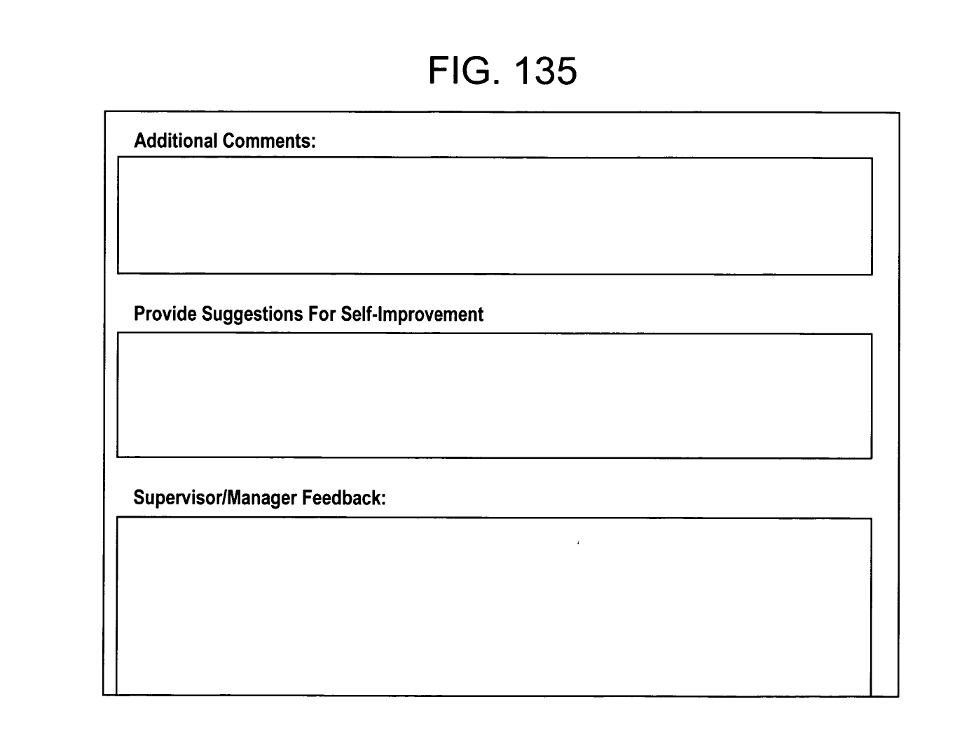

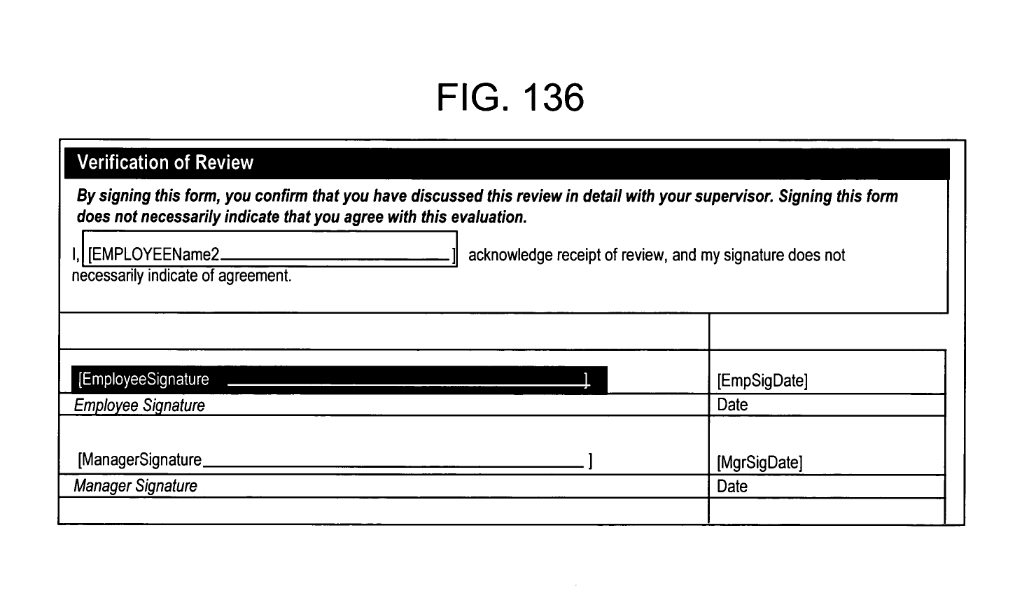

A typical signature page for a form has fields for Name and Date, as shown in FIG. 136. As shown in FIG. 136, there is an insert field in the form for the Employee Name. Since each tag must be unique, [EmployeeName2] is used to differentiate from the tag in the Employee Information section. Although the tag name must be different, the DataField_Property will be the same for both [EmployeeName] and [EmployeeName2] since they refer to the same ‘employee_name’ field in the Reference DLL file.

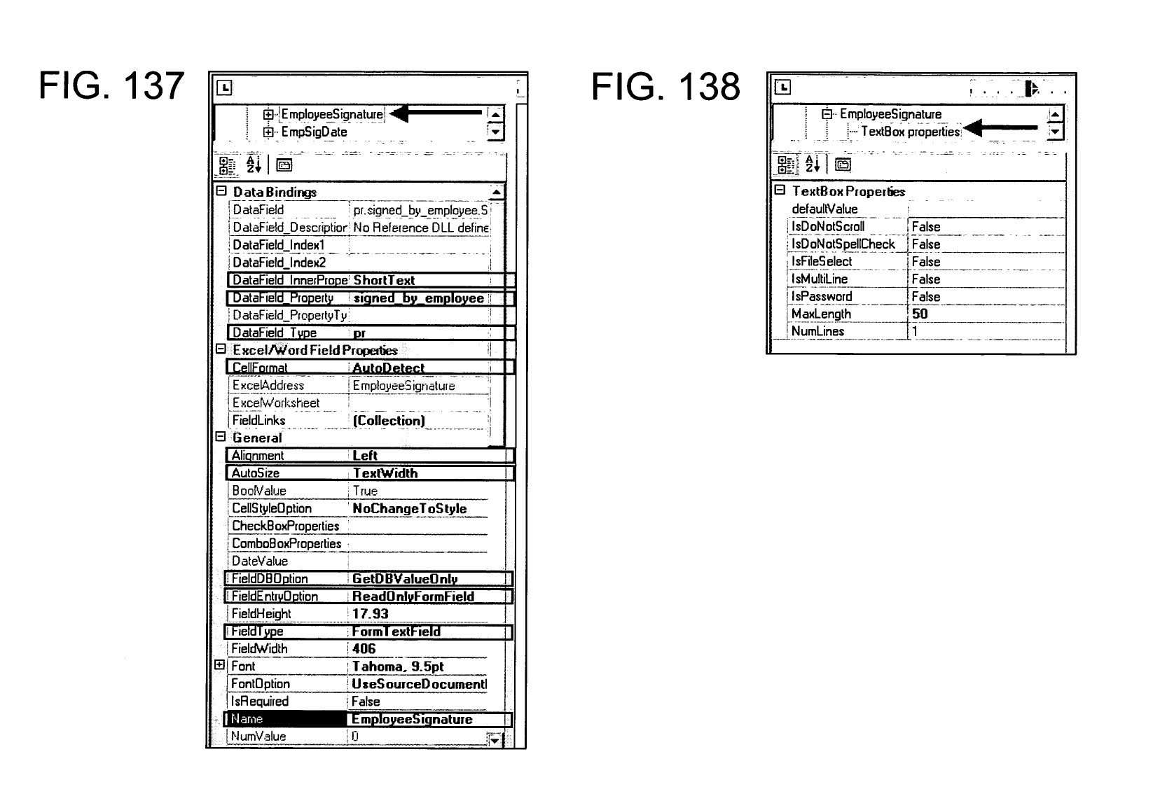

Using [EmployeeSignature] as an example, the field definitions would be set up as shown in FIG. 137. As shown in FIG. 137, [EmployeeSignature] is a Performance Review Object (PR). Most of the field definitions will be the same as those indicated in the Employee Information section; however, there are a few differences.

The DataField_Property for [EmployeeSignature] is ‘signed_by_employee’, which is the same definition assigned to [EmpSigDate]. Therefore, the DataField_InnerProperty field is used to distinguish between the signature and the date signed.

[EmployeeSignature] is defined as:

DataField_InnerProperty=ShortText (defining a Text field)

DataField_Property=signed_by_employee

DataField_Type=PR

[EmpSigDate] is defined as:

DataField_InnerProperty=Signed_Date (defining a Date field)

DataField_Property=signed_by_employee

DataField_Type=PR

In addition, for all signature and date fields the FieldDBOption is set to ‘GetDBValueOnly’ and the FieldEntryOption is set to ‘ReadOnlyFormField’.

The TextBox Properties for the signature and date fields are the same as for typical PR fields (see FIG. 138).

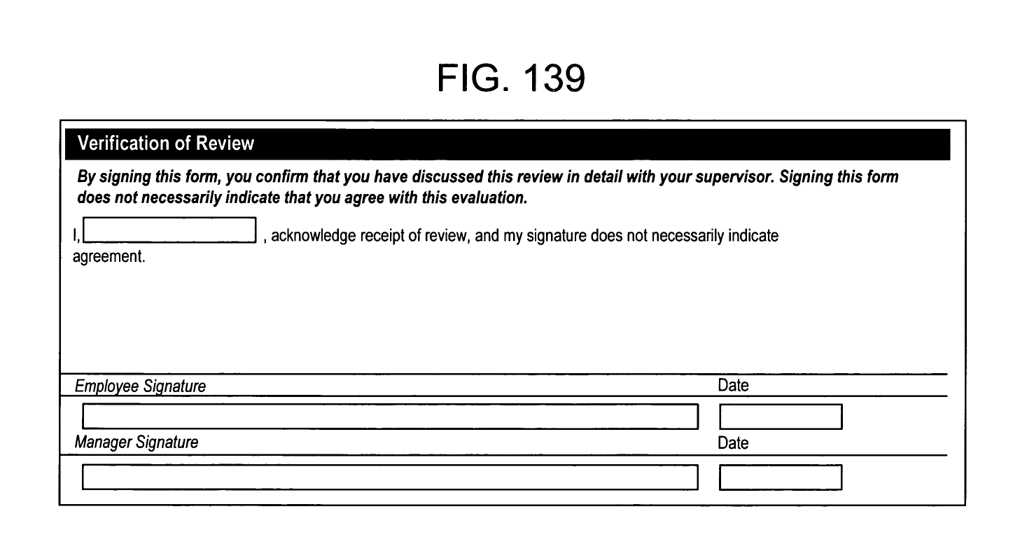

At any time, after the form fields have been created and defined the user can hit F6 to ‘Generate Run Time Package’ and then F10 to ‘Generate PDF file’ to view the completed form (see FIG. 139). ‘Generate Run Time Package’ can also be accessed by selecting ‘Form Tools’ on the Form Builder toolbar; and, ‘Generate PDF file by Role’ can be accessed by selecting ‘PDF’ on the toolbar. Similar functions are available to generate and view results in HTML, MS Word, MS Excel, and the like, formats.

Overall Score

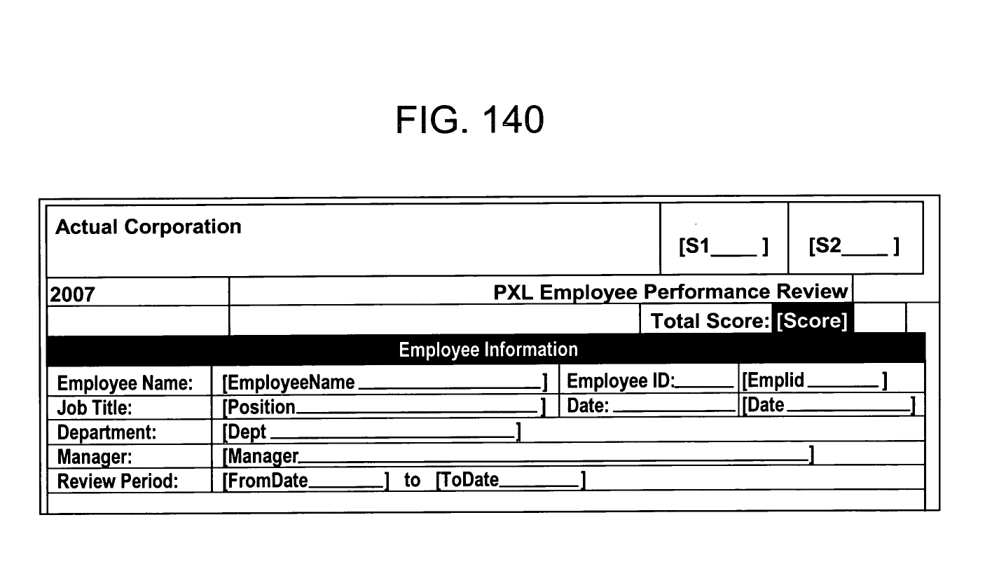

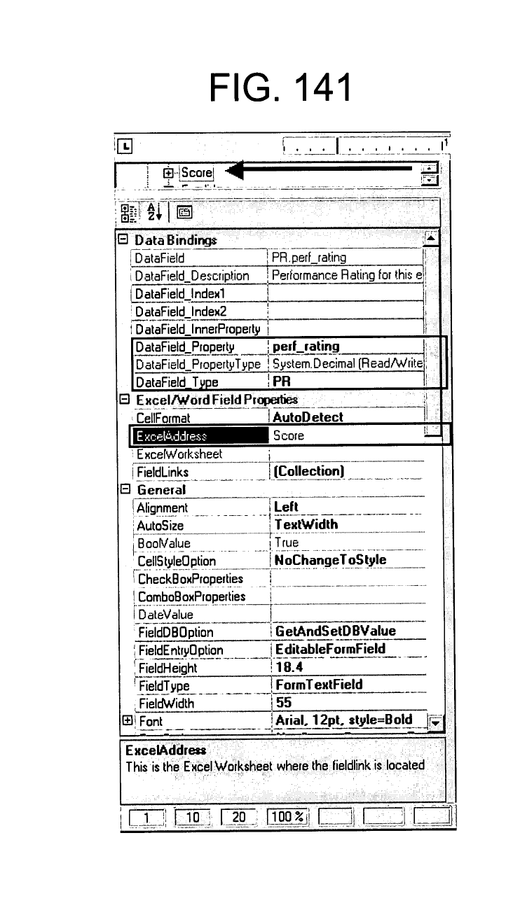

The Overall Score is typically either a weighted or unweighted average of the performance ratings for each competency and is defined by an Excel calculation (see FIG. 140). As shown in FIG. 140, [Score] is a Performance Review Object (PR). Most of the field definitions will be the same as those indicated in the Employee Information section; however, there are a few differences (see FIG. 141).

The DataField_PropertyType is set to ‘System.Decimal (Read/Write)’ and the ExcelAddress field indicates the referencing Excel document labeled ‘Score’ where the calculation is stored. At any time, after the form fields have been created and defined the user can hit F6 to ‘Generate Run Time Package’ and then F10 to ‘Generate PDF file’ to view the completed form. ‘Generate Run Time Package’ can also be accessed by selecting ‘Form Tools’ on the Form Builder toolbar; and, ‘Generate PDF file by Role’ can be accessed by selecting ‘PDF’ on the toolbar. Similar functions are available to generate and view results in HTML, MS Word, MS Excel, and the like, formats.

Submit/Save

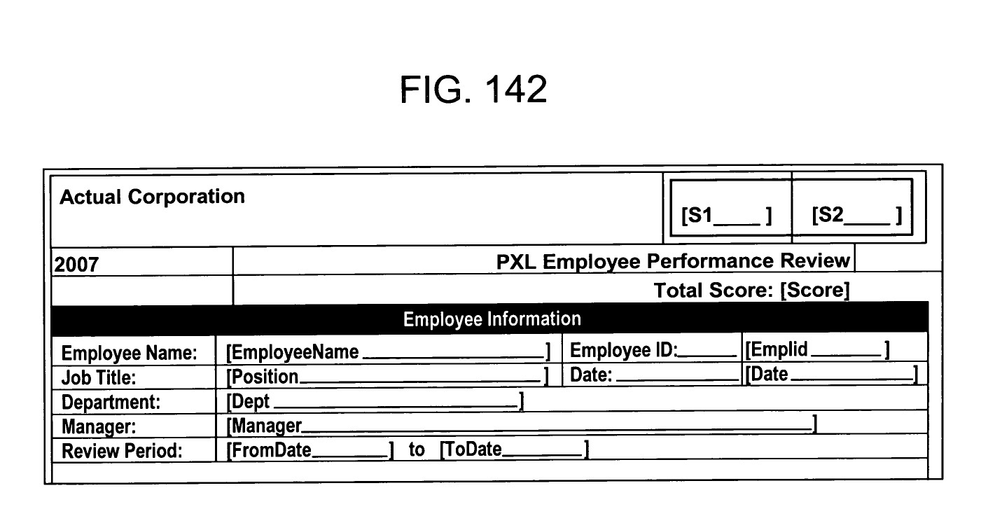

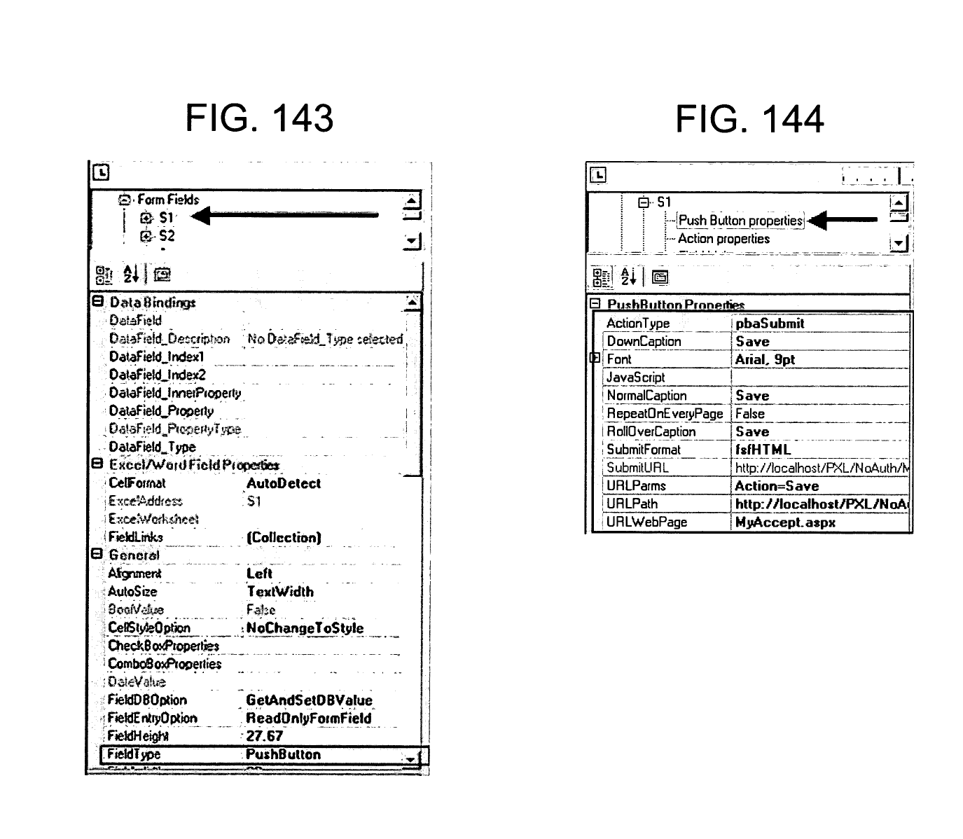

The [S1] and [S2] tags on the form define ‘Submit’ and ‘Save’ push buttons which allow the completed form to move up in the approval process (see FIG. 142). There is no DataField_Type or DataField_Property assigned to [S1] and [S2] tags as they don't reference a field name, rather a function the form is to perform. A push button is created by setting FieldType to ‘PushButton’ as shown in FIG. 143.

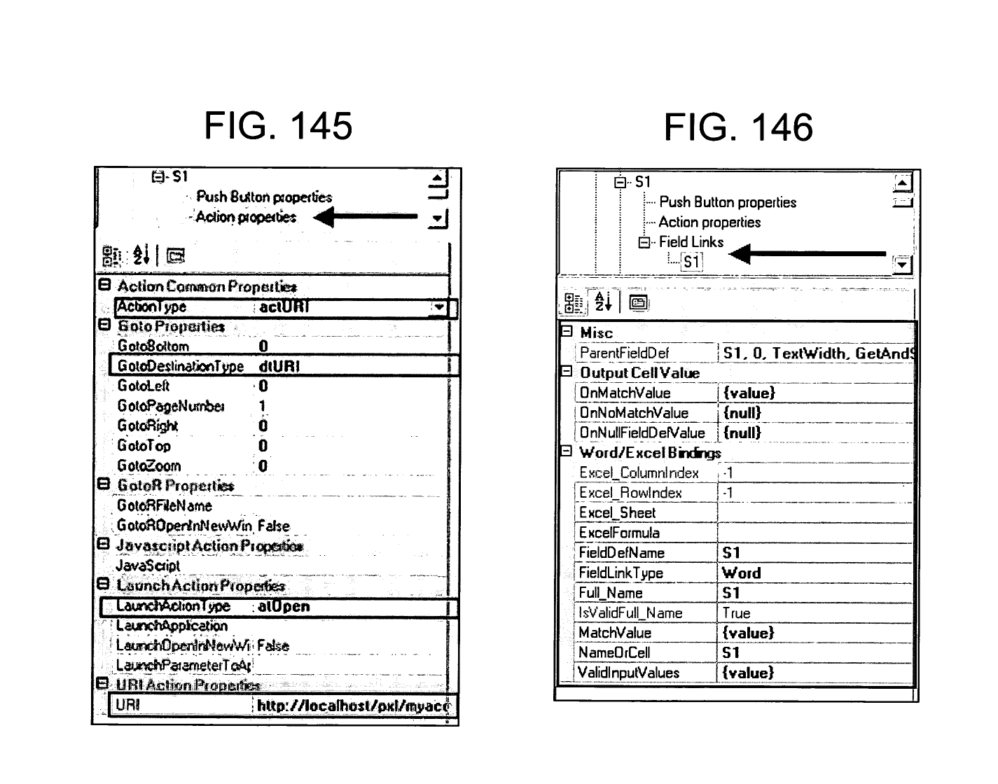

The Push Button Properties are then further defined to indicate how the button should function and be formatted (see FIG. 144). Also assigned to a Push Button are Action Properties which indicate what action is to take place when the button is launched (see FIG. 145). The Field Links assigned to the Push Button are typically auto generated (see FIG. 146).

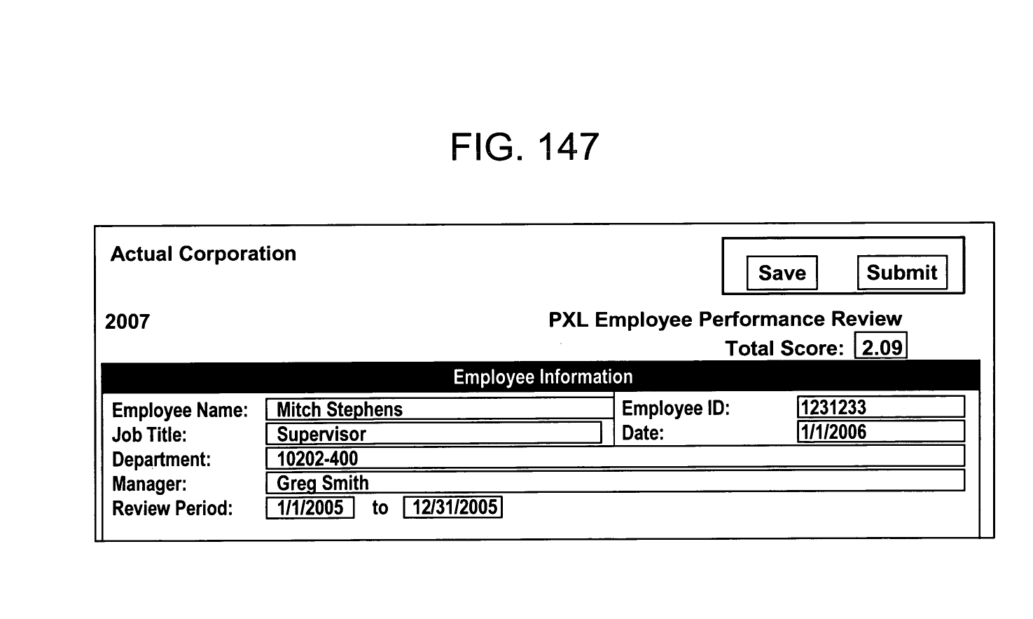

At any time, after the form fields have been created and defined the user can hit F6 to ‘Generate Run Time Package’ and then F10 to ‘Generate PDF file’ to view the completed form (see FIG. 147). ‘Generate Run Time Package’ can also be accessed by selecting ‘Form Tools’ on the Form Builder toolbar; and, ‘Generate PDF file by Role’ can be accessed by selecting ‘PDF’ on the toolbar. Similar functions are available to generate and view results in HTML, MS Word, MS Excel, and the like, formats.

Thus, PerformanceXL provides performance management allowing you to get rid of your paper-based performance evaluation process and replace it with a high powered web-based solution that is customized to meet your specific requirements. Features of PerformanceXL include Create sophisticated custom performance appraisals to replace your paper-based system, Allow managers and employees to work online or offline, HR can monitor the process in-flight to control and manage, Use powerful customized Reporting to keep a tight grip on the process, Generate and print custom, polished Word documents, For focal and anniversary review cycles, and Easy to use.

Via PerformanceXL's simple, highly customizable web-based interface, managers and their subordinates can complete the performance review process in short order, dramatically improving productivity for Managers, Employees, and HR. PerformanceXL's architecture allows you to not only customize your performance appraisal process for your organization, but to tailor it to individual groups of employees as well. Further features of PerformanceXL including Pull competencies, goals and objectives, and development and action plans from your HRMS system, configure them within PerformanceXL or allow employees and managers to enter appropriated information. Using PerformanceXL's unique template based approach; it's completely up to you.

PerformanceXL provides Delivered Performance appraisal solutions that exhibit your own look and feel and can be customized by design, including navigational and visual models that completely match your corporate standards. PerformanceXL fully supports bi-directional integration to your ADP Enterprise, HRizon, Lawson or PeopleSoft HRMS. If these components are not populated in your HRMS; PerformanceXL will act as your repository for performance appraisal data. With PerformanceXL, Managers and employees complete reviews in no time. Using PerformanceXL's Admin tool, HR can monitor the entire process at the individual review level as well as more globally via our powerful custom reporting facility.

PerformanceXL provides Workflow and Notification, including a

Unique Approach to Organizational Structure. Organizations are often far more complicated then they are spelled out in your HRMS. Dotted line reporting, managers wearing multiple hats and other common organizational anomalies can twist your “Reports To” tree into a pretzel. PerformanceXL's organization approach allows you to Specify a unique approval path for every employee in your organization, Add managers, and Allow managers to stand in for other managers. You can sculpt your organization—make it perfect for your performance appraisal.

PerformanceXL provides Integrated Messaging and Notification—Mangers can be notified via email when new tasks arrive. Messages within the PerformanceXL tool contain the relevant Appraisal. No need to go searching. Also PerformaceXL will automatically inform you and react to transfers, terminations, job changes and other relevant HR events.

PerformanceXL employs Net technology, fully leveraging the Microsoft Platform. Virtually all HRMS systems can be accommodated. Supporting databases for Performance Appraisal data can reside in Oracle or SQL server. Premise-based and hosted models are available.

PerformanceXL's unique ability to utilize existing Microsoft Office applications provides HR and managers with an integrated web-based approach to performance management, along with sophisticated real-time reporting that enables them to manage and complete the process more rapidly and with fewer hurdles along the way. PerformanceXL uses an online interface and also permits managers to download their work into Word or Excel to provide offline access at home or while commuting or traveling. PerformanceXL's key features include cascading goals and objectives, key job responsibilities, competencies, development plans, messaging and notification, e-signatures and automation of all performance review process forms. HCR Software Solution's implementation process guides each client through a thorough analysis of current workflows, offering recommendations based on best practices and ongoing post-implementation support, to ensure the client's complete understanding and optimal use of the PerformanceXL's software functionality.

Thus, the exemplary embodiments provide automated compensation planning and performance management, for example, employing Excel spreadsheets and Word documents, and the like, advantageously, overcoming problems with entirely Web-based applications, which require a major undertaking of implementing a new enterprise software “suite.” Beyond implementations that can take years, user adoption is a major challenge, requiring training and continual “police” actions by HR with such conventional entirely Web-based applications and systems. The exemplary embodiments, however, provide a novel approach to compensation and performance management software by leveraging, for example, Excel spreadsheets and Word documents that organizations already know and use productively every day. Accordingly, the exemplary embodiments provide the following advantages Leverage your existing Excel spreadsheets and Word docs in a robust web-based solution, Quickly attain 100% user adoption, Focus on pay-for-performance, not a brand new software application, Reduce errors and ensure Sarbanes-Oxley compliance, Implement in 4-8 weeks, and Realize rapid, measurable ROI.

Accordingly, the exemplary embodiments provide solutions around familiar, powerful, and widely used applications, such as Microsoft Excel for compensation management and Microsoft Word for performance management. Advantageously, existing worksheets and forms can be employed and taken to the next level by integrating best practices to provide powerful intelligence for managers and improve the processes. Anything that one can do in Excel and Word can be done with the exemplary embodiments and without custom programming, resulting in ease of implementation.

With this foundation, a robust web-based solution with a database backend, flexible workflow, powerful organizational management, HRIS integration, and reporting is provided and with a familiar Microsoft Excel or Word interface, and with the option of working online or offline. Advantageously, this reduces user adoption, training, and compliance challenges to nearly zero. By contrast, conventional and immense talent management “suites” require users to learn a completely new, different and often confusing user interface, and forces adoption of new processes to work within such a framework.

For example, the SalaryXL or CompensationXL exemplary embodiments advantageously provide Web based operation—work online or offline, Salary, bonus, stock, commissions, Use of existing spreadsheets, Monitor manager status in real time, Real time budgets, Intuitive job and salary history display Integrate market data from any source, Flexible workflow, Hierarchy management, Flexible and powerful reporting, Advanced data analytics in Excel, Full integration with PerformanceXL provides powerful pay and performance solution.

Similarly, the PerformanceXL exemplary embodiments advantageously provide Web based operation—work online or offline, Automate all performance related forms, Monitor review status in real time, Competencies, goals, development plans, Matrix manager support, Integrated messaging and notification, Automated approvals and electronic signatures, Flexible workflow, Hierarchy management, Flexible and powerful reporting, Advanced data analytics in Excel, Available as premise based application or hosted application, Leverages existing process/culture, Rapid implementation time, Low Total Cost of Ownership, Rapid ROI, Leverages MS Word, PDF, HTML, and MS Excel as user interfaces, Minimal instruction required, Easily integrate existing forms without programming, Multiple interfaces, online and offline, Automate any HR paper based workflow, Easy to use Form Builder, Automated workflow, Handle “real world” events, Multiple forms with multiple workflows, Integrated Messaging, Automate familiar forms and processes, Easily track employees and managers through the performance process, Automatic reminders and notifications, Automated approvals and electronic signatures, Online and offline completion of tasks, Forms rendered to look like current documents, Ad hoc analysis via reports and Excel, Automatic routing, Manage performance during the year, Attach files relevant to performance, Electronic signatures, Control and monitor the process real time, Easily build forms and workflow, “Sees” the process through the eyes of any manager, Automated reminders, Establish organizational competencies, Company wide analytics, Built in Net, Supports Oracle, SQL Server, Premise or hosted delivery, Easy integration with HRMS and other data sources, and Fully integrated with SalaryXL or CompensationXL provides powerful pay and performance solution.

The above-described devices and subsystems of the exemplary embodiments can include, for example, any suitable clients, workstations, PCs, laptop computers, PDAs, Internet appliances, handheld devices, cellular telephones, wireless devices, other devices, and the like, according to the exemplary embodiments. The devices and subsystems of the exemplary embodiments can communicate with each other using any suitable protocol and can be implemented using one or more programmed computer systems or devices.

One or more interface mechanisms can be used with the exemplary embodiments, including, for example, Internet access, telecommunications in any suitable form (e.g., voice, modem, and the like), wireless communications media, and the like. For example, employed communications networks or links can include one or more wireless communications networks, cellular communications networks, G3 communications networks, Public Switched Telephone Network (PSTNs), Packet Data Networks (PDNs), the Internet, intranets, a combination thereof, and the like.

It is to be understood that the devices and subsystems of the exemplary embodiments are for exemplary purposes, as many variations of the specific hardware used to implement the exemplary embodiments are possible, as will be appreciated by those skilled in the relevant art(s). For example, the functionality of one or more of the devices and subsystems of the exemplary embodiments can be implemented via one or more programmed computer systems or devices.

To implement such variations as well as other variations, a single computer system can be programmed to perform the special purpose functions of one or more of the devices and subsystems of the exemplary embodiments. On the other hand, two or more programmed computer systems or devices can be substituted for any one of the devices and subsystems of the exemplary embodiments. Accordingly, principles and advantages of distributed processing, such as redundancy, replication, and the like, also can be implemented, as desired, to increase the robustness and performance of the devices and subsystems of the exemplary embodiments.

The devices and subsystems of the exemplary embodiments can store information relating to various processes described herein. This information can be stored in one or more memories, such as a hard disk, optical disk, magneto-optical disk, RAM, and the like, of the devices and subsystems of the exemplary embodiments. One or more databases of the devices and subsystems of the exemplary embodiments can store the information used to implement the exemplary embodiments of the present inventions. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases thereof.

All or a portion of the devices and subsystems of the exemplary embodiments can be conveniently implemented using one or more general purpose computer systems, microprocessors, digital signal processors, micro-controllers, and the like, programmed according to the teachings of the exemplary embodiments of the present inventions, as will be appreciated by those skilled in the computer and software arts. Appropriate software can be readily prepared by programmers of ordinary skill based on the teachings of the exemplary embodiments, as will be appreciated by those skilled in the software art. Further, the devices and subsystems of the exemplary embodiments can be implemented on the World Wide Web. In addition, the devices and subsystems of the exemplary embodiments can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware circuitry and/or software.

Stored on any one or on a combination of computer readable media, the exemplary embodiments of the present inventions can include software for controlling the devices and subsystems of the exemplary embodiments, for driving the devices and subsystems of the exemplary embodiments, for enabling the devices and subsystems of the exemplary embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the exemplary embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present inventions can be distributed for better performance, reliability, cost, and the like.

As stated above, the devices and subsystems of the exemplary embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present inventions have been described in connection with a number of exemplary embodiments, and implementations, the present inventions are not so limited, but rather cover various modifications, and equivalent arrangements, which fall within the purview of prospective claims.

What is claimed is:

1. A system for salary planning and performance management, the system comprising at least one of:
means for allowing documents used by organizations for salary planning, performance management, or other human resource (HR) processes to be used as a user interface to an automated system; and
means for allowing documents used by organizations for salary planning, performance management, or other human resource (HR) processes to be used to generate online forms that closely mirror the documents and subsequent changes to the documents via an automated system.

2. The system of claim 1, further comprising at least one of:
means for managing multiple compensation or performance review processes or cycles within an organization;
means for dynamically refreshing data as required;
means for managing organizational changes within compensation or performance review cycles and making adjustments when necessary for “one-off” situations;
means for seeing status of a manager's compensation or performance reviews at any suitable point in time;
means for monitoring overall compensation or performance review processes and budget;
means for making compensation or performance review changes and adjustments;
means for drilling down with custom reports;
means for receiving notifications and handling real-time events that occur in and organization and are reflected in it's system of record, including a human resources management system (HRMS), and including terminations, leaves-of-absence, and transfers, via an interactive user driven process that allow these events to be reflected in a current salary planning or performance management process while synchronizing data changes resulting from these event with data and events within a salary planning or performance management system;
means for communicating efficiently with any suitable participant in the compensation review process;
means for keeping track of where a manger stands in a salary or performance review process, and what the manger needs to do next;
means for centrally managing an entire salary or performance review process for each subordinate;
means for accessing needed information, including previous salary or performance reviews, and salary or performance histories;
means for working online or downloading spreadsheet or word processor documents and working offline;
means for submitting salary or performance reviews for approval by senior management, and for approving or rejecting salary or performance reviews of subordinate managers; and
means for sending “what if” scenarios to management and subordinates.

3. A method corresponding to one or more of the means of the system of claim 1.

4. A computer program product corresponding to one or more of the means of the system of claim 1.

5. A device corresponding to one or more of the means of the system of claim 1.
